(19) United States
(12) Patent Application Publication
(10) Pub. No.: US 2026/0268213 A1
(43) Pub. Date: Sep. 10, 2026

(54) SYSTEMS AND METHODS FOR ANALYZING ARTIFICIAL INTELLIGENCE (AI) MODELS USING EFFECTIVE STATE-SIZE

(71) Applicant: Liquid AI, Inc., Cambridge, MA (US)

(72) Inventor: Stefano MASSAROLI, Tokyo (JP)

(73) Assignee: Liquid AI, Inc., Cambridge, MA (US)

(21) Appl. No.: 19/264,645

(22) Filed: Jul. 9, 2025

Related U.S. Application Data
(60) Provisional application No. 63/768,110, filed on Mar. 6, 2025.

(51) Int. Cl. G06N 20/00

(52) U.S. Cl. CPC G06N 20/00

(57) ABSTRACT

A method for configuring a machine-learning sequence model based on memory utilization of the model, comprising receiving data representing one or more characteristics for the model from the group including: 1) an architecture, 2) an initialization stage, 3) a featurizer, 4) a training process, and 5) a configuration following the training stage of the model, computing a measure of effective state size of the model based on the received data, wherein the measure of effective state size characterizes memory utilization of the model, based on the computed measure of the effective state size, selecting a modification to the model from the group including a modification to: 1) the initialization stage, 2) the featurizer, 3) a loss function of the training stage, 3) a model order, 4) a hybridization, and 5) an architecture, applying the selected modification to the model, and training the model based on the applied modification.

### CROSS-REFERENCE TO RELATED APPLICATION

This application claims priority to U.S. Provisional Application No. 63/768,110, filed Mar. 6, 2025, the entire contents of which is incorporated herein by reference.

### FIELD

This application relates generally to artificial intelligence (AI) models, and more specifically to systems and methods for analyzing and automatically optimizing AI models based on quantification of effective state-size (ESS).

### BACKGROUND

In recent years, the success of autoregressive sequence modeling in the context of deep learning has largely been driven by advancements in highly parallelizable causal architectures. However, despite their strong performance and hardware efficiency, understanding the inner workings of these neural networks remains a challenging task due to their non-linearity and the diversity of fundamental building blocks used.

### SUMMARY

Understanding the inner workings of the neural networks of the causal architecture remains a challenging task. Previous work has utilized a variety of extrinsic and intrinsic analysis tools to qualitatively and quantitively characterize neural networks, treating the model's internal processes as black boxes. Extrinsic tools, which focus solely on the input and output of the model are highly generalizable across models and datasets, but that generality makes the extrinsic tools less effective at quantifying the neural network's internal black box. Conversely, intrinsic tools directly visualize the model's internal mechanisms. Examples of intrinsic tools include mechanistic interpretability, which analyzes how individual model components contribute to model behavior, visualization of the model operator, which analyzes formation features like induction heads, strong activations, diagonal patterns, etc., and spectral analysis of the full operator. While each of the aforementioned intrinsic tools have had some success, each suffers from at least one disadvantage. For example, mechanistic interpretability does not target the operator view of the model. Visualization techniques often fail to highlight critical properties that explain how different models construct internal representations of the input data and thus cannot provide the quantitative metrics necessary to effectively evaluate a model's internal mechanisms. The spectral analysis on the full operator does not appropriately consider important conflating factors like the causal masking of T which significantly distorts the metric. Other intrinsic tools yielding a quantitative metric are largely limited to a specific model class, and thus lack a necessary generalizability. Additionally, measures such as model size and cache/state size are flawed means of distinguishing sequence models. Namely, while these metrics serve as reasonable proxies for the capacity of a model to learn, they fail to capture how much of that capacity is realized. As such, they ignore important aspects of the model pipeline such as data, initialization, and optimization.

Accordingly, a highly generalizable and quantitative analysis is required to effectively evaluate a model's internal mechanism. Disclosed herein are systems and methods that leverage effective state size (ESS) to provide such a highly generalizable and quantitative analysis of internal mechanisms of models, and to provide systems and methods for automatically reconfiguring and optimizing models based on said analysis. As explained herein, ESS analysis is highly generalizable, as it can be applied to any sequence model that can materialize a linear operator, T. For example, any sequence model which supports parallelization across the sequence dimension may materialize T. Such sequence models may be formally expressed as either linear systems (y=Tu) or systems with input-varying linear operators (y=f(u)u), the latter of which may be abbreviated as LIV. ESS analysis may provide an ESS metric that quantitatively characterizes a model's memory utilization, and thus the model's performance and accuracy for a task. Additionally, unlike other quantitative approaches, ESS may consider the sequence model's functional form, input data, optimization, and, more generally, any parameter that impacts the realization of T. Furthermore, ESS analysis may quantify meaningful differences across causal architectures (e.g., sequence models) and/or compare memory utilization on a per-token basis.

The ESS metric may include, or may take the form of, one or more different quantitative metrics, depending on the metric's functional form. For example, a tolerance-ESS metric is the minimum state-size necessary for an input-invariant recurrence to approximate the operator, such that the spectral norm of the approximation error remains below a specified tolerance level. The tolerance-ESS metric may offer a more precise and readily interpretable depiction of rank concerning approximation error. In another example, an entropy-ESS metric is calculated by exponentiating the normalized spectral entropy (e.g., perplexity) and may be used to quantify the entire tolerance space of a given model. Regardless of functional form, the ESS metric may, in some embodiments, be a single number obtained by averaging across various dimensions. For example, an average ESS metric, which may be referred to as simply the ESS metric, may be obtained by averaging across layer, channel, sequence, and batch size dimensions for a model. In some embodiments, a total ESS metric may be obtained by first summing ESS across the channels for a model and then averaging over the remaining dimensions for said model. In some embodiments, the ESS metric may be compared to and/or otherwise evaluated in conjunction with a theoretically realizable state-size (TSS) metric to further quantify and characterize a model's internal mechanisms. The TSS metric may serve as a proxy for memory capacity and may be the upper bound for ESS.

As explained herein, ESS analysis may be applied to evaluate a sequence model at one or more of various different stages in the machine learning process, for example pre-training, mid-training, or post-training. In the pre-training stage, ESS analysis may be used to automatically determine whether and how to select or modify an initialization schema for the model and/or whether and how to select or modify a featurizer for the model. In the mid-training stage, ESS analysis may be used to automatically determine whether and how to select or modify one or more characteristics of the training process, for example by modifying a loss function of the model. In the post-training stage, ESS analysis may be used to automatically determine whether and how to select or modify a model order of the model (e.g., by applying model order reduction) and/or whether and how to modify hybridization of the model. Additionally, ESS analysis in the post-training stage, may be used to automatically determine whether and how to select a different sequence model for a given task and/or given data set.

ESS analysis may be provided as part of a computerized system that automatically ingests data characterizing one or more models to be analyzed, applies ESS analysis at one or more stages of the model's training, and then automatically generates a determination (based at least in part on said ESS analysis) as to whether and how to modify one or more characteristics of the model. In this way, ESS analysis may provide an automated system for modifying and re-training machine learning models during their development, thus allowing for automatic optimization and deployment of machine learning models based on the task(s) and/or data set(s) to which the model is to be applied.

According to some embodiments, a method for configuring a machine-learning sequence model based on memory utilization of the model, the method performed by a system comprising one or more processors, the method comprising receiving data representing one or more characteristics for the model from the group consisting of: an architecture for the model, an initialization stage of the model, a featurizer for the model, a training process of the model, and a configuration of the model following the training stage, computing a measure of effective state size of the model based on the received data, wherein the measure of effective state size characterizes memory utilization of the model, based on the computed measure of the effective state size of the model, selecting a modification to the model from the group consisting of: a modification to the initialization stage of the model, a modification to the featurizer for the model, a modification to a loss function of the training stage of the model, a modification to a model order of the model, a modification to a hybridization of the model, and a modification to an architecture of the model, applying the selected modification to the model, and training the model based on the applied modification.

In any of these embodiments, computing the measure of effective state size comprises applying a tolerance value to threshold singular values of one or more operator submatrices of the sequence model to generate a tolerance effective state size metric. In any of these embodiments, computing the measure of effective state size comprises exponentiating a normalized spectral entropy of one or more operator submatrices of the sequence model. In any of these embodiments, computing the measure of effective state size comprises computing specific respective ESS values for each sequence index on a per-channel, per-layer basis and averaging the specific respective ESS values across layer, channel, sequence, and batch size dimensions to generate the measure of effective state size.

In any of these embodiments, computing the measure of effective state size comprises computing specific respective ESS values for each sequence index on a per-channel, per-layer basis, summing the specific respective ESS values across channels to generate channel-sum ESS values, and averaging the channel-sum ESS values across layer, sequence, and batch size dimensions to generate the measure of effective state size. In any of these embodiments, computing the measure of effective state size comprises computing a plurality of respective ESS values for the model across channels and input samples and evaluating a minimum of the plurality of ESS values at the mid-point of the sequence. In any of these embodiments, the training stage of the model comprises training the model on one or more tasks from the group consisting of: multi-query associative recall (MQAR), selective copying, and compression. In any of these embodiments, the sequence model comprises one or more model types from the group consisting of: gated linear attention (GLA), weighted linear attention (WLA), linear attention (LA), and softmax attention (SA), S6, or GLA-S6.

In any of these embodiments, computing the measure of effective state size of the model comprises computing the measure at a first stage during the training process and the method further comprises computing a second measure of effective state size of the model at a second stage during the training process. In any of these embodiments, comprising based on the measure of the effective state size of the model at the first stage during the training process and based on the second measure of effective state size of the model at a second stage during the training process, detecting that a failure mode of the training process has occurred, wherein selecting the modification to the model is performed in accordance with detecting that the failure mode has occurred.

In any of these embodiments, the failure mode comprises a mode of the group consisting of: state saturation and state collapse. In any of these embodiments, the failure mode is a state saturation mode in which the model has insufficient memory to learn a task, and detecting the state saturation mode comprises detecting, based on the measure of effective state size of the model at the first stage during the training process and based on the second measure of effective state size of the model at a second stage during the training process, that a measure of state utilization approaches withing a threshold distance of 1 as the training process progresses, wherein state utilization is computed as a ratio of the effective state size to theoretical realizable state size of the model. In any of these embodiments, selecting a modification to the model comprises selecting the modification to increase the theoretical realizable state size of the model. In any of these embodiments, the failure mode is a state collapse mode in which memory utilization fails to sufficiently increase during the training process, and detecting the state collapse mode comprises detecting, based on the measure of effective state size of the model at the first stage during the training process and based on the second measure of effective state size of the model at a second stage during the training process, that an increase in the second measure of effective state size as compared to the first measure of effective state size fails to meet one or more improvement criteria. In any of these embodiments, selecting a modification to the model comprises selecting the modification to increase the effective state size of the model without changing a theoretical realizable state size of the model.

In any of these embodiments, the data representing the one or more characteristics for the model represents the model before the training process of the model is performed and the selected modification to the model comprises the modification to the featurizer for the model. In any of these embodiments, the data representing the one or more characteristics for the model represents the model before the training process of the model is performed and the selected modification to the model comprises the modification to the initialization stage of the model. In any of these embodiments, the modification to the initialization stage of the model comprises an increase in a normalization factor of the initialization stage. In any of these embodiments, the data representing the one or more characteristics for the model represents the model after at least part of the training process of the model is performed and the selected modification to the model comprises regularization of one or more layers of the model.

In any of these embodiments, the regularization of the one or more layers of the model comprises regularization of a second of two sequence mixing layers without regularization of a first of the two sequence mixing layers. In any of these embodiments, the data representing the one or more characteristics for the model represents the model after the training process of the model is performed and the selected modification to the model comprises the modification to a model order of the model. In any of these embodiments, the data representing the one or more characteristics for the model represents the model after the training process of the model is performed and the selected modification to the model comprises the modification to the hybridization of the model. In any of these embodiments, computing the measure of effective state size of the model based on the received data comprises computing one or more per-layer measures of effective state size of the model. In any of these embodiments, the model comprises a model type of the group consisting of: a linear system and an input-varying linear operator.

According to some embodiments, a system comprising at least one computer processor and a memory storing computer instructions, wherein the instructions are configured to be executed by the at least one computer processor, to cause the system to perform operations comprising receiving data representing one or more characteristics for a model from the group consisting of: an architecture for the model, an initialization stage of the model, a featurizer for the model, a training process of the model, and a configuration of the model following the training stage, computing a measure of effective state size of the model based on the received data, wherein the measure of effective state size characterizes memory utilization of the model, based on the computed measure of the effective state size of the model, selecting a modification to the model from the group consisting of: a modification to the initialization stage of the model, a modification to the featurizer for the model, a modification to a loss function of the training stage of the model, a modification to a model order of the model, a modification to a hybridization of the model, and a modification to an architecture of the model, applying the selected modification to the model, and training the model based on the applied modification.

In any of these embodiments, computing the measure of effective state size comprises computing specific respective ESS values for each sequence index on a per-channel, per-layer basis and averaging the specific respective ESS values across layer, channel, sequence, and batch size dimensions to generate the measure of effective state size. In any of these embodiments, computing the measure of effective state size comprises computing specific respective ESS values for each sequence index on a per-channel, per-layer basis, summing the specific respective ESS values across channels to generate channel-sum ESS values, and averaging the channel-sum ESS values across layer, sequence, and batch size dimensions to generate the measure of effective state size. In any of these embodiments, computing the measure of effective state size comprises computing a plurality of respective ESS values for the model across channels and input samples and evaluating a minimum of the plurality of ESS values at the mid-point of the sequence. In any of these embodiments, the training stage of the model comprises training the model on one or more tasks from the group consisting of: multi-query associative recall (MQAR), selective copying, and compression. In any of these embodiments, the model comprises a model type of the group consisting of: a linear system and an input-varying linear operator.

According to some embodiments, a non-transitory computer-readable storage medium storing computer instructions that, when executed by at least one computer processor of a computing system, cause the computing system to perform operations comprising receiving data representing one or more characteristics for a model from the group consisting of: an architecture for the model, an initialization stage of the model, a featurizer for the model, a training process of the model, and a configuration of the model following the training stage, computing a measure of effective state size of the model based on the received data, wherein the measure of effective state size characterizes memory utilization of the model, based on the computed measure of the effective state size of the model, selecting a modification to the model from the group consisting of: a modification to the initialization stage of the model, a modification to the featurizer for the model, a modification to a loss function of the training stage of the model, a modification to a model order of the model, a modification to a hybridization of the model, and a modification to an architecture of the model, applying the selected modification to the model, and training the model based on the applied modification.

According to some embodiments, a method for quantitatively assessing a machine-learning sequence model based on memory utilization of the model, the method performed by a system comprising one or more processors, the method comprising receiving data representing one or more characteristics for the model from the group consisting of: an architecture for the model, an initialization stage of the model, a featurizer for the model, a training process of the model, and a configuration of the model following the training stage and computing a measure of effective state size of the model based on the received data, wherein the measure of effective state size characterizes memory utilization of the model.

In any of these embodiments, based on the computed measure of the effective state size of the model, selecting the model for application to a task and deploying the model for performance of the task. In any of these embodiments, computing the measure of effective state size comprises computing specific respective ESS values for each sequence index on a per-channel, per-layer basis and averaging the specific respective ESS values across layer, channel, sequence, and batch size dimensions to generate the measure of effective state size. In any of these embodiments, computing the measure of effective state size comprises computing specific respective ESS values for each sequence index on a per-channel, per-layer basis, summing the specific respective ESS values across channels to generate channel-sum ESS values, and averaging the channel-sum ESS values across layer, sequence, and batch size dimensions to generate the measure of effective state size. In any of these embodiments, computing the measure of effective state size comprises computing a plurality of respective ESS values for the model across channels and input samples and evaluating a minimum of the plurality of ESS values at the mid-point of the sequence. In any of these embodiments, the model comprises a model type of the group consisting of: a linear system and an input-varying linear operator.

According to some embodiments, a system comprising at least one computer processor and a memory storing computer instructions, wherein the instructions are configured to be executed by the at least one computer processor, to cause the system to perform operations comprising receiving data representing one or more characteristics for a model from the group consisting of: an architecture for the model, an initialization stage of the model, a featurizer for the model, a training process of the model, and a configuration of the model following the training stage and computing a measure of effective state size of the model based on the received data, wherein the measure of effective state size characterizes memory utilization of the model.

In any of these embodiments, based on the computed measure of the effective state size of the model, selecting the model for application to a task and deploying the model for performance of the task. In any of these embodiments, computing the measure of effective state size comprises computing specific respective ESS values for each sequence index on a per-channel, per-layer basis and averaging the specific respective ESS values across layer, channel, sequence, and batch size dimensions to generate the measure of effective state size. In any of these embodiments, computing the measure of effective state size comprises computing specific respective ESS values for each sequence index on a per-channel, per-layer basis, summing the specific respective ESS values across channels to generate channel-sum ESS values, and averaging the channel-sum ESS values across layer, sequence, and batch size dimensions to generate the measure of effective state size. In any of these embodiments, computing the measure of effective state size comprises computing a plurality of respective ESS values for the model across channels and input samples and evaluating a minimum of the plurality of ESS values at the mid-point of the sequence. In any of these embodiments, the model comprises a model type of the group consisting of: a linear system and an input-varying linear operator.

According to some embodiments, a non-transitory computer-readable storage medium storing computer instructions that, when executed by at least one computer processor of a computing system, cause the computing system to perform operations comprising receiving data representing one or more characteristics for a model from the group consisting of: an architecture for the model, an initialization stage of the model, a featurizer for the model, a training process of the model, and a configuration of the model following the training stage and computing a measure of effective state size of the model based on the received data, wherein the measure of effective state size characterizes memory utilization of the model.

In any of these embodiments, based on the computed measure of the effective state size of the model, selecting the model for application to a task and deploying the model for performance of the task.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The patent or application file contains at least one drawing executed in color. Copies of this patent or patent application publication with color drawing(s) will be provided by the Office upon request and payment of the necessary fee.

FIG. 1 illustrates an exemplary method for configuring a sequence model using ESS analysis, according to some embodiments.

FIG. 2 illustrates an overview of the ESS metric and its various downstream applications, according to some embodiments.

FIG. 3A(i)-FIG. 3A(iv) illustrates accuracy versus TSS/kv for (i) GLA featurizer, (ii) LA featurizer, (iii) WLA featurizer, and (iv) SA featurizer, according to some embodiments.

FIG. 3B(i)-FIG. 3B(iv) illustrates accuracy versus (total TSS)/kv for (i) GLA featurizer, (ii) LA featurizer, (iii) WLA featurizer, and (iv) SA featurizer, according to some embodiments.

FIG. 3C(i)-FIG. 3C(iv) illustrates accuracy versus ESS/kv for (i) GLA featurizer, (ii) LA featurizer, (iii) WLA featurizer, and (iv) SA featurizer, according to some embodiments.

FIG. 3D(i)-FIG. 3D(iv) illustrates accuracy versus (total ESS)/kv for (i) GLA featurizer, (ii) LA featurizer, (iii) WLA featurizer, and (iv) SA featurizer, according to some embodiments.

FIG. 3E(i)-FIG. 3E(iv) illustrates accuracy versus ESS/TSS for (i) GLA featurizer, (ii) LA featurizer, (iii) WLA featurizer, and (iv) SA featurizer, according to some embodiments.

FIG. 3F(i)-FIG. 3F(iv) illustrates accuracy versus (total ESS)/(total TSS) for (i) GLA featurizer, (ii) LA featurizer, (iii) WLA featurizer, and (iv) SA featurizer, according to some embodiments.

FIG. 3G(i)-FIG. 3G(iv) illustrates accuracy versus ESS for (i) GLA featurizer, (ii) LA featurizer, (iii) WLA featurizer, and (iv) SA featurizer, according to some embodiments.

FIG. 3H(i)-FIG. 3H(iv) illustrates accuracy versus TSS for (i) GLA featurizer, (ii) LA featurizer, (iii) WLA featurizer, and (iv) SA featurizer, according to some embodiments.

FIG. 4(i)-FIG. 4(iv) illustrates training dynamics of ESS in a (i) SA, (ii) GLA, (iii) LA, and (iv) WLA model (dmodel=256, heads=8) trained on multi-query associative recall (MQAR) with sequence length of 2048 and kv of 64, according to some embodiments.

FIG. 5A(i)-FIG. 5A(iv) illustrates MQAR accuracy marginalized across TSS versus kv for (i) GLA featurizer, (ii) LA featurizer, (iii) WLA featurizer, and (iv) SA featurizer, according to some embodiments.

FIG. 5B(i)-FIG. 5B(iv) illustrates MQAR accuracy marginalized across total TSS versus kv for (i) GLA featurizer, (ii) LA featurizer, (iii) WLA featurizer, and (iv) SA featurizer, according to some embodiments.

FIG. 5C(i)-FIG. 5C(iv) illustrates MQAR accuracy marginalized across TSS versus sequence length for (i) GLA featurizer, (ii) LA featurizer, (iii) WLA featurizer, and (iv) SA featurizer, according to some embodiments.

FIG. 5D(i)-FIG. 5D(iv) illustrates MQAR accuracy marginalized across total TSS versus sequence length for (i) GLA featurizer, (ii) LA featurizer, (iii) WLA featurizer, and (iv) SA featurizer, according to some embodiments.

FIG. 5E(i)-FIG. 5E(iv) illustrates MQAR accuracy marginalized across sequence length versus kv for (i) GLA featurizer, (ii) LA featurizer, (iii) WLA featurizer, and (iv) SA featurizer, according to some embodiments.

FIG. 5F illustrates MQAR accuracy versus TSS, according to some embodiments.

FIG. 5G illustrates MQAR accuracy versus total TSS, according to some embodiments.

FIG. 5H illustrates MQAR accuracy versus kv, according to some embodiments.

FIG. 5I illustrates MQAR accuracy versus sequence length, according to some embodiments.

FIG. 6A(i)-FIG. 6A(iv) illustrates MQAR entropy-ESS/kv marginalized across TSS versus kv for (i) GLA featurizer, (ii) LA featurizer, (iii) WLA featurizer, and (iv) SA featurizer, according to some embodiments.

FIG. 6B(i)-FIG. 6B(iv) illustrates MQAR entropy-ESS/kv marginalized across total TSS versus kv for (i) GLA featurizer, (ii) LA featurizer, (iii) WLA featurizer, and (iv) SA featurizer, according to some embodiments.

FIG. 6C(i)-FIG. 6C(iv) illustrates MQAR entropy-ESS/kv marginalized across TSS versus sequence length for (i) GLA featurizer, (ii) LA featurizer, (iii) WLA featurizer, and (iv) SA featurizer, according to some embodiments.

FIG. 6D(i)-FIG. 6D(iv) illustrates MQAR entropy-ESS/kv marginalized across total TSS versus sequence length for (i) GLA featurizer, (ii) LA featurizer, (iii) WLA featurizer, and (iv) SA featurizer, according to some embodiments.

FIG. 6E(i)-FIG. 6E(iv) illustrates MQAR entropy-ESS/kv marginalized across sequence length versus kv for (i) GLA featurizer, (ii) LA featurizer, (iii) WLA featurizer, and (iv) SA featurizer, according to some embodiments.

FIG. 6F illustrates MQAR entropy-ESS/kv versus TSS, according to some embodiments.

FIG. 6G illustrates MQAR entropy-ESS/kv versus total TSS, according to some embodiments.

FIG. 6H illustrates MQAR entropy-ESS/kv versus kv, according to some embodiments.

FIG. 6I illustrates MQAR entropy-ESS/kv versus sequence length, according to some embodiments.

FIG. 7A(i)-FIG. 7A(iv) illustrates MQAR (total entropy-ESS)/kv marginalized across TSS versus kv for (i) GLA featurizer, (ii) LA featurizer, (iii) WLA featurizer, and (iv) SA featurizer, according to some embodiments.

FIG. 7B(i)-FIG. 7B(iv) illustrates MQAR (total entropy-ESS)/kv marginalized across total TSS versus kv for (i) GLA featurizer, (ii) LA featurizer, (iii) WLA featurizer, and (iv) SA featurizer, according to some embodiments.

FIG. 7C(i)-FIG. 7C(iv) illustrates MQAR (total entropy-ESS)/kv marginalized across TSS versus sequence length for (i) GLA featurizer, (ii) LA featurizer, (iii) WLA featurizer, and (iv) SA featurizer, according to some embodiments.

FIG. 7D(i)-FIG. 7D(iv) illustrates MQAR (total entropy-ESS)/kv marginalized across total TSS versus sequence length for (i) GLA featurizer, (ii) LA featurizer, (iii) WLA featurizer, and (iv) SA featurizer, according to some embodiments.

FIG. 7E(i)-FIG. 7E(iv) illustrates MQAR (total entropy-ESS)/kv marginalized across sequence length versus kv for (i) GLA featurizer, (ii) LA featurizer, (iii) WLA featurizer, and (iv) SA featurizer, according to some embodiments.

FIG. 7F illustrates MQAR (total entropy-ESS)/kv versus TSS, according to some embodiments.

FIG. 7G illustrates MQAR (total entropy-ESS)/kv versus total TSS, according to some embodiments.

FIG. 7H illustrates MQAR (total entropy-ESS)/kv versus kv, according to some embodiments.

FIG. 7I illustrates MQAR (total entropy-ESS)/kv versus sequence length, according to some embodiments.

FIG. 8A(i)-FIG. 8A(iv) illustrates MQAR entropy-ESS/TSS marginalized across TSS versus kv for (i) GLA featurizer, (ii) LA featurizer, (iii) WLA featurizer, and (iv) SA featurizer, according to some embodiments.

FIG. 8B(i)-FIG. 8B(iv) illustrates MQAR entropy-ESS/TSS marginalized across total TSS versus kv for (i) GLA featurizer, (ii) LA featurizer, (iii) WLA featurizer, and (iv) SA featurizer, according to some embodiments.

FIG. 8C(i)-FIG. 8C(iv) illustrates MQAR entropy-ESS/TSS marginalized across TSS versus sequence length for (i) GLA featurizer, (ii) LA featurizer, (iii) WLA featurizer, and (iv) SA featurizer, according to some embodiments.

FIG. 8D(i)-FIG. 8D(iv) illustrates MQAR entropy-ESS/TSS marginalized across total TSS versus sequence length for (i) GLA featurizer, (ii) LA featurizer, (iii) WLA featurizer, and (iv) SA featurizer, according to some embodiments.

FIG. 8E(i)-FIG. 8E(iv) illustrates MQAR entropy-ESS/TSS marginalized across sequence length versus kv for (i) GLA featurizer, (ii) LA featurizer, (iii) WLA featurizer, and (iv) SA featurizer, according to some embodiments.

FIG. 8F illustrates MQAR entropy-ESS/TSS versus TSS, according to some embodiments.

FIG. 8G illustrates MQAR entropy-ESS/TSS versus total TSS, according to some embodiments.

FIG. 8H illustrates MQAR entropy-ESS/TSS versus kv, according to some embodiments.

FIG. 8I illustrates MQAR entropy-ESS/TSS versus sequence length, according to some embodiments.

FIG. 9A(i)-FIG. 9A(iv) illustrates MQAR (total entropy-ESS)/(total TSS) marginalized across TSS versus kv for (i) GLA featurizer, (ii) LA featurizer, (iii) WLA featurizer, and (iv) SA featurizer, according to some embodiments.

FIG. 9B(i)-FIG. 9B(iv) illustrates MQAR (total entropy-ESS)/(total TSS) marginalized across total TSS versus kv for (i) GLA featurizer, (ii) LA featurizer, (iii) WLA featurizer, and (iv) SA featurizer, according to some embodiments.

FIG. 9C(i)-FIG. 9C(iv) illustrates MQAR (total entropy-ESS)/(total TSS) marginalized across TSS versus sequence length for (i) GLA featurizer, (ii) LA featurizer, (iii) WLA featurizer, and (iv) SA featurizer, according to some embodiments.

FIG. 9D(i)-FIG. 9D(iv) illustrates MQAR (total entropy-ESS)/(total TSS) marginalized across total TSS versus sequence length for (i) GLA featurizer, (ii) LA featurizer, (iii) WLA featurizer, and (iv) SA featurizer, according to some embodiments.

FIG. 9E(i)-FIG. 9E(iv) illustrates MQAR (total entropy-ESS)/(total TSS) marginalized across sequence length versus kv for (i) GLA featurizer, (ii) LA featurizer, (iii) WLA featurizer, and (iv) SA featurizer, according to some embodiments.

FIG. 9F illustrates MQAR (total entropy-ESS)/(total TSS) versus TSS, according to some embodiments.

FIG. 9G illustrates MQAR (total entropy-ESS)/(total TSS) versus total TSS, according to some embodiments.

FIG. 9H illustrates MQAR (total entropy-ESS)/(total TSS) versus kv, according to some embodiments.

FIG. 9I illustrates MQAR (total entropy-ESS)/(total TSS) versus sequence length, according to some embodiments.

FIG. 10A(i)-FIG. 10A(iv) illustrates MQAR entropy-ESS-accuracy correlations computed over training marginalized across TSS versus kv for (i) GLA featurizer, (ii) LA featurizer, (iii) WLA featurizer, and (iv) SA featurizer, according to some embodiments.

FIG. 10B(i)-FIG. 10B(iv) illustrates MQAR entropy-ESS-accuracy correlations computed over training marginalized across total TSS versus kv for (i) GLA featurizer, (ii) LA featurizer, (iii) WLA featurizer, and (iv) SA featurizer, according to some embodiments.

FIG. 10C(i)-FIG. 10C(iv) illustrates MQAR entropy-ESS-accuracy correlations computed over training marginalized across TSS versus sequence length for (i) GLA featurizer, (ii) LA featurizer, (iii) WLA featurizer, and (iv) SA featurizer, according to some embodiments.

FIG. 10D(i)-FIG. 10D(iv) illustrates MQAR entropy-ESS-accuracy correlations computed over training marginalized across total TSS versus sequence length for (i) GLA featurizer, (ii) LA featurizer, (iii) WLA featurizer, and (iv) SA featurizer, according to some embodiments.

FIG. 10E(i)-FIG. 10E(iv) illustrates MQAR entropy-ESS-accuracy correlations computed over training marginalized across sequence length versus kv for (i) GLA featurizer, (ii) LA featurizer, (iii) WLA featurizer, and (iv) SA featurizer, according to some embodiments.

FIG. 10F illustrates MQAR entropy-ESS-accuracy correlations computed over training versus TSS, according to some embodiments.

FIG. 10G illustrates MQAR entropy-ESS-accuracy correlations computed over training versus total TSS, according to some embodiments.

FIG. 10H illustrates MQAR entropy-ESS-accuracy correlations computed over training versus kv, according to some embodiments.

FIG. 10I illustrates MQAR entropy-ESS-accuracy correlations computed over training versus sequence length, according to some embodiments.

FIG. 11(i)-FIG. 11(iv) illustrates scatter plots of accuracy versus ESS/kv for (i) GLA featurizer, (ii) LA featurizer, (iii) WLA featurizer, and (iv) SA featurizer, according to some embodiments.

FIG. 12 illustrates ESS/kv versus TSS/kv as measured by correlation, according to some embodiments.

FIG. 13(i)-FIG. 13(iv) illustrates accuracy versus TSS/kv for (i) GLA featurizer, (ii) LA featurizer, (iii) WLA featurizer, and (iv) SA featurizer, according to some embodiments.

FIG. 14(i)-FIG. 14(iv) illustrates accuracy versus (total TSS)/kv for (i) GLA featurizer, (ii) LA featurizer, (iii) WLA featurizer, and (iv) SA featurizer, according to some embodiments.

FIG. 15A(i)-FIG. 15A(iv) illustrates MQAR accuracy versus (tolerance-ESS)/kv for (i) GLA featurizer, (ii) LA featurizer, (iii) WLA featurizer, and (iv) SA featurizer, according to some embodiments.

FIG. 15B(i)-FIG. 15B(iv) illustrates MQAR accuracy versus (total tolerance-ESS)/kv for (i) GLA featurizer, (ii) LA featurizer, (iii) WLA featurizer, and (iv) SA featurizer, according to some embodiments.

FIG. 15C(i)-FIG. 15C(iv) illustrates MQAR accuracy versus (tolerance-ESS)/(TSS) for (i) GLA featurizer, (ii) LA featurizer, (iii) WLA featurizer, and (iv) SA featurizer, according to some embodiments.

FIG. 15D(i)-FIG. 15D(iv) illustrates MQAR accuracy versus (total tolerance-ESS)/(total TSS) for (i) GLA featurizer, (ii) LA featurizer, (iii) WLA featurizer, and (iv) SA featurizer, according to some embodiments.

FIG. 15E(i)-FIG. 15E(iv) illustrates MQAR accuracy versus tolerance-ESS for (i) GLA featurizer, (ii) LA featurizer, (iii) WLA featurizer, and (iv) SA featurizer, according to some embodiments.

FIG. 16A(i)-FIG. 16A(iv) illustrates MQAR tolerance-ESS/kv marginalized across TSS versus kv for (i) GLA featurizer, (ii) LA featurizer, (iii) WLA featurizer, and (iv) SA featurizer, according to some embodiments.

FIG. 16B(i)-FIG. 16B(iv) illustrates MQAR tolerance-ESS/kv marginalized across total TSS versus kv for (i) GLA featurizer, (ii) LA featurizer, (iii) WLA featurizer, and (iv) SA featurizer, according to some embodiments.

FIG. 16C(i)-FIG. 16C(iv) illustrates MQAR tolerance-ESS/kv marginalized across TSS versus sequence length for (i) GLA featurizer, (ii) LA featurizer, (iii) WLA featurizer, and (iv) SA featurizer, according to some embodiments.

FIG. 16D(i)-FIG. 16D(iv) illustrates MQAR tolerance-ESS/kv marginalized across total TSS versus sequence length for (i) GLA featurizer, (ii) LA featurizer, (iii) WLA featurizer, and (iv) SA featurizer, according to some embodiments.

FIG. 16E(i)-FIG. 16E(iv) illustrates MQAR tolerance-ESS/kv marginalized across sequence length versus kv for (i) GLA featurizer, (ii) LA featurizer, (iii) WLA featurizer, and (iv) SA featurizer, according to some embodiments.

FIG. 16F illustrates MQAR tolerance-ESS/kv versus TSS, according to some embodiments.

FIG. 16G illustrates MQAR tolerance-ESS/kv versus total TSS, according to some embodiments.

FIG. 16H illustrates MQAR tolerance-ESS/kv versus kv, according to some embodiments.

FIG. 16I illustrates MQAR tolerance-ESS/kv versus sequence length, according to some embodiments.

FIG. 17A(i)-FIG. 17A(iv) illustrates MQAR (total tolerance-ESS)/kv marginalized across TSS versus kv for (i) GLA featurizer, (ii) LA featurizer, (iii) WLA featurizer, and (iv) SA featurizer, according to some embodiments.

FIG. 17B(i)-FIG. 17B(iv) illustrates MQAR (total tolerance-ESS)/kv marginalized across total TSS versus kv for (i) GLA featurizer, (ii) LA featurizer, (iii) WLA featurizer, and (iv) SA featurizer, according to some embodiments.

FIG. 17C(i)-FIG. 17C(iv) illustrates MQAR (total tolerance-ESS)/kv marginalized across TSS versus sequence length for (i) GLA featurizer, (ii) LA featurizer, (iii) WLA featurizer, and (iv) SA featurizer, according to some embodiments.

FIG. 17D(i)-FIG. 17D(iv) illustrates MQAR (total tolerance-ESS)/kv marginalized across total TSS versus sequence length for (i) GLA featurizer, (ii) LA featurizer, (iii) WLA featurizer, and (iv) SA featurizer, according to some embodiments.

FIG. 17E(i)-FIG. 17E(iv) illustrates MQAR (total tolerance-ESS)/kv marginalized across sequence length versus kv for (i) GLA featurizer, (ii) LA featurizer, (iii) WLA featurizer, and (iv) SA featurizer, according to some embodiments.

FIG. 17F illustrates MQAR (total tolerance-ESS)/kv versus TSS, according to some embodiments.

FIG. 17G illustrates MQAR (total tolerance-ESS)/kv versus total TSS, according to some embodiments.

FIG. 17H illustrates MQAR (total tolerance-ESS)/kv versus kv, according to some embodiments.

FIG. 17I illustrates MQAR (total tolerance-ESS)/kv versus sequence length, according to some embodiments.

FIG. 18A(i)-FIG. 18A(iv) illustrates MQAR tolerance-ESS/TSS marginalized across TSS versus kv for (i) GLA featurizer, (ii) LA featurizer, (iii) WLA featurizer, and (iv) SA featurizer, according to some embodiments.

FIG. 18B(i)-FIG. 18B(iv) illustrates MQAR tolerance-ESS/TSS marginalized across total TSS versus kv for (i) GLA featurizer, (ii) LA featurizer, (iii) WLA featurizer, and (iv) SA featurizer, according to some embodiments.

FIG. 18C(i)-FIG. 18C(iv) illustrates MQAR tolerance-ESS/TSS marginalized across TSS versus sequence length for (i) GLA featurizer, (ii) LA featurizer, (iii) WLA featurizer, and (iv) SA featurizer, according to some embodiments.

FIG. 18D(i)-FIG. 18D(iv) illustrates MQAR tolerance-ESS/TSS marginalized across total TSS versus sequence length for (i) GLA featurizer, (ii) LA featurizer, (iii) WLA featurizer, and (iv) SA featurizer, according to some embodiments.

FIG. 18E(i)-FIG. 18E(iv) illustrates MQAR tolerance-ESS/TSS marginalized across sequence length versus kv for (i) GLA featurizer, (ii) LA featurizer, (iii) WLA featurizer, and (iv) SA featurizer, according to some embodiments.

FIG. 18F illustrates MQAR tolerance-ESS/TSS versus TSS, according to some embodiments.

FIG. 18G illustrates MQAR tolerance-ESS/TSS versus total TSS, according to some embodiments.

FIG. 18H illustrates MQAR tolerance-ESS/TSS versus kv, according to some embodiments.

FIG. 18I illustrates MQAR tolerance-ESS/TSS versus sequence length, according to some embodiments.

FIG. 19A(i)-FIG. 19A(iv) illustrates MQAR (total tolerance-ESS)/(total TSS) marginalized across TSS versus kv for (i) GLA featurizer, (ii) LA featurizer, (iii) WLA featurizer, and (iv) SA featurizer, according to some embodiments.

FIG. 19B(i)-FIG. 19B(iv) illustrates MQAR (total tolerance-ESS)/(total TSS) marginalized across total TSS versus kv for (i) GLA featurizer, (ii) LA featurizer, (iii) WLA featurizer, and (iv) SA featurizer, according to some embodiments.

FIG. 19C(i)-FIG. 19C(iv) illustrates MQAR (total tolerance-ESS)/(total TSS) marginalized across TSS versus sequence length for (i) GLA featurizer, (ii) LA featurizer, (iii) WLA featurizer, and (iv) SA featurizer, according to some embodiments.

FIG. 19D(i)-FIG. 19D(iv) illustrates MQAR (total tolerance-ESS)/(total TSS) marginalized across total TSS versus sequence length for (i) GLA featurizer, (ii) LA featurizer, (iii) WLA featurizer, and (iv) SA featurizer, according to some embodiments.

FIG. 19E(i)-FIG. 19E(iv) illustrates MQAR (total tolerance-ESS)/(total TSS) marginalized across sequence length versus kv for (i) GLA featurizer, (ii) LA featurizer, (iii) WLA featurizer, and (iv) SA featurizer, according to some embodiments.

FIG. 19F illustrates MQAR (total tolerance-ESS)/(total TSS) versus TSS, according to some embodiments.

FIG. 19G illustrates MQAR (total tolerance-ESS)/(total TSS) versus total TSS, according to some embodiments.

FIG. 19H illustrates MQAR (total tolerance-ESS)/(total TSS) versus kv, according to some embodiments.

FIG. 19I illustrates MQAR (total tolerance-ESS)/(total TSS) versus sequence length, according to some embodiments.

FIG. 20A(i)-FIG. 20A(iv) illustrates MQAR tolerance-ESS-accuracy correlations computed over training marginalized across TSS versus kv for (i) GLA featurizer, (ii) LA featurizer, (iii) WLA featurizer, and (iv) SA featurizer, according to some embodiments.

FIG. 20B(i)-FIG. 20B(iv) illustrates MQAR tolerance-ESS-accuracy correlations computed over training marginalized across total TSS versus kv for (i) GLA featurizer, (ii) LA featurizer, (iii) WLA featurizer, and (iv) SA featurizer, according to some embodiments.

FIG. 20C(i)-FIG. 20C(iv) illustrates MQAR tolerance-ESS-accuracy correlations computed over training marginalized across TSS versus sequence length for (i) GLA featurizer, (ii) LA featurizer, (iii) WLA featurizer, and (iv) SA featurizer, according to some embodiments.

FIG. 20D(i)-FIG. 20D(iv) illustrates MQAR tolerance-ESS-accuracy correlations computed over training marginalized across total TSS versus sequence length for (i) GLA featurizer, (ii) LA featurizer, (iii) WLA featurizer, and (iv) SA featurizer, according to some embodiments.

FIG. 20E(i)-FIG. 20E(iv) illustrates MQAR tolerance-ESS-accuracy correlations computed over training marginalized across sequence length versus kv for (i) GLA featurizer, (ii) LA featurizer, (iii) WLA featurizer, and (iv) SA featurizer, according to some embodiments.

FIG. 20F illustrates MQAR tolerance-ESS-accuracy correlations computed over training versus TSS, according to some embodiments.

FIG. 20G illustrates MQAR tolerance-ESS-accuracy correlations computed over training versus total TSS, according to some embodiments.

FIG. 20H illustrates MQAR tolerance-ESS-accuracy correlations computed over training versus kv, according to some embodiments.

FIG. 20I illustrates MQAR tolerance-ESS-accuracy correlations computed over training versus sequence length, according to some embodiments.

FIG. 21(i)-FIG. 21(iv) illustrates correlation between ESS and accuracy over the course of model training bucketed by TSS and kv for (i) GLA featurizer, (ii) LA featurizer, (iii) WLA featurizer, and (iv) SA featurizer, according to some embodiments.

FIG. 22(i)-FIG. 22(ii) illustrates (i) accuracy and (ii) state utilization as a function of kv for low and high TSS models, according to some embodiments.

FIG. 23A illustrates ESS/kv and ∥ΠᵢAᵢ∥_{F} as a function of sequence length, according to some embodiments.

FIG. 23B illustrates accuracy of models as a function of ESS-based regularizer strength, according to some embodiments.

FIG. 24 illustrates per-layer ESS/kv as a function of MQAR sequence length for the GLA and WLA featurizers, according to some embodiments.

FIG. 25(i)-FIG. 25(iv) illustrates training dynamics of ESS in a (i) SA, (ii) GLA, (iii) LA, and (iv) WLA model (dmodel=512, heads=4) trained on MQAR with sequence length of 2048 and kv of 128, according to some embodiments.

FIG. 26A(i)-FIG. 26A(iv) illustrates accuracy versus entropy-ESS/number of tokens (ntc) for (i) GLA featurizer, (ii) LA featurizer, (iii) WLA featurizer, and (iv) SA featurizer for a selective copying task, according to some embodiments.

FIG. 26B(i)-FIG. 26B(iv) illustrates accuracy versus (total entropy-ESS)/ntc for (i) GLA featurizer, (ii) LA featurizer, (iii) WLA featurizer, and (iv) SA featurizer for a selective copying task, according to some embodiments.

FIG. 26C(i)-FIG. 26C(iv) illustrates accuracy versus TSS/ntc for (i) GLA featurizer, (ii) LA featurizer, (iii) WLA featurizer, and (iv) SA featurizer for a selective copying task, according to some embodiments.

FIG. 26D(i)-FIG. 26D(iv) illustrates accuracy versus (total TSS)/ntc for (i) GLA featurizer, (ii) LA featurizer, (iii) WLA featurizer, and (iv) SA featurizer for a selective copying task, according to some embodiments.

FIG. 26E(i)-FIG. 26E(iv) illustrates entropy-ESS-accuracy correlation computed over the course of training in (TSS, kv) buckets for (i) GLA featurizer, (ii) LA featurizer, (iii) WLA featurizer, and (iv) SA featurizer for a selective copying task, according to some embodiments.

FIG. 26F(i)-FIG. 26F(iv) illustrates entropy-ESS-accuracy correlation computed over the course of training in (total TSS, kv) buckets for (i) GLA featurizer, (ii) LA featurizer, (iii) WLA featurizer, and (iv) SA featurizer for a selective copying task, according to some embodiments.

FIG. 27A(i)-FIG. 27A(iv) illustrates accuracy versus entropy-ESS/vocab size (vs) for (i) GLA featurizer, (ii) LA featurizer, (iii) WLA featurizer, and (iv) SA featurizer for a compression task, according to some embodiments.

FIG. 27B(i)-FIG. 27B(iv) illustrates accuracy versus (total entropy-ESS)/vs for (i) GLA featurizer, (ii) LA featurizer, (iii) WLA featurizer, and (iv) SA featurizer for a compression task, according to some embodiments.

FIG. 27C(i)-FIG. 27C(iv) illustrates accuracy versus TSS/vs for (i) GLA featurizer, (ii) LA featurizer, (iii) WLA featurizer, and (iv) SA featurizer for a compression task, according to some embodiments.

FIG. 27D(i)-FIG. 27D(iv) illustrates accuracy versus (total TSS)/vs for (i) GLA featurizer, (ii) LA featurizer, (iii) WLA featurizer, and (iv) SA featurizer for a compression task, according to some embodiments.

FIG. 27E(i)-FIG. 27E(iv) illustrates entropy-ESS-accuracy correlation computed over the course of training in (TSS, kv) buckets for (i) GLA featurizer, (ii) LA featurizer, (iii) WLA featurizer, and (iv) SA featurizer for a compression task, according to some embodiments.

FIG. 27F(i)-FIG. 27F(iv) illustrates the entropy-ESS-accuracy correlation computed over the course of training in (total TSS, kv) buckets for (i) GLA featurizer, (ii) LA featurizer, (iii) WLA featurizer, and (iv) SA featurizer for a compression task, according to some embodiments.

FIG. 28A illustrates validation accuracy of S6, according to some embodiments.

FIG. 28B illustrates validation loss of S6, according to some embodiments.

FIG. 28C illustrates validation accuracy of GLA-S6, according to some embodiments.

FIG. 28D illustrates validation loss of GLA-S6, according to some embodiments.

FIG. 29 illustrates ESS and MQAR accuracy as a function of TSS on a custom task regime, according to some embodiments.

FIG. 30A illustrates ESS-TSS scaling in the S6, GLA, and GLA-S6 featurizers, according to some embodiments.

FIG. 30B illustrates ESS and accuracy on MQAR as a function of TSS in GLA, according to some embodiments.

FIG. 30C illustrates ESS and accuracy on MQAR as a function of normalization factor for initialization in GLA-S6, according to some embodiments.

FIG. 31 illustrates distillation loss versus ESS of a teacher model, according to some embodiments.

FIG. 32(i)-FIG. 32(iv) illustrates the distillation loss versus ESS for (i) student TSS of 16, (ii) student TSS of 32, (iii) student TSS of 64, and (iv) student TSS of 128, according to some embodiments.

FIG. 33(i)-FIG. 33(ii) illustrates MQAR accuracy and ESS across reduction scale for (i) layer 0 and (ii) layer 1, according to some embodiments.

FIG. 34(i)-FIG. 34(iv) illustrates distilled student ESS versus teacher ESS for (i) student TSS of 16, (ii) student TSS of 32, (iii) student TSS of 64, and (iv) student TSS of 128, according to some embodiments.

FIG. 35A(i)-FIG. 35A(xvi) illustrates per-layer ESS of all possible 4-layer GLA-SA hybrid networks, according to some embodiments.

FIG. 35B(i)-FIG. 35B(v) illustrates the per-layer ESS of all possible 8-layer GLA-SA Jamba-inspired hybrid networks, according to some embodiments.

FIG. 35C illustrates model accuracy, max ESS, and average ESS of SA layers in the 4-layer GLA-SA hybrid networks, according to some embodiments.

FIG. 35D illustrates model accuracy, max ESS, and average ESS of GLA layers in the 4-layer GLA-SA hybrid networks, according to some embodiments.

FIG. 36 illustrates an exemplary computing unit, according to some embodiments.

### DETAILED DESCRIPTION

The following description sets forth exemplary systems, parameters, and the like. It should be recognized, however, that such description is not intended as a limitation on the scope of the present disclosure but is instead provided as a description of exemplary embodiments.

Although the following description uses terms “first,” “second,” etc. to describe various elements, these elements should not be limited by the terms. These terms are only used to distinguish one element from another. For example, a first graphical representation could be termed a second graphical representation, and, similarly, a second graphical representation could be termed a first graphical representation, without departing from the scope of the various described embodiments. The first graphical representation and the second graphical representation are both graphical representations, but they are not the same graphical representation.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Provided herein are systems and methods for automatically analyzing artificial intelligence (AI) models using effective state-state (ESS) analysis and automatically configuring and re-training said models based on the ESS analysis. ESS analysis is a highly generalizable analysis that can be utilized by any sequence model that can materialize a linear operator, T. Sequence models that can effectively materialize a linear operator T may include any sequence model that supports parallelization across the sequence dimension. Such sequence models may be formally expressed as either linear systems (y=Tu) or systems with input-varying linear operators (y=f(u)u), the latter of which may be abbreviated as LIV. ESS analysis may provide a quantitative analysis used to evaluate a model's internal mechanisms. ESS analysis may yield a quantitative metric, an ESS metric, that may serve as a proxy for a sequence model's memory utilization, and thus a sequence model's performance and task accuracy.

In some embodiments, the ESS metric may be a tolerance-ESS metric, which may offer a more precise and readily interpretable depiction of model rank concerning approximation error. In some embodiments, the ESS metric may be an entropy-ESS metric, which may offer a more comprehensive evaluation of the model across the entire tolerance space. Regardless of functional form, the ESS metric may be a single number that is obtained by averaging across various dimensions. For example, the average ESS metric, which may be referred to as simply the ESS metric, may be obtained by averaging across the layer, channel, sequence, and batch size dimension. In another example, the total ESS metric may be obtained by first summing ESS across the channels and then averaging over the remaining dimensions. In some embodiments, the ESS metric may be compared to or otherwise evaluated in conjunction with a TSS metric, where TSS may serve as a proxy for memory capacity and is the upper bound for ESS. In some embodiments, ESS analysis may enable quantitative and automatic identification one or more failure modes of learning for a model, including state saturation and/or state collapse. State saturation may occur when a model has insufficient TSS to fully learn a task, which may result in the model's ESS converging near its TSS. State collapse may occur when a model has sufficient TSS to learn, or partially learn a task, but its ESS fails to increase during training, which may result in a heavily underutilized state.

In some embodiments, the ESS analysis may be used to evaluate a sequence model during any stage of the machine learning process, for example pre-training, mid-training, and post-training. Training may be applied with respect to one or more synthetic tasks, such as MQAR, selective copying, and compression, defined by task settings, for example number of key-value pairs, number of tokens to copy, sequence length, featurizer, epochs, etc. In the pre-training stage, the ESS analysis may be used to inform selection of a model's initialization and/or inform selection of a model's featurizer. For example, the ESS analysis may be used to analyze the correlation between the ESS metric and task accuracy, and the correlation may inform the initialization and/or featurizer selection. In the mid-training stage, the ESS analysis may be used to inform the training itself, for example by modifying a loss function based on the correlation between the ESS metric and task accuracy. In the post-training stage, the ESS analysis may be used to modify the model's order and/or modify the model's hybridization. For example, the ESS analysis may modify a model's order on the basis that the original model (e.g., a teacher model) influences the model's ability to be distilled into a smaller model (e.g., a student model). The ESS analysis may also inform the layer configuration of a hybrid neural network with the greatest task accuracy based on a correlation between the ESS metric and task accuracy. Additionally, the ESS analysis in the post-training stage may inform the selection of a different sequence model based on the correlation between ESS and task accuracy.

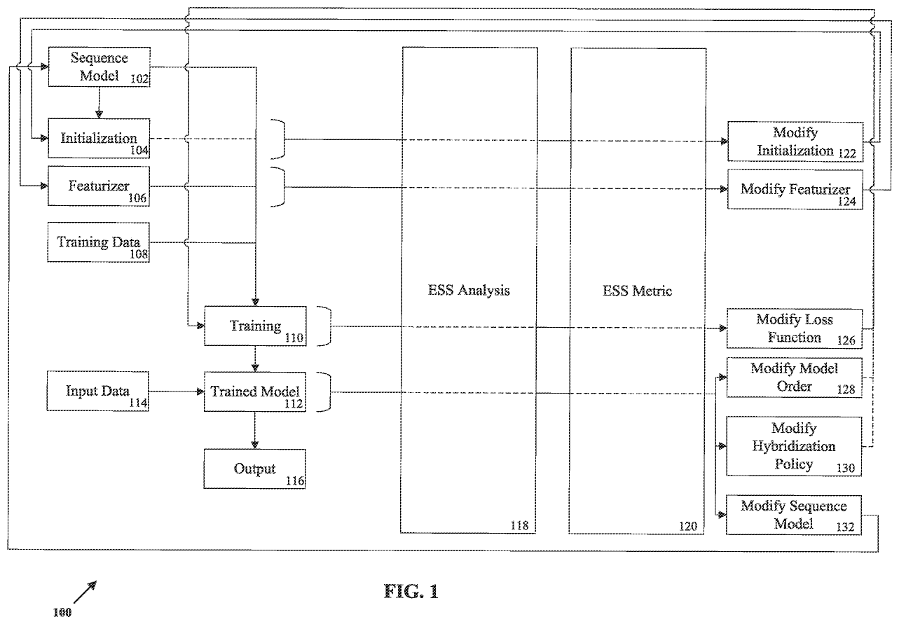

FIG. 1 illustrates an exemplary method 100 for configuring a sequence model using ESS analysis. Method 100 may be performed by a computer system comprising one or more processors and memory. The system may receive, access, or retrieve data representing one or more machine learning models to be analyzed and/or optimized. In some embodiments, the system may actively monitor a machine learning model during its training, automatically receiving data about the model at various stages as the training process progresses. At one or more stages before, during, or after the training process, the system may apply an ESS analysis to generate an ESS metric derived from data regarding the model configuration(including any training that the model has undergone). Based at least in part on the ESS metric, the system may automatically assess memory utilization of the model, and may automatically determine whether one or more modifications should be made to the model in order to improve memory utilization of the model. In some embodiments, the system may automatically select and apply one or more modifications to the model, and may then train and/or retrain the model following application of the one or more selected modifications. The trained and/or retrained model may, in some embodiments, be re-assessed using ESS-based analysis, and the process may be iterated until ESS and/or memory utilization criteria are satisfied for an optimized model. The optimized model may be automatically stored, transmitted, and/or deployed and applied in operation to one or more tasks for which is has been optimized.

Referring to FIG. 1, a sequence model 102 may be selected to undergo exemplary method 100. The sequence model 102 may be any sequence model that can materialize a linear operator, T, for example a sequence model that supports parallelization across the sequence dimension. The sequence model 102 may be formally expressed by a linear system, such that y=Tu (e.g., an input invariant linear system), or a system with input-varying linear operators, such that y=f(u)u, the latter of which may be abbreviated as LIV.

The sequence model 102 may have a model architecture associated with a model type. For example, model 102 may be a linear system and an input-varying linear operator (LIV) model type. In some embodiments, the sequence model 102 is a gated linear attention (GLA) model (e.g., includes only GLA layers), a weighted linear attention (WLA) model (e.g., includes only WLA layers), a linear attention (LA) model (e.g., includes only LA layers), a softmax attention (SA) model (e.g., includes only SA layers), a S6 model, or a GLA-S6 model. In some embodiments, the sequence model 102 is a hybrid sequence model, in which a hybrid sequence model has a hybrid neural network. In some embodiments, the sequence model 102 includes at least one channel mixing layer (MLP) and at least one sequence mixing layer, in which a sequence mixing layer is any sequence model layer described above.

As shown along the left edge of FIG. 1, model 102 may undergo a pre-training process that includes model initialization 104 and application of a featurizer 106. The model 102 may then undergo a training process 110 that uses training data 108 to train model 102 for application to a specific task. After training, model 102 may then take the form of trained model 112. (For simplicity herein, this disclosure may refer to the model in general, or to the model 102, which may be understood to refer to the model before training, during training, and/or after training (when it takes the form of model 112), unless specified otherwise.) The trained model 112 may be used to process input data 114 and to generate output data 116 when applied in operation to the task for which the model has been trained. Output 116 may be any output a trained model 112 may produce based on input data 114, for example at least one prediction, classification, or generative output.

As shown on the right half of FIG. 1, ESS analysis 118 may be applied to model 102 (or model 112) at various points during the model development process, including the pre-training stage, the training stage, and the post-training stage. In some embodiments, regardless of the stage at which the ESS analysis 118 is applied, the ESS analysis 118 may generate an ESS metric 120, which may be assessed by the system and used to automatically determine whether and how to modify the analyzed model. As shown along the left edge of FIG. 1, the system may determine whether and how various different modifications should be applied to the model, including modifications to initialization, featurization, loss function used for training, model order, hybridization, and/or to the selection of the model (e.g., the model architecture) itself. As explained in further detail below, different types of modifications to the model may be associated with different stages at which the ESS analysis 118 is applied during the model development process. Below, specific examples of different stages at which the ESS analysis may be applied, and specific associates examples of model modifications that may accordingly be selected and applied, are explained.

It should be noted that one or more of the modifications shown along the left side of FIG. 1 may be made individually based on one round of ESS analysis, or may be made iteratively based on multiple rounds of ESS analysis. The different kinds of modifications may be combined with one another in various combinations; for example, analysis of the model at the initialization stage (104) may be performed and modifications to the initialization may be made, and then analysis of the model featurizer (106) may be performed thereafter and modifications to the featurizer may be made. The process of optimizing the sequence model may thus iterate and build on itself through one or more ESS analyses applied at one or more stages of model development.

As shown at initialization stage 104, ESS analysis may be applied to model 102 after the model has been initialized. For instance, if the model 102 is a GLA model, the model 102 may be initialized in accordance with the hyperparameters described in Table 4. As shown at block 122, the ESS metric 120 may be evaluated and the system may determine whether and how to modify the initialization of the model. The initialization 104 of the sequence model 102 in weight space may play a crucial role in machine learning, significantly impacting model convergence and training stability. The initialization modification 122 may include choosing a new initialization or modifying at least one parameter of the initialization. For instance, the initialization modification 122 may include modifying at least one hyperparameter of the initialization, such as the hyperparameters described in reference to Table 2 and Table 4. Training may then be performed after the one or more modifications have been applied.

As shown at block 106, a featurizer may be selected and applied during the pre-training stage of model development. The featurizer 106 may be a function that maps inputs, for example training data 108 or input data 114, into features, for example f_{B}:u_{:i}→Bᵢ, and the features may be used to construct elements of the linear operator T. Specifically, the featurizer 106 may map the inputs to the operator T=f(u) or equivalently the recurrent features (Aᵢ(u_{:i}), Bᵢ(u_{:i}), Cᵢ(u:i), Dᵢ(u_{:i}))_{i∈[l]}. The featurizer 106 may be chosen by the user and/or at least one processor of at least one computing unit. In some embodiments, the featurizer 106 is a recurrent featurizer. In some embodiments, the featurizer 106 is a featurizer for a LA sequence model, a featurizer for a GLA sequence model, a featurizer for a WLA sequence model, a featurizer for a SA sequence model, a featurizer for an S6 sequence model, or a featurizer for a GLA-S6 sequence model.

The featurizer 106 may be analyzed at least once with the ESS analysis 118 and at least one ESS metric 120 may be produced from the ESS analysis 118. Based on the ESS metric 120, the featurizer may be modified at block 124, and the modified featurizer 124 may replace the original featurizer 106. The featurizer modification 124 may include choosing a new featurizer or modifying at least one parameter of the featurizer 106. Training may then be performed after the one or more modifications have been applied.

As shown at blocks 108 and 110, the model may be trained (process 110) for one or more tasks based on a set of training data 108 and based on the featurizer 106 and initialization 104. Training 110 may include performing any synthetic tasks. In some embodiments, the synthetic tasks may be multi-query associative recall (MQAR), selective copying, and/or compression because these synthetic tasks probe the ability of the sequence model 102 to effectively utilize its working memory.

The ESS analysis 118 may be applied at one or more instances during the training process in order to generate one or more instances of ESS metric 120. The ESS analysis 118 of training 110 may be performed after at least some training for performance of at least one synthetic task has been performed. The training 110 may be analyzed at least once with the ESS analysis 118 and at least once ESS metric 120 may be produced; the ESS analysis 118 may be performed at any time during training 110, for example at the beginning, middle, or end of training 110. Based on the ESS metric 120, the training process 110 may be modified, for example by modifying a loss function used during training, as shown at block 126. In some embodiments, modifying the loss function 126 includes adjusting a regularizer's strength. Adjusting the strength of the regularizer may push learnable matrices Aᵢ towards the identity I. The modified loss function may replace an original loss function associated with training 110. Training may then continue, or the model may be re-trained, after the one or more modifications have been applied.

As shown at block 112, the model after training 110 may take the form of a trained model. Post-training ESS analysis 118 may then be applied to the trained model. The trained model 112 may be analyzed at least once with the ESS analysis 118 and at least one ESS metric 120 may be produced. Based on the ESS metric 120, one or more modifications to the model may be made. In some embodiments, model-order modification (e.g., reduction) may be applied, as shown at block 128. The modified model order of the trained model 112 may be the result of a model-order reduction, which may be a process of improving model efficiency by reducing state-size while retaining model performance. In some embodiments, hybridization (e.g., a hybridization policy) of the trained model may be applied, as shown at block 130. The hybridization policy associated with the modified hybridization policy 130 may be the process of arranging different operators in a multi-layer sequence model. In some embodiments, the organization of the different operators may influence an ESS score for the model. In some embodiments, the model architecture itself (e.g., the base model) may be modified or replaced, as shown at block 132. The model may then be re-trained after the one or more modifications have been applied.

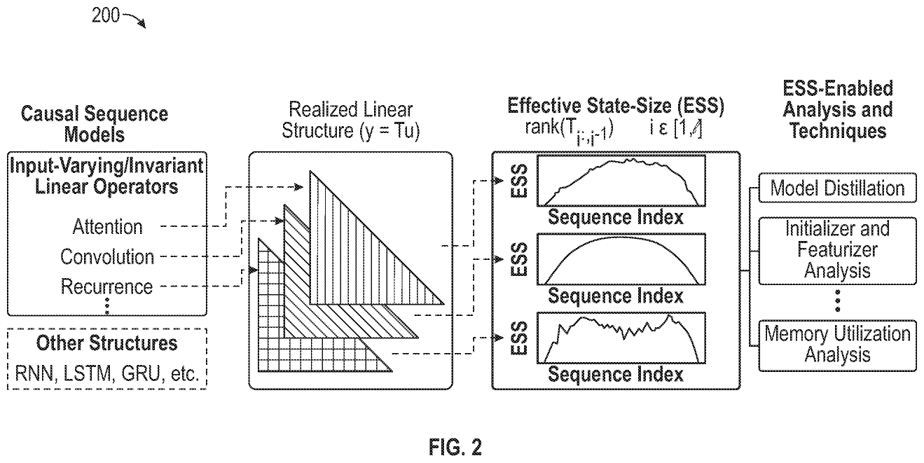

According to some embodiments, FIG. 2 illustrates a second exemplary method 200 for configuring a sequence model using ESS analysis, specifically FIG. 2 illustrates an overview of the ESS metric and its various downstream applications described herein.

### Derivation of ESS Analysis and ESS Metrics

The forthcoming description may utilize the following notation:
1. Inputs, outputs, and operators follow flattened notation (e.g., u, y∈ [symbol] ^{ld}, and T∈ [symbol] ^{ld×ld}). The original inputs and outputs with shape l×d are flattened in row-major ordering, resulting in T having l×l sub-blocks, in which a sub-block is of size d×d. The flattened notation may offer a general framework for formulating a wide range of operators and recurrences. As an example, an S5 layer (Smith et al., 2023), which mixes both the channels and sequence simultaneously, can be formulated as y=Tu (with the operator T described herein) in the same way an S4 layer can (Gu et al., 2022a), which only mixes the sequence. The difference between the S5 and the S4 models may be in the structure of T, such that for S4 Tᵢⱼ is diagonal, whereas for S5 Tᵢⱼ is not diagonal.
2. Tensor subscripts index sequence indices (time-step) and superscripts index channel/hidden dimensions (e.g., for an input u∈ [symbol] ^{ld}, uᵢ∈ [symbol] ^{d} denotes the input vector at sequence-index i, and u^{α}∈ [symbol] ^{l} denotes the input vector for channel α). Similarly, Tᵢⱼ∈ [symbol] ^{d×d} denotes the linear weighting of uⱼ onto yᵢ.
3. Indices within square brackets indicate matrix indices void of semantics (e.g., sequence index, channels, etc.). For example, A_{i[α,β]} indexes row a and column β of matrix Aᵢ.
4. Semicolons within subscripts denote a product over ranges. For example, A_{1;3}=A₁A₂A₃.
5. Tensor slices are denoted with colons and are inclusive over the ranges. For example, u_{0:2}=u₀u₁u₂.
6. The operator is denoted as T∈ [symbol] ^{dl×dl}, the inputs are denoted as u, the outputs are denoted as y∈ [symbol] ^{dl}, the sequence length is denoted as l, and the channel dimension is denoted as d.

A sequence model, for example model 102 for analysis by ESS analysis 118 as described herein, may effectively materialize a linear operator T; examples of the linear operator T may include Tᵢⱼ=CᵢBⱼ (e.g., a linear attention system), Tᵢⱼ=Kᵢ₋ⱼ (e.g., a convolution system), Tᵢⱼ=σ(CᵢBⱼ) (e.g., an attention system), Tᵢⱼ=CᵢAᵢ₋₁ . . . Aⱼ₊₁Bⱼ (e.g., a recurrence system), or Tᵢⱼ=CᵢKᵢ₋ⱼBⱼ (e.g., a gated convolution system). A linear system may have an input-invariant operator T. A LIV may be constructed via causal features that map past inputs into features (e.g., f_{B}:u_{:i}→Bᵢ), which may then be used to construct the elements of the linear operator T. An example of the linear system may be the convolution system described herein. An example of the LIV system may be an attention or gated convolution system described herein. A general linear recurrence for a linear system may be formulated as follows, where (Aᵢ∈ [symbol] ⁿ^{ᵢ₊₁}^{×n}^{ᵢ}, Bᵢ∈ [symbol] ⁿ^{ᵢ₊₁}^{×d}, Cᵢ∈ [symbol] ^{d×n}^{ᵢ}, Dᵢ∈ [symbol] ^{d×d})_{i∈[l]}, sᵢ is the state at sequence index i, and nᵢ is the state-size at sequence index i:

$${s}_{i + 1} = {A}_{i} {s}_{i} + {B}_{i} {u}_{i} \\ {y}_{i} = {C}_{i} {s}_{i} + {D}_{i} {u}_{i} \qquad Equation 1$$

Unrolling the recurrence in Equation 1 may result in the following:

$${s}_{0} = 0 \\ {s}_{1} = {B}_{0} {u}_{0} \\ {s}_{2} = {B}_{1} {u}_{1} + {A}_{1} ( {B}_{0} {u}_{0} ) \\ {s}_{3} = {B}_{2} {u}_{2} + {A}_{2} ( {B}_{1} {u}_{1} + {A}_{1} ( {B}_{0} {u}_{0} ) ) \\ {s}_{i} = ( {\sum }_{j = 0}^{i - 1} [ {\prod }_{k = i - 1}^{j + 1} {A}_{k} ] {B}_{j} {u}_{j} ) \qquad Equation 2$$

$${y}_{i} = {C}_{i} ( {\sum }_{j = 1}^{i - 1} [ {\prod }_{k = i - 1}^{j + 1} {A}_{k} ] {B}_{j} {u}_{j} ) + {D}_{i} {u}_{i} \qquad Equation 3$$

Equation 2 may correspond to the following linear operator:

$${T}_{ij} = \{ \begin{matrix}0 , & i < j \\ {D}_{i} , & i = j \\ {C}_{i} {A}_{i - 1 ; j + 1} {B}_{j} , & i > j\end{matrix} \qquad Equation 4$$

A general linear recurrence for the LIVs may be as follows:

$${s}_{i + 1} = {A}_{i} {s}_{i} + {B}_{i} {f}_{u} ( {u}_{i} ) \\ {y}_{i} = {C}_{i}^{T} {s}_{i} + {D}_{i} {f}_{u} ( {u}_{i} ) .$$

For any given input-invariant operator T (e.g., linear system), there exist infinite recurrent realizations in the form of Equation 1 (and Equation 2 and 3), which may motivate the search for the minimal recurrent realization (see Theorem 3.1 below).

Theorem 3.1. Given any causal input-invariant operator T, there exist infinite variations of linear recurrences in the form of Equation 1 that realize an equivalent input-output operator.

The ESS analyses described herein may be formulated from the linear system and LIV described herein. For example, the proof of Theorem 3.1, described herein, may demonstrate that the operator submatrices Hᵢ can be decomposed arbitrarily into two state-projection matrices, [symbol] ᵢ and [symbol] ᵢ, whose inner product dimension defines the state size of its recurrent realization at sequence index i. By the rank-nullity theorem, rank (Hᵢ) represents the minimum inner product dimension of any such state-projection matrices and thus corresponds to the minimally realizable state size of the operator T at sequence index i. The resulting metric

$${n}_{i}^{*} = rank ( {H}_{i} )$$

may be referred to as effective state-size (ESS) (see Theorem 3.2 below).

Theorem 3.2. The rank of the operator submatrix (Hᵢ=T_{i:,:i-1}) determines the minimal state size required to represent the causal operation (y=Tu) as a recurrence.

The ESS of the input-invariant linear system may be given by the system's minimal state-size, which is directly interpretable as a measure of model memory utilization. For LIVs, however, the minimal realization process, described herein, may no longer be guaranteed to obtain recurrences that preserve causality (e.g., the minimally realized features Aᵢ* depend on future inputs uₖ, k>i). Nevertheless, ESS may lower bound the state-size nᵢ, meaning that for any LIV, an equivalent recurrence must necessarily materialize a state-size at least as large as its ESS. Therefore, ESS may serve as a proxy for model memory utilization in LIVs as well. For LIVs, ESS may be associated with the model's functional form, the input data, optimization, and more generally, anything that impacts the realization of T.

The memory capacity of LIVs may be given by the state-size nᵢ, and the memory capacity may be referred to as theoretically realizable state-size (TSS) because it serves as a tight upper bound for ESS. For LIVs, TSS may be associated with the model's functional form. Similarly, TSS may be associated with the model's functional form for linear systems (e.g., any system that may be expressed by a matrix vector product between a linear operator, T, and an input, u, such as described in reference to FIG. 1). Because TSS may be associated only with the model's functional form, ESS analysis may measure meaningful differences across architectures, including architectures that possess the same or similar TSS. Additionally, within a single model, ESS analysis may be used to compare memory utilization on a per-token basis.

Computing an ESS metric may require considerations due to numerical errors and approximations. At least two approaches may be used: tolerance-ESS or entropy-ESS. Broadly, tolerance-ESS and entropy-ESS may rely on singular values (Σᵢ) obtained from taking the singular value decomposition (SVD) of Hᵢ. In some embodiments, a tolerance value is selected to threshold the singular values of Hᵢ, such that the tolerance-ESS metric is defined as follows:

$$tolerance - ESS ( {H}_{i} , τ ) := \vert \{ {σ}_{i}^{m} : {σ}_{i}^{m} > τ \} \vert , where {σ}_{i}^{m} ∈ {Σ}_{i} , {U}_{i} diag ( {Σ}_{i} ) {V}_{i} = SVD ( {H}_{i} ) .$$

According to the Eckart-Young-Mirsky theorem, the tolerance-ESS metric may be interpreted as the minimum state size necessary for an input-invariant recurrence to approximate the original operator, such that the spectral norm of the approximation error remains below the specified tolerance level

$$( {‖ {T}_{ij} - {T}_{ij}^{*} ‖}_{2} \leq τ ) .$$

A drawback of tolerance-ESS may be its reliance on the somewhat arbitrary selection of a tolerance value. Instead, entropy-ESS may be computed by computing the effective rank, which involves exponentiating the normalized spectral entropy (e.g., perplexity) of Hᵢ:

$$entropy - ESS ( {H}_{i} ) := exp ( - {\sum }_{m} {p}_{i}^{m} log ( {p}_{i}^{m} ) ) , where {p}_{i}^{m} = \frac{{σ}_{i}^{m}}{{‖ {σ}_{i} ‖}_{1}} .$$

In contrast to the tolerance-based ESS metric, which is discrete, entropy-ESS may assume continuous values ranging from 1 to |Σᵢ| and does not require the selection of a tolerance value. However, the normalization applied to the singular values in entropy-ESS computation results in the loss of absolute values, which may be significant for per-sequence-index comparisons of state size. Nonetheless, both the tolerance-based and entropy-based forms of ESS may be valuable for model analysis. Entropy-ESS may be particularly useful for summarizing metrics across the entire tolerance space, whereas tolerance-ESS may offer a more precise and readily interpretable depiction of rank concerning approximation error. In some embodiments, consistent experimental trends are observed between entropy-ESS and tolerance-ESS when the metrics are marginalized over the sequence length. Calculating the effective rank may cause numerical instability when

$${p}_{i}^{m}$$

approaches 0 due to the logarithmic term, but the numerical instability may be partially mitigated by clipping the normalized singular values.

In some embodiments, ESS is computed separately for each sequence index of the input on a per-channel, per-layer basis; it may be possible to compute ESS separately for each sequence index because the sequence models described herein have decoupled channel mixing and sequence mixing. ESS may be computed using the standard operator formulation T∈ [symbol] ^{l×l}. In some embodiments, computing ESS separately for each sequence index is significantly more efficient than computing ESS for the multi-channel (e.g., flattened) representation. The ESS computation may be further reduced to only the h independents for attention layers or the like because the operator (e.g., the attention matrix) is shared across channels within the same head. The shape of the unprocessed ESS tensor for a multi-layered model processing a batch of sequences may be:
(batch-size, layers, heads or channels, sequence length−1)

Unless otherwise stated, ESS of a given model is a single-number summary, which is obtained by averaging across the layer, channel, sequence, and batch size dimensions. In analyses that also include a different metric, for example the total ESS, the single-number ESS may be referred to as the average ESS. Total ESS may be computed by first summing the ESS across channels and then averaging over the remaining dimensions. The total ESS may be particularly useful for a non-recurrent model, for example a SA model, in which the average TSS (computed analogous to the average ESS) depends only on the sequence index i. As such, the average TSS may remain constant irrespective of model width (e.g., channel dimension) for non-recurrent models, like the SA model. In contrast, the total ESS (and analogously total TSS) may change as a function of model width. In analyses that compare ESS to TSS, total ESS may serve as a more informative metric than the average ESS.

In some embodiments, the time complexity of computing ESS on a model with M layers, D channels, sequence length L, and batch size B is O(L³nBDM) because SVD scales cubically in the size of a square matrix. As such, ESS may be a costly metric to compute for long sequence lengths. In some embodiments, for example in models with bounded (e.g., n<<L) and fixed TSS, a truncated SVD is used to reduce the time complexity to O(L²nBDM) for computing ESS, such as entropy-ESS and/or tolerance-ESS. The time complexity may be further reduced by a factor of the head dimension in models that have channels that share the same recurrence within the same head.

In some embodiments, ESS is formulated as a per-sequence index metric that may be generally applicable to all models that realize the operator T. For single-input-single-output (SISO) models, ESS can be extended along the channel dimension, and particularly for LIV SISO models, ESS can be further extended along the batch size dimension as ESS is a function of the input. As such, for a multi-layer LIV SISO model with m layers, d channels, batch size b, and sequence length l: ESS∈ [symbol] ^{m×d×b×l}. Since ESS is a multidimensional tensor, there may be various means to aggregate ESS across the model and data dimensions. In some embodiments, a mode of aggregation termed average ESS and a mode of aggregation termed total ESS is defined. The average ESS may be defined as follows:

$$average ESS = \frac{1}{mdbl} {\sum }_{α ∈ [ d ]} {\sum }_{β ∈ [ m ]} {\sum }_{γ ∈ [ b ]} {\sum }_{i ∈ [ l ]} {ESS}_{i}^{αβγ} .$$

The total ESS may be defined as follows:

$$total ESS = average ESS * d .$$

In some embodiments, for models (e.g., softmax attention) where average TSS (which is computed analogously to average ESS) depends only on the sequence index i and thus remains constant as a function of model width (e.g., channel dimension), a model-dependent statistic may be determined by summing the ESS across channels and then averaging over the remaining dimensions. This approach may allow ESS and TSS to vary as a function of model width.

Theorem 3.1, Theorem 3.2, and the explanations described herein, provide a derivation of ESS analysis, and the following derivation may be used to supplement the aforementioned derivation. According to Equation 5 below, factorizing the strictly lower triangular submatrices of the operator T_{i:,:i-1} into causal and anti-causal factors, may reveal that nᵢ(i.e., the TSS) upper bounds the dimensionality of the inner product between the factors, and thus, also the rank of the submatrix (nᵢ≥rank(Hᵢ)).

$$\begin{matrix}{T}_{i : , : i - 1} ≡ {H}_{i} = [ \begin{matrix}{C}_{i} & & \\ & ⋱ & \\ & & {C}_{ℓ - 1}\end{matrix} ] [ \begin{matrix}{A}_{i - 1 ; 1} & … & I \\ ⋮ & ⋱ & ⋮ \\ {A}_{ℓ - 2 ; 1} & … & {A}_{ℓ - 2 ; i}\end{matrix} ] [ \begin{matrix}{B}_{0} & & \\ & ⋱ & \\ & & {B}_{i - 1}\end{matrix} ] \\ = [ \begin{matrix}{C}_{i} & & \\ & ⋱ & \\ & & {C}_{ℓ - 1}\end{matrix} ] [ \begin{matrix}I \\ {A}_{i} \\ {A}_{i + 1 ; i} \\ ⋮ \\ {A}_{ℓ - 2 ; i}\end{matrix} ] [ {A}_{i - 1 ; 1} {A}_{i - 1 ; 2} … {A}_{i - 1} I ] [ \begin{matrix}{B}_{0} & & \\ & ⋱ & \\ & & {B}_{i - 1}\end{matrix} ] \\ = {{{[ \begin{matrix}{𝒞}_{i} \\ {𝒞}_{i + 1} {A}_{i} \\ {𝒞}_{i + 2} {A}_{i + 1 ; i} \\ ⋮ \\ {𝒞}_{ℓ - 1} {A}_{ℓ - 2 ; i}\end{matrix} ]}_{⎵}}_{d ( ℓ - i ) \times {n}_{i}}}_{anti - casual} {{{[ {A}_{i - 1 ; 1} {B}_{0} {A}_{i - 1 ; 2} {B}_{1} … {A}_{i - 1} {B}_{i - 2} {B}_{i - 1} ]}_{⎵}}_{{n}_{i} \times {d}_{i}}}_{casual} ≡ {𝒪}_{i} {𝒞}_{i}\end{matrix} \qquad Equation 5$$

Besides revealing the relationship between the rank of the realized operator and the original state-size nᵢ, the decomposition may also reveal that the causal portion [symbol] ᵢ is the input-state projection matrix at a time-step i (i.e., sᵢ= [symbol] ᵢu_{:i-1}) corresponding to Equation 2. The decomposition may also reveal that ESS (rank(Hᵢ)) is the minimum rank between the causal and anti-causal projections. Furthermore, the decomposition may reveal that in conjunction with Theorem 3.2, the causally determinable minimal state-size (causal ESS) is equivalent to the rank of the causal projection, which may allow for a more efficient realization of the recurrence, such that (1) the causal projection can be minimally factorized as [symbol] ᵢ=LᵢRᵢ, where Lᵢ∈Rⁿ^{ᵢ}^{×r} and Rᵢ∈R^{r×di}, with r=rank( [symbol] ᵢ), (2) the right factor Rᵢ may become the new input-state projection matrix for Hᵢ, effectively reducing the state dimension to the causal ESS, and (3)

$${A}_{i - 1}^{*} and {B}_{i - 1}^{*}$$

can be determined from Rᵢ using the process outlined in Theorem 3.1 and

$${C}_{i}^{*} = {C}_{i} {L}_{i} .$$

In some embodiments, any input-varying and input-invariant causal operator can be trivially realized with the following recurrence:

$${s}_{i + 1} = [ \begin{matrix}{I}_{( di )} \\ {0}_{( d )}\end{matrix} ] {s}_{i} + [ \begin{matrix}{0}_{( di )} \\ {I}_{( d )}\end{matrix} ] {u}_{i} , \qquad Equation 6$$

$${y}_{i} = [ {T}_{i , 0} {T}_{i , 1} … {T}_{i , i - 1} ] {s}_{i} + {T}_{i , i} {u}_{i} .$$

The state sᵢ may store each input from t∈[i−1], which may then be mapped to the output with operator features at row i. In some embodiments, where the operator is input varying, this trivial realization upholds the causality of the featurization process (i.e., the features (Aᵢ, Bᵢ, Cᵢ, Dᵢ)_{i∈[l]} of the trivial realization are causally determined). Moreover, the causally determined ESS, as derived above, for the trivially realized recurrence is equivalent to its TSS, as [symbol] ᵢ=I_{di}.

In some embodiments, a minimal recurrent realization is a proof of Theorem 3.1. First, the operator may be categorized into two portions, for example the memoryless portion, where i=j, and the dynamical portion, where i>j. The memoryless portion may be trivially realized by setting Dᵢ=Tᵢᵢ. For the dynamical portion, the proof of existence may be approached in accordance with the following:
1. As described herein, given a linear recurrence in the form of Equation 1, the operator submatrix can be factorized into causal and anti-causal parts, where the causal part represents the input-state projection matrix. Given this factorization, the following ansatz can be made: for any operator submatrix T_{i;,;i-1}≡Hᵢ, Hᵢ can be arbitrarily factorized into [symbol] ᵢ∈ [symbol] ^{d(l-i)×n}^{ᵢ} and [symbol] ∈ [symbol] ⁿ^{ᵢ}^{×di} and that [symbol] ᵢ represents the input-state projection at time-step i (i.e., sᵢ= [symbol] u_{:i-1}).
2. Given the above ansatz, the dynamic features (Aᵢ, Bᵢ, Cᵢ)_{i∈[l]} may be constructed such that the ansatz holds. It may be assumed that the initial and final states are 0 without loss of generality, such that the realization of C₀, A₀, Aₗ₋₁, and Bₗ₋₁ may be ignored.
   a. Set Cᵢ= [symbol] _{i[:d-1]} to obtain (Cᵢ)_{i∈[1,l]}, as given the assumptions above, the first set of rows of [symbol] ᵢ linearly projects sᵢ onto yᵢ−Dᵢuᵢ, which is identical to Cᵢ in Equation 1.
   b. Set Bᵢ₋₁= [symbol] _{i[:d-1]} to obtain (Bᵢ)_{i∈[l-1]}, for which the identity can be obtained by deconstructing the input-state projection matrix [symbol] ᵢ and equating its assumed state sᵢ with Equation 1.

$${s}_{i} = {A}_{i - 1} {s}_{i - 1} - {B}_{i - 1} {u}_{i - 1} = {𝒞}_{i [ : , : - d - 1 ]} {u}_{: i - 2} + {𝒞}_{i [ : , : - d : ]} {u}_{: - 1}$$

c. Using the same state-dynamics equation, the assume state-projection matrices could be equated with each other, obtaining (Aᵢ)_{i∈[1,l-1]}:

$${s}_{i + 1} = {A}_{i} {s}_{i} + {B}_{i} {u}_{i}$$

$${𝒞}_{i + 1} {u}_{: i} = {A}_{i} {𝒞}_{i} {u}_{: i - 1} + {𝒞}_{i + 1 [ : , - d : ]} {u}_{i}$$

$${𝒞}_{i + 1 \{ : , : - d - 1 ]} {u}_{: i - 1} = {A}_{i} {𝒞}_{i} {u}_{: i - 1}$$

$${A}_{i} = {𝒞}_{i + 1 \{ : , : - d - 1 ]} {𝒞}_{i}^{+}$$

3. Verify that the realized recurrence maps back to the original operator Tᵢⱼ, proving that the arbitrary factorization (of which there are infinite variation) of the operator submatrices can be used to construct equivalent operators.

$${T}_{ij} = {C}_{i} {A}_{i - 1} … {A}_{j + 1} {B}_{j} = {𝒪}_{i [ : d - 1 ]} {𝒞}_{i [ : , : - d - 1 ]} … {𝒞}_{j + 2}^{+} {𝒞}_{j + 2 [ : , : - d - 1 ]} {𝒞}_{j + 1}^{+} {𝒞}_{j + 1 [ : , - d : ]} = {𝒪}_{i [ : d - 1 ]} {𝒞}_{i [ : , : - d - 1 ]} {I}_{[ : , : ( j + 1 ) d - 1 ]} {I}_{[ : , - d : ]} = {𝒪}_{i [ : d - 1 ]} {𝒞}_{i [ : , : - d - 1 ]} = {H}_{i [ : d - 1 , jd : ( j + 1 ) d - 1 ]} = {T}_{ij}$$

As an example, Hᵢ can be factorized with SVD as follows:

$${𝒪}_{i} {𝒞}_{i} = ( {U}_{( r )} {D}_{( r )}^{1 / 2} ) ( {D}_{( r )}^{1 / 2} {V}_{( r )} ) ,$$

where U₍ᵣ₎∈ [symbol] ^{m×r}, D₍ᵣ₎∈ [symbol] ^{r×r}, and V₍ᵣ₎∈ [symbol] ^{r×n} are the r-truncated SVD decompositions, and r=rank of Hᵢ∈ [symbol] ^{m×n}. These factors can then be used to realize a minimal recurrence as described above.

### Sequence Model Formulations

As described herein, for example in reference to the sequence model 102 in FIG. 1, in some embodiments, the sequence model 102 is a GLA, WLA, LA, SA, S6, or GLA-S6 model. It can be demonstrated that linear attention models are state-space models (SSMs), which may serve as the foundation for the formulation of the models, for example the GLA and WLA, below. A single linear attention head with dimension d/h may be formulated as:

$$y = {qk}^{T} v ,$$

in which q, k, v∈ [symbol] ^{l×d/h} are input features. They can be reformulated as recurrences with matrix-valued states sᵢ∈R^{d/h×d/h} as follows (Katharopoulos et al., 2020):

$${s}_{i} = {s}_{i - 1} + {k}_{i} {v}_{i}^{T}$$

$${y}_{i} = {q}_{i}^{T} {s}_{i} .$$

Without loss of generality, applying column-major flattening to the matrix-valued state and treating vᵢ as the input uᵢ, the recurrence may be formulated like Equation 1, by setting Aᵢ=I_{(d/h)}_{²} and:

$${B}_{i - 1} = [ \begin{matrix}{k}_{1}^{i} & 0 & … & 0 \\ ⋮ & ⋮ & ⋱ & ⋮ \\ \text{?} & 0 & … & 0 \\ 0 & \text{?} & … & 0 \\ ⋮ & ⋮ & ⋱ & ⋮ \\ 0 & \text{?} & … & 0 \\ ⋮ & ⋮ & ⋱ & ⋮ \\ 0 & 0 & … & \text{?} \\ ⋮ & ⋮ & ⋱ & ⋮ \\ 0 & 0 & … & \text{?}\end{matrix} ] , {C}_{i} = [ \begin{matrix}{q}_{i}^{1} & … & \text{?} & 0 & … & 0 & … & 0 & … & 0 \\ 0 & … & 0 & \text{?} & … & \text{?} & … & 0 & … & 0 \\ ⋮ & ⋱ & ⋮ & ⋮ & ⋱ & ⋮ & … & ⋮ & ⋱ & ⋮ \\ 0 & … & 0 & 0 & … & 0 & … & {q}_{i}^{1} & … & \text{?}\end{matrix} ]$$

$$\text{?} \text{indicates text missing or illegible when filed}$$

Each individual channel forms a single-input-single-output (SISO) recurrence (like many of the SSM architectures including S4, S7, Mamba2, and more), as there is no mixing across channels. Additionally, each of these SISO recurrences has a state-size of d/h.

In some embodiments, the LA model, and/or LA layer, is based on Katharopoulos et al. (2020), and A (gating term) is not trainable and is instead fixed as the identity matrix. In some embodiments, the LA model is defined by the following equations:

$${A}^{k} = I ,$$

$${B}_{i - 1}^{k} = RoPE ( {W}_{B}^{k} {u}_{i} ) ,$$

$${C}_{i}^{k} = RoPE ( {W}_{C}^{k} {u}_{i} ) ,$$

$${f}_{u} ( {u}_{i} ) = {W}_{u}^{k} {u}_{i} ,$$

where

$${W}_{C}^{k} , {W}_{B}^{k} , {W}_{u}^{k} ∈ {ℝ}^{d / h \times d} ;$$

d and h represent the number of channels and heads, respectively. A may be a fixed identity matrix. In some embodiments, the per-channel TSS is

$${n}_{i}^{k} = d / h ,$$

and the total TSS is d²/h. In some embodiments, each channel c∈[d] is grouped into heads, where the head index corresponding to the channel is given by k=[ch/d], and within a head, all corresponding projection matrices

$$( {W}_{C}^{k} , {W}_{B}^{k} , etc . )$$

are weight tied (e.g., shared). In some embodiments, a rotational positional encoding (RoPE) is by default applied to the B and C projections.

In some embodiments, the GLA model, and/or GLA layer, implements the gated linear attention formulation described in Yang et al. (2024a), where the recurrent feature A (gating term) is input-varying, placing it in the same class as models like Liquid-S4 (Hasani et al., 2022) and Mamba (Gu & Dao, 2024; Dao & Gu, 2024). In some embodiments, the GLA model is defined by the following equations:

$${A}_{i - 1}^{k} = diag ( {sigmoid ( {W}_{{A}_{2}}^{k} {W}_{{A}_{1}} {u}_{i} )}^{1 / β} ) ,$$

$${B}_{i - 1}^{k} = {W}_{B}^{k} {u}_{i} ,$$

$${C}_{i}^{k} = {W}_{C}^{k} {u}_{i} ,$$

$${f}_{u} ( {u}_{i} ) = {W}_{u}^{k} {u}_{i} ,$$

where besides having projections identical to those in the LA model, W_{A}_{₁}∈ [symbol] ^{16×d} and

$${W}_{{A}_{2}}^{k} ∈ {ℝ}^{d / h \times 16} .$$

In some embodiments, the per-channel TSS is nᵢ^{k}=d/h and the total TSS is d²/h. In some embodiments, β=16.

In some embodiments, the WLA model, and/or WLA layer, is nearly identical to GLA, but with an input-invariant A matrix, placing it in the same class as Hyena-S4D (Poli et al., 2023), RetNets (Sun et al., 2023), and gated-convolutions in general. In some embodiments, the WLA model is defined by the following equations:

$${A}^{k} = diag ( {sigmoid ( {Â}^{k} )}^{1 / β} ) ,$$

$${B}_{i - 1}^{k} = {W}_{B}^{k} {u}_{i} ,$$

$${C}_{i}^{k} = {W}_{C}^{k} {u}_{i} ,$$

$${f}_{u} ( {u}_{i} ) = {W}_{u}^{k} {u}_{i} ,$$

where W_{C}, W_{B}, and Wᵤ are identical to those in LA, and Â^{k}∈ [symbol] ^{d/h} is explicitly parameterized and initialized to 0. In some embodiments, the per-channel TSS is nᵢ^{k}=d/h, and the total TSS is d²/h.

In some embodiments, the SA model, and/or SA layer, is the canonical attention layer which is similar to linear attention, but with the addition of a softmax non-linearity applied to the attention matrix (Vaswani et al., 2023), enabling unbounded TSS. In some embodiments, the SA model is defined by the following equations:

$${\hat{B}}_{i}^{k} = RoPE ( {W}_{B}^{k} {u}_{i} ) ,$$

$${\hat{C}}_{i}^{k} = RoPE ( {W}_{C}^{k} {u}_{i} ) ,$$

$${T}_{k} = softmax ( {{\hat{C}}^{k} ( {\hat{B}}^{k} )}^{T} ) ,$$

$${f}_{u} ( {u}_{i} ) = {W}_{u}^{k} {u}_{i} ,$$

where W_{C}, W_{B}, and Wᵤ are identical to those in LA, and T is converted into a recurrence using the trivial realization in Equation 6. In some embodiments, the per-channel TSS is i, and the total TSS is id. In some embodiments, a rotational positional encoding (RoPE) is by default applied to the \hat{B} and Ĉ projections (Su et al., 2023).

In some embodiments, the S6 model (Gu & Dao, 2024) is defined by the following equations:

$${Δ}^{c} = softplus ( {W}_{Δ}^{c} {u}_{i} + {b}^{c} ) ,$$

$${A}_{i - 1}^{c} = diag ( exp ( - {Â Δ}^{c} ) ) ,$$

$${B}_{i - 1}^{c} = {Δ}^{C} {W}_{B} {u}_{i} ,$$

$${C}_{i} = {W}_{C} {u}_{i} ,$$

where Â∈ [symbol] ⁿ is initialized to [1 2 . . . n]^{T}, c is the channel index, W_{C}, W_{B}∈ [symbol] ^{n×d}, and

$${W}_{Δ}^{C} ∈ {ℝ}^{1 \times d} .$$

In some embodiments, the per-channel TSS is n, and the total TSS is nd. In some embodiments, S6 resembles GLA by setting n=d/h, with the following exceptions: (1) S6 has only one (not h) different projection matrices for B and C, (2) S6 has channel-wise projections for the input-varying discretization applied to B and C, (3) S6 has an explicitly parameterized vector valued Â, and (4) S6 has some minor differences in the non-linearly applied to keep 0<A<1. In some embodiments, like GLA, S6 also has diagonal A matrices, whereas in Mamba2 Dao & Gu (2024), the A matrix is scalar-valued. In some embodiments, the B and C projections in Mamba2 more closely resemble GLA.

In some embodiments, the GLA-S6 model is defined by the following equations:

$${A}_{i - 1}^{h} = diag ( exp ( - {[ 1 / α 2 / α … n / α ]}^{T} ⊙ softplus ( {W}_{{A}_{2}}^{h} {W}_{{A}_{1}} {u}_{i} ) ) ) ,$$

$${B}_{i - 1}^{h} = {W}_{B}^{h} {u}_{i} ,$$

$${C}_{i}^{h} = {W}_{C}^{h} {u}_{i} ,$$

$${f}_{u} ( {u}_{i} ) = {W}_{u}^{k} {u}_{i} .$$

In some embodiments, the GLA-S6 model is a combination of S6 and GLA, such that the B and C projections are identical to that of GLA, while A is featurized similarly to S6. The GLA-S6 model may have identical W_{B}, W_{C}, and Wᵤ to those found in the LA model, thus the per-channel TSS, in some embodiment, is d/h, and the total TSS is d²/h. In some embodiments, the A matrix is featurized with the arange term ([1 2 . . . n]^{T}), like S6. In some embodiments, the normalization hyperparameter a is added to control the rate at which elements of A decay to 0.

### Training Parameters

Model training, for example training 110 as referenced in FIG. 1, may include training for performance of one or more synthetic tasks. The synthetic tasks may include MQAR, selective copying, and/or compression. In some embodiments, the default vocabulary size for the MQAR and selective copying tasks is 8192 (Arora et al., 2023), and the vocabulary size for the compression tasks is varied to modulate task difficulty. According to some embodiments, Table 1 illustrates the set of hyperparameters, otherwise referred to as task settings, used in model training.

TABLE 1

| Configuration | Value(s) |
|---|---|
| Tasks | MQAR, selective copying, compression |
| Num. key-value pairs | 8, 16, 32, 64, 128 |
| Num. tokens to copy | 8, 16, 32, 64, 128 |
| Vocab size (compression) | 8, 16, 32, 64, 128 |
| Vocab size | 8192 |
| (MQAR and selective copying) | |
| Sequence length | 64, 128, 256, 512, 1024, 2048 |
| Model (featurizer) | GLA, LA, WLA, SA |
| Model width | 64, 128, 256, 512 |
| Number of heads | 4.8 |
| Optimizer | AdamW |
| Learning Rate | 0.002 |
| Weight Decay | 0.1 |
| Batch Size | 64 |
| Epochs | 70 |
| Steps Per Epoch | 2000 |
| Num. Training Samples | 128k |
| Num. Testing Samples | 6.4k |

In some embodiments, other task settings not specified in Table 1 are defaulted to the task settings in Arora et al. (2023). In some embodiments, constraints are placed on the tasks; the constraints may be similar, or the same, as constraints in Arora et al. (2023). In some embodiments, a task constraint is placed on the MQAR tasks such that 4*num kv pairs≤seq len. In some embodiments, a task constraint is placed on the selective copying task such that 2*num tokens to copy<seq len. In some embodiments, if the task settings illustrated in Table 1 violate the task constraints on MQAR tasks and selective copying tasks, the task configuration for a given sequence model is not trained. In some embodiments, the task difficulty is modulated within each task. For example, the task difficulty of MQAR may be modulated with the number of key-value (kv) pairs the models are tasked to match, as well as the total sequence length of the prompt. In some embodiments, TSS is varied for a given sequence model. In some embodiments, for a given task-model configuration in Table 1, the ESS and accuracy on a validation set is computed every 10 epochs.

### Analysis of ESS Metrics

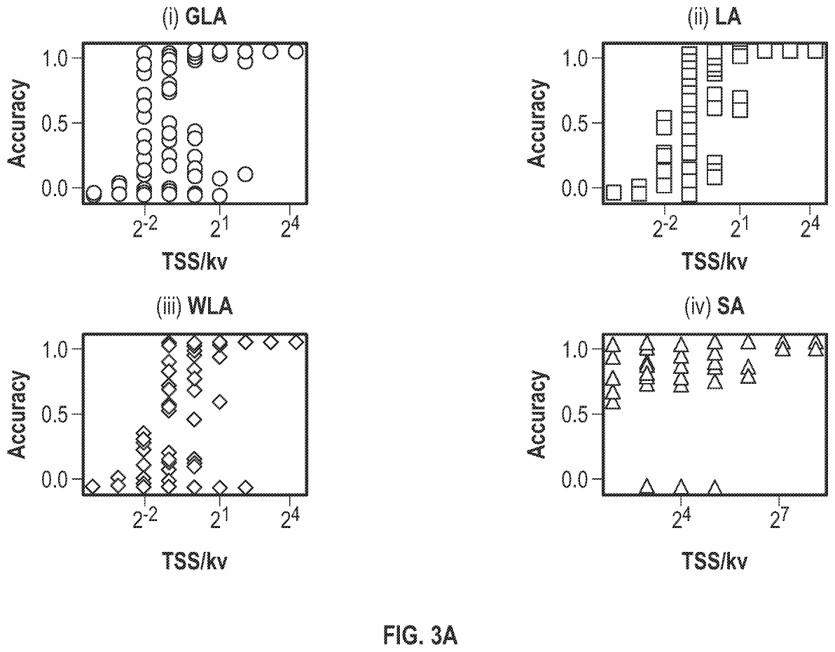

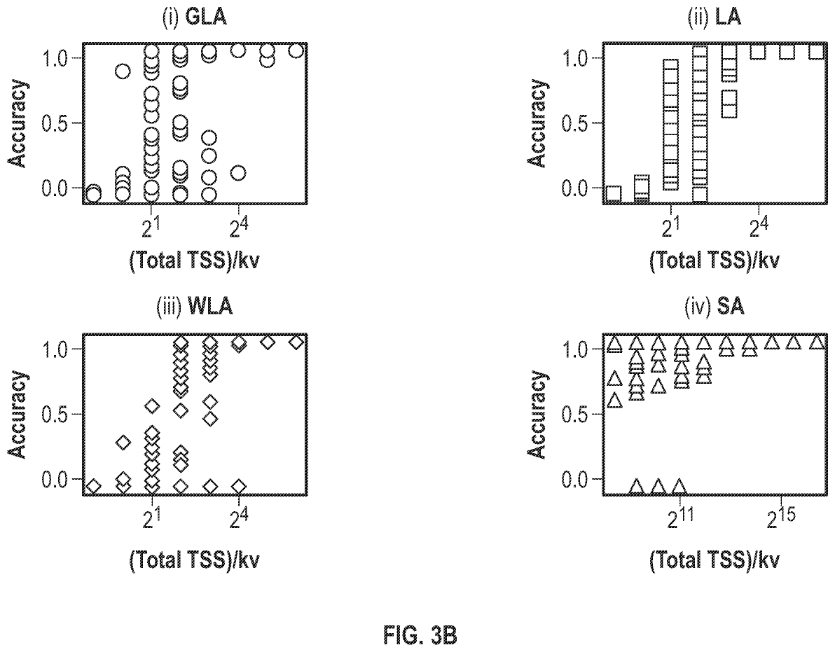

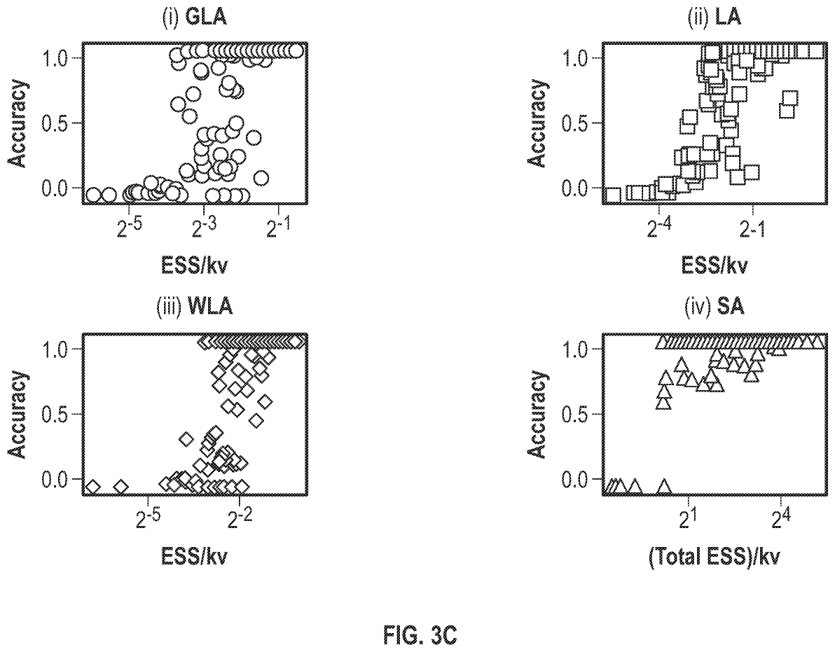

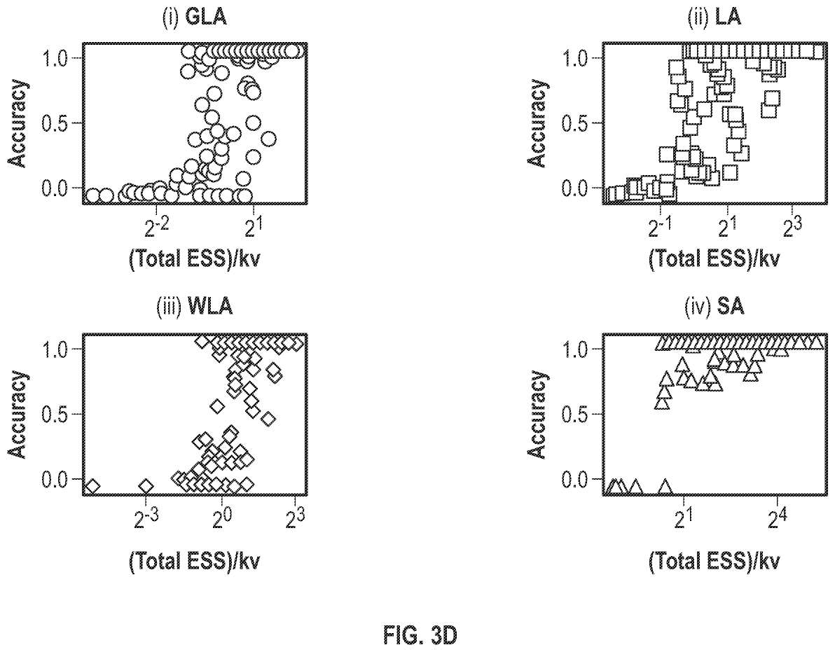

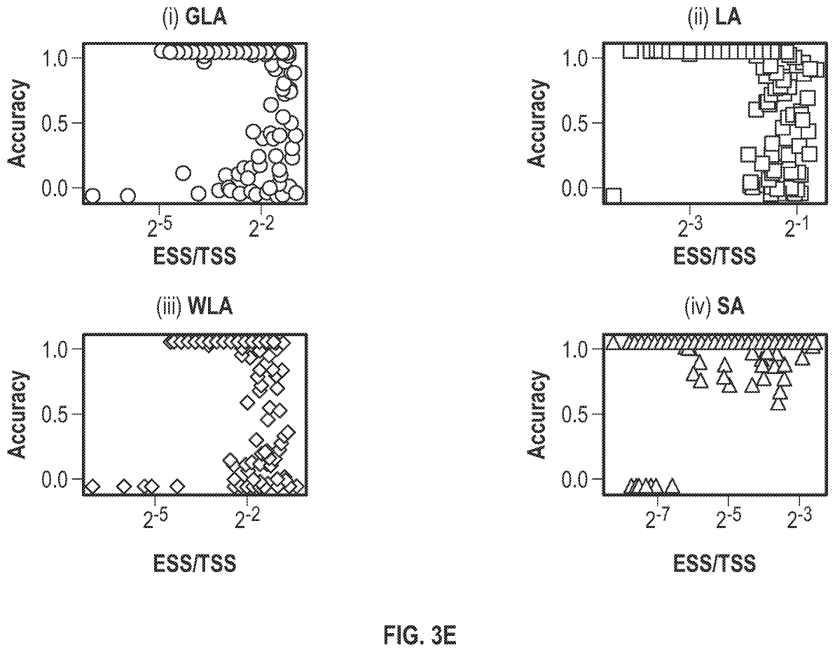

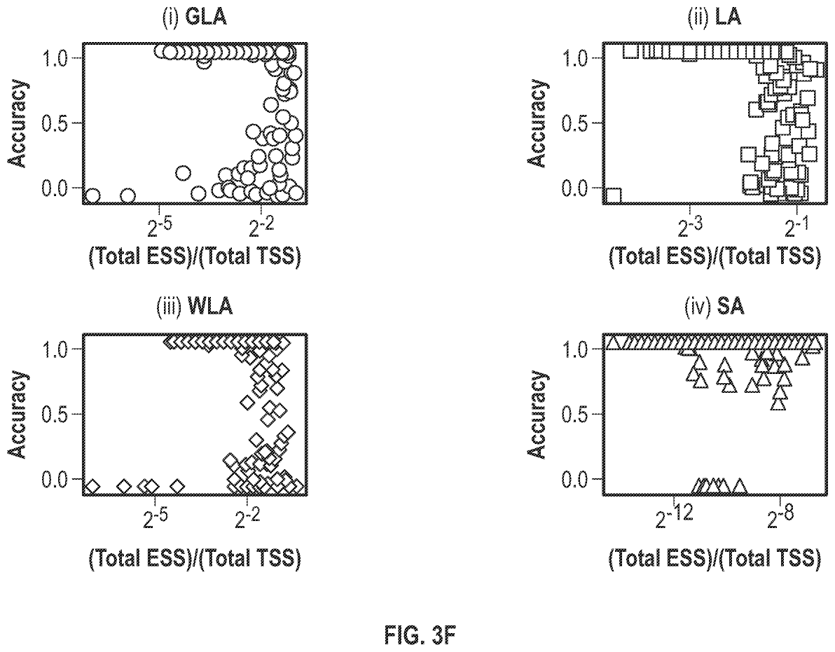

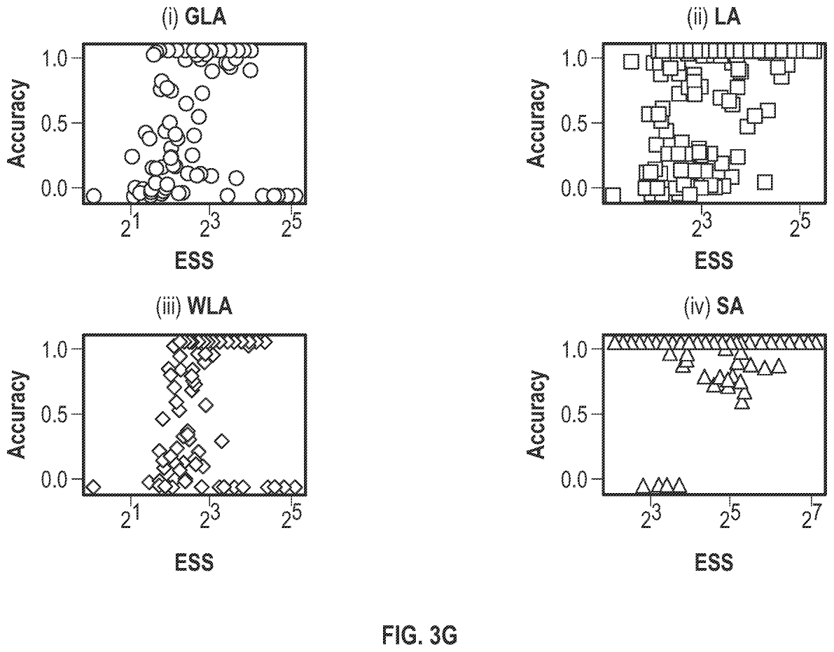

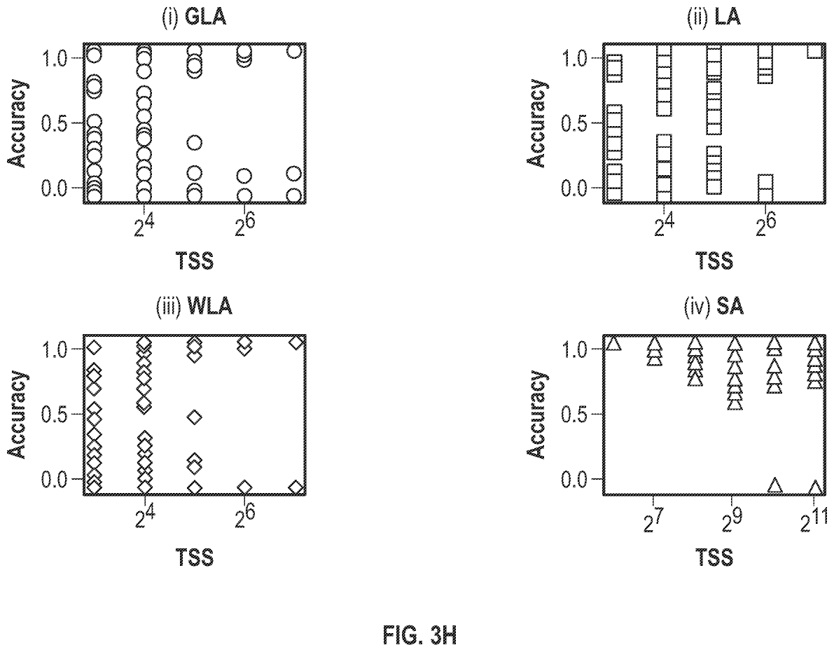

Described herein, ESS analysis may be used to analyze a sequence model's memory utilization, and thus model performance, at various stage of the machine learning process. The following describes certain examples of patterns, trends, and/or strategies that may be revealed with ESS analysis. FIG. 3 illustrates an entropy-ESS metric and TSS metric under various conditions over an entire task-model sweep, in which a task-model sweep is a set of models and tasks that were analyzed with ESS. Specifically, FIG. 3A(i)-FIG. 3A(iv) illustrates accuracy versus TSS/kv for (i) GLA featurizer, (ii) LA featurizer, (iii) WLA featurizer, and (iv) SA featurizer. FIG. 3B(i)-FIG. 3B(iv) illustrates accuracy versus (total TSS)/kv for (i) GLA featurizer, (ii) LA featurizer, (iii) WLA featurizer, and (iv) SA featurizer. FIG. 3C(i)-FIG. 3C(iv) illustrates accuracy versus ESS/kv for (i) GLA featurizer, (ii) LA featurizer, (iii) WLA featurizer, and (iv) SA featurizer. FIG. 3D(i)-FIG. 3D(iv) illustrates accuracy versus (total ESS)/kv for (i) GLA featurizer, (ii) LA featurizer, (iii) WLA featurizer, and (iv) SA featurizer. FIG. 3E(i)-FIG. 3E(iv) illustrates accuracy versus ESS/TSS (e.g., state utilization) for (i) GLA featurizer, (ii) LA featurizer, (iii) WLA featurizer, and (iv) SA featurizer. FIG. 3F(i)-FIG. 3F(iv) illustrates accuracy versus (total ESS)/(total TSS) for (i) GLA featurizer, (ii) LA featurizer, (iii) WLA featurizer, and (iv) SA featurizer. FIG. 3G(i)-FIG. 3G(iv) illustrates accuracy versus ESS for (i) GLA featurizer, (ii) LA featurizer, (iii) WLA featurizer, and (iv) SA featurizer. FIG. 3H(i)-FIG. 3H(iv) illustrates accuracy versus TSS for (i) GLA featurizer, (ii) LA featurizer, (iii) WLA featurizer, and (iv) SA featurizer. FIG. 3A(i)-FIG. 3A(iv) demonstrates that TSS/kv (e.g., memory capacity) may be a worse proxy for model performance than ESS/kv. FIG. 3B(i)-FIG. 3B(iv) demonstrates that (total TSS)/kv may be a worse proxy for model performance than (total ESS)/kv. FIG. 3E(i)-FIG. 3E(iv) demonstrates that models that saturate their state may tend to perform worse on the task due to state saturation described herein. FIG. 3E(i)-FIG. 3E(iv) also demonstrates that models that do not saturate their state but still perform poorly include models that undergo state collapse described herein. FIG. 3G(i)-FIG. 3G(iv) demonstrates that the correlation with accuracy may break down substantially when the metric is not normalized by kv (e.g., the task memory). Unless otherwise stated, an ESS or TSS metric without an average or total qualifier is the average ESS or the average TSS.

In some embodiments, the average TSS for the GLA, LA, and WLA models is computed over the channels, such that model width and number of heads dimensions are consolidated into one dimension. In some embodiments, TSS is computed as a sum of TSS over all d channels, given by the total TSS per layer=d*i because average TSS is a function of the task rather than model hyperparameters for SA. In some embodiments, computations for SA cross-model correlations filter out models which have an accuracy >0.95, so that meaningful variations as a function of (total ESS)/kv and (total TSS)/kv can be observed since many of the SA models obtain an accuracy of 1. In some embodiments, computations for MQAR within-model correlations include dropping epoch 0 because a phase at the start of training is observed such that ESS tends to decrease, but accuracy does not change.

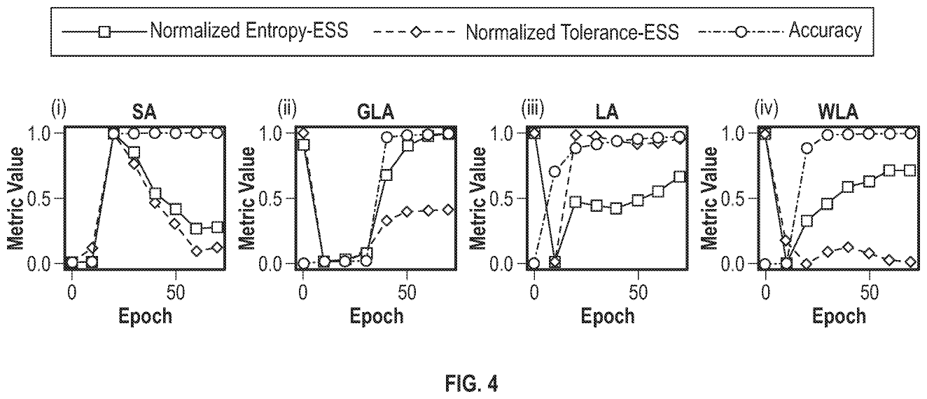

FIG. 4 illustrates the aforementioned trend that, in some embodiments, ESS tends to decrease at the start of training in MQAR. Specifically, FIG. 4(i)-FIG. 4(iv) illustrates the training dynamics of ESS in a (i) SA, (ii) GLA, (iii) LA, and (iv) WLA model (dmodel=256, heads=8) trained on MQAR (seqlen=2048, kv=64), in which the ESS curves over the course of training are min-max normalized to emphasize the shape of the curve as opposed to the magnitude and the tolerance-ESS is computed using a tolerance of 1e-3. In some embodiments, in between epochs 0 and 10 (e.g., at the start of training), ESS is evolving even if the accuracy is not. FIG. 4 demonstrates that there may be a sharp decrease in the ESS before it begins to rise later in training (and along with it the model accuracy) for the recurrent frameworks (GLA, LA, and WLA). FIG. 4 also demonstrates that there may be a sharp decrease at the start of training followed by a steady decrease (even after it has solved the task) for SA models.

In some embodiments, state utilization of a model (e.g., ESS/TSS) is a proxy for what portion of the memory capacity of the network is realized in practice, and by definition, state utilization ranges continuously from 0 to 1. In some embodiments, a state utilization near 1 is indicative of state saturation as described herein.

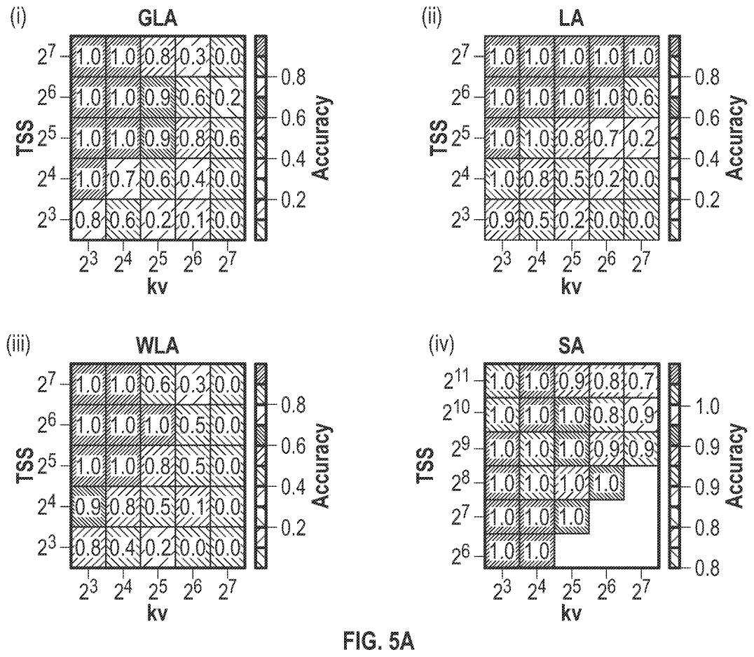

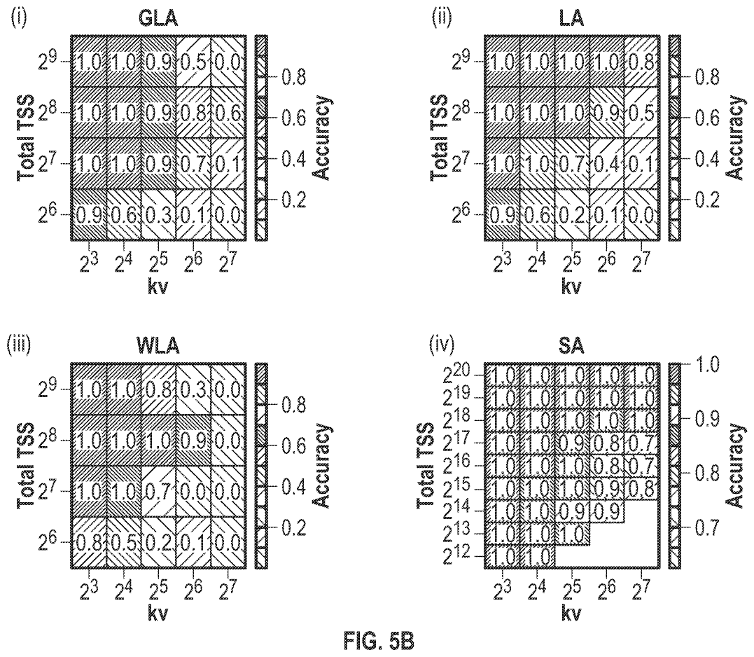

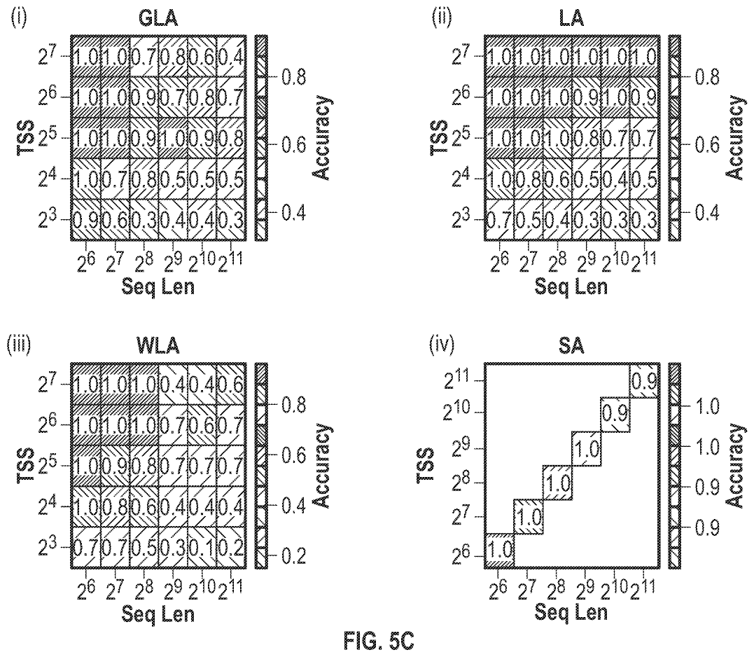

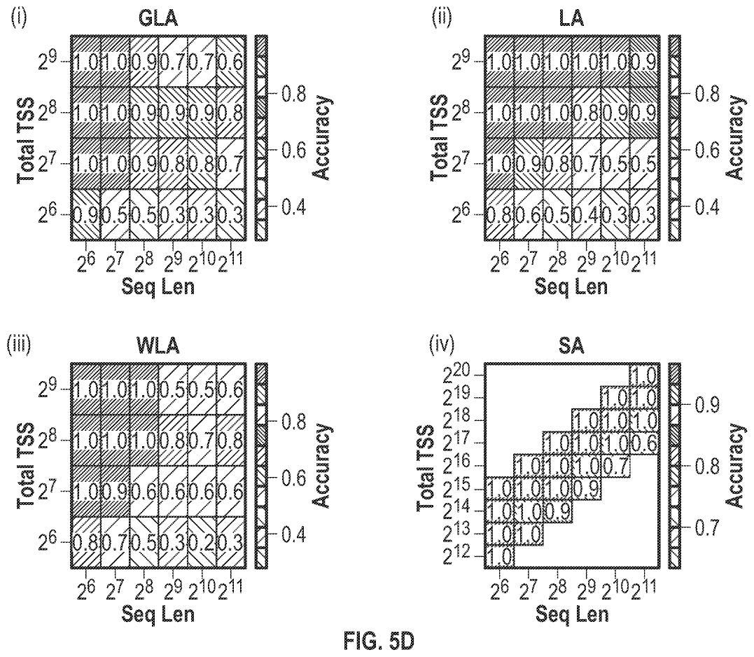

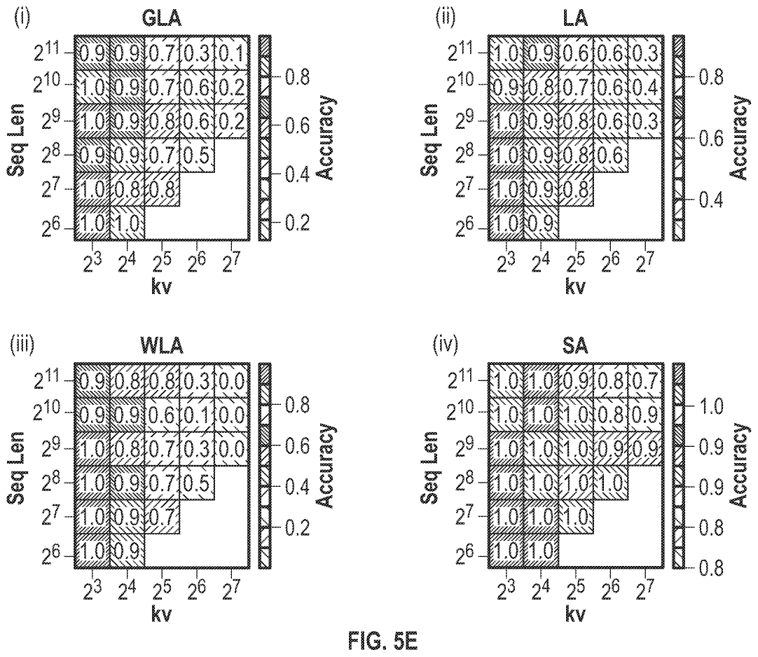

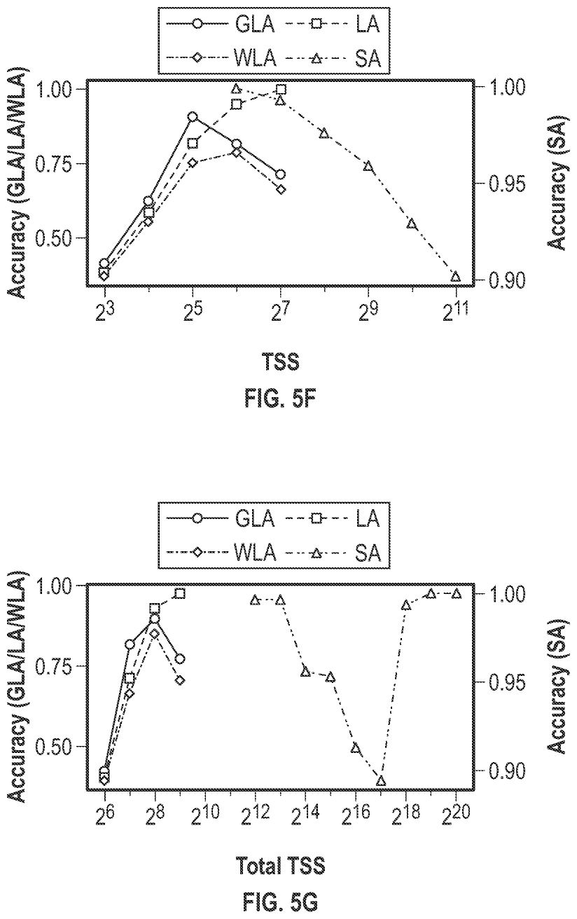

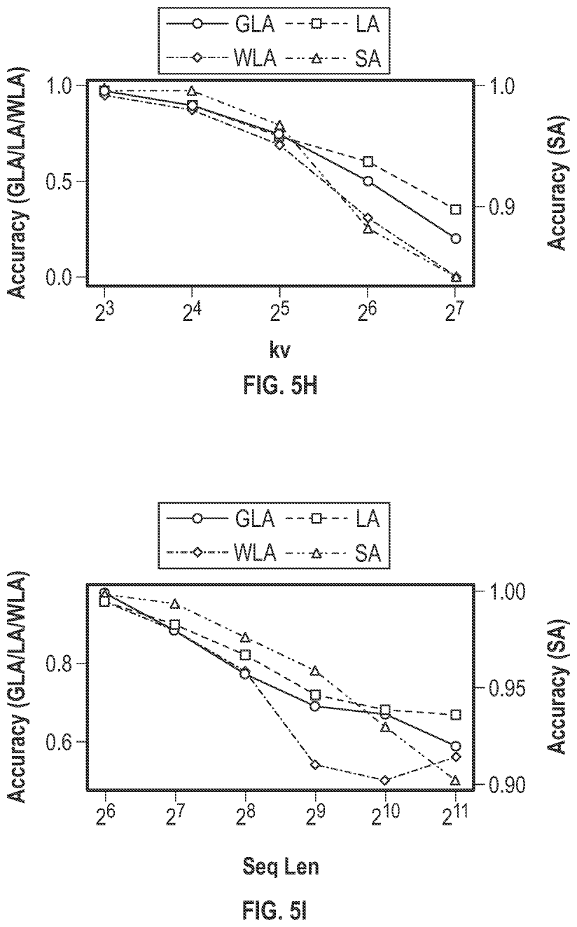

FIGS. 5-10 expand upon FIG. 3 by plotting the entropy-ESS or TSS metric marginalized across different dimensions. In some embodiments, marginalizing across dimensions means to average across all models in that bucket of task-model space. Marginalizing across dimensions may not mean averaging across tasks or featurizers. According to some embodiments, FIG. 5 illustrates the MQAR accuracies marginalized across different dimensions. For instance, FIG. 5A(i)-FIG. 5A(iv) illustrates MQAR accuracy marginalized across TSS versus kv for (i) GLA featurizer, (ii) LA featurizer, (iii) WLA featurizer, and (iv) SA featurizer. According to some embodiments, FIG. 5B(i)-FIG. 5B(iv) illustrates MQAR accuracy marginalized across total TSS versus kv for (i) GLA featurizer, (ii) LA featurizer, (iii) WLA featurizer, and (iv) SA featurizer. According to some embodiments, FIG. 5C(i)-FIG. 5C(iv) illustrates MQAR accuracy marginalized across TSS versus sequence length for (i) GLA featurizer, (ii) LA featurizer, (iii) WLA featurizer, and (iv) SA featurizer. According to some embodiments, FIG. 5D(i)-FIG. 5D(iv) illustrates MQAR accuracy marginalized across total TSS versus sequence length for (i) GLA featurizer, (ii) LA featurizer, (iii) WLA featurizer, and (iv) SA featurizer. According to some embodiments, FIG. 5E(i)-FIG. 5E(iv) illustrates MQAR accuracy marginalized across sequence length versus kv for (i) GLA featurizer, (ii) LA featurizer, (iii) WLA featurizer, and (iv) SA featurizer. According to some embodiments, FIG. 5F illustrates MQAR accuracy versus TSS. According to some embodiments, FIG. 5G illustrates MQAR accuracy versus total TSS. According to some embodiments, FIG. 5H illustrates MQAR accuracy versus kv. According to some embodiments, FIG. 5I illustrates MQAR accuracy versus sequence length.

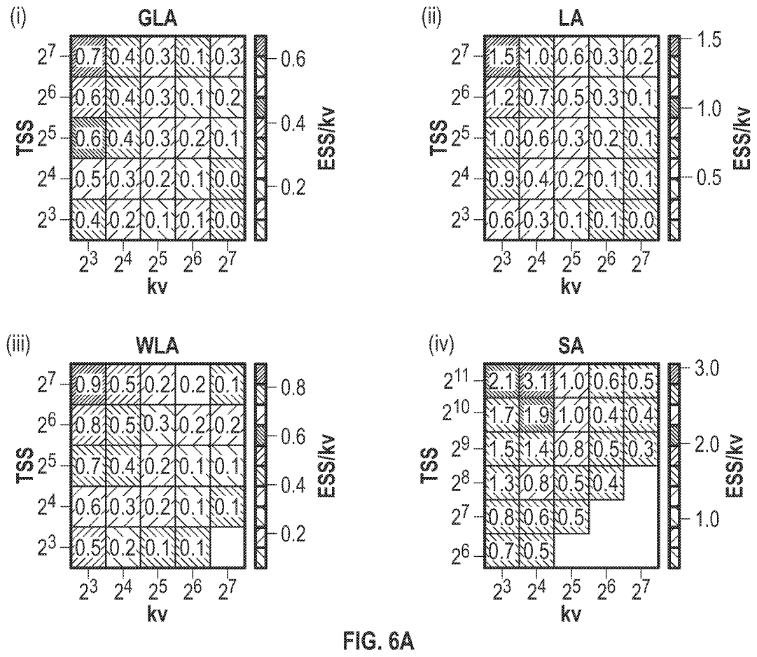

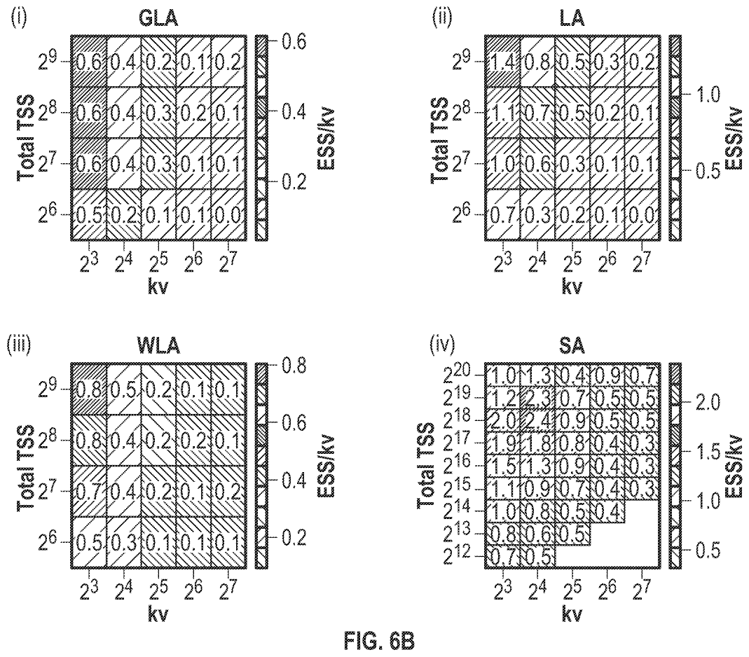

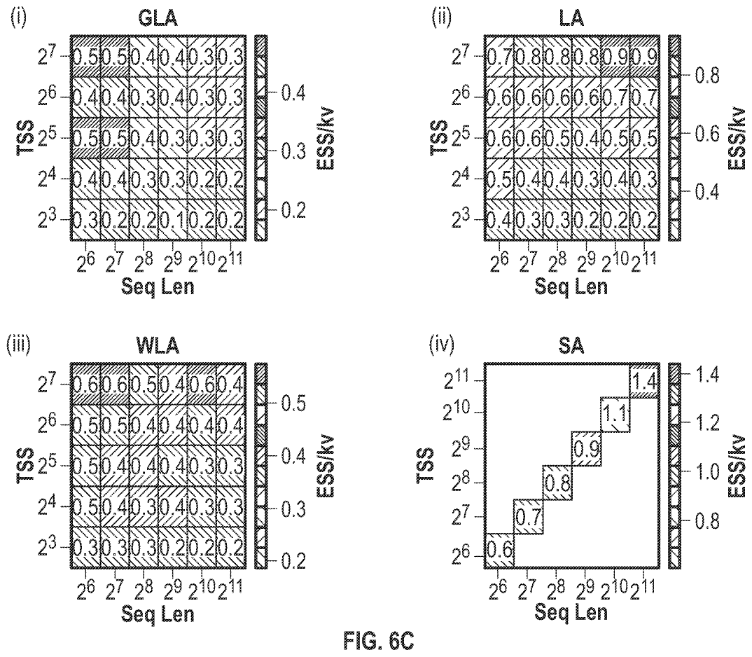

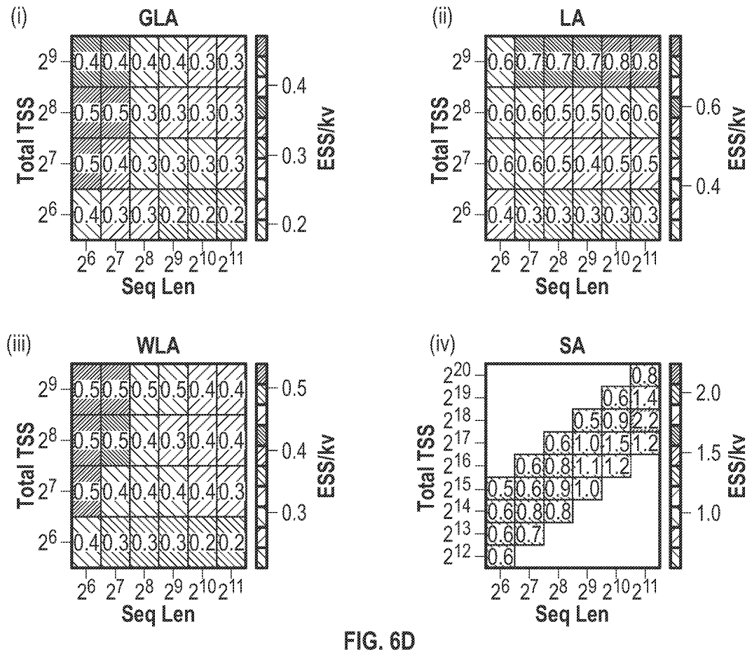

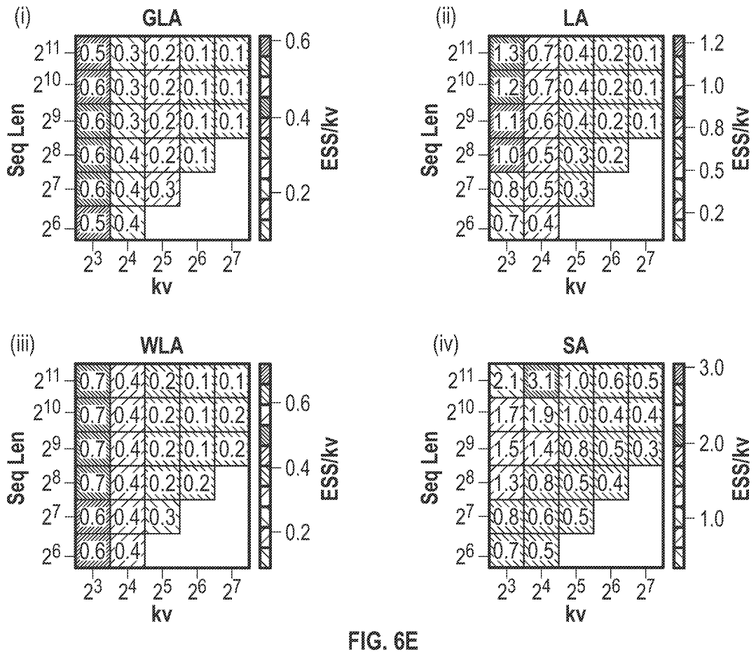

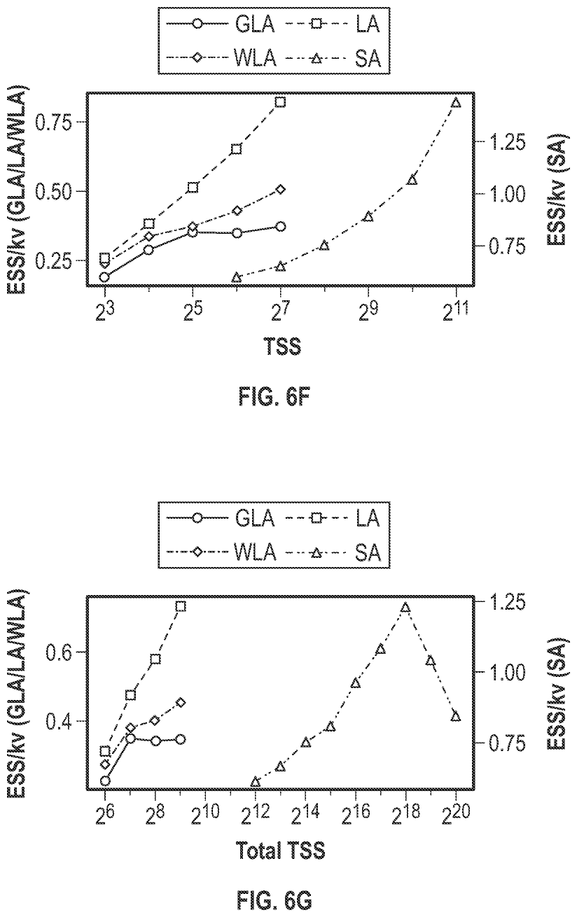

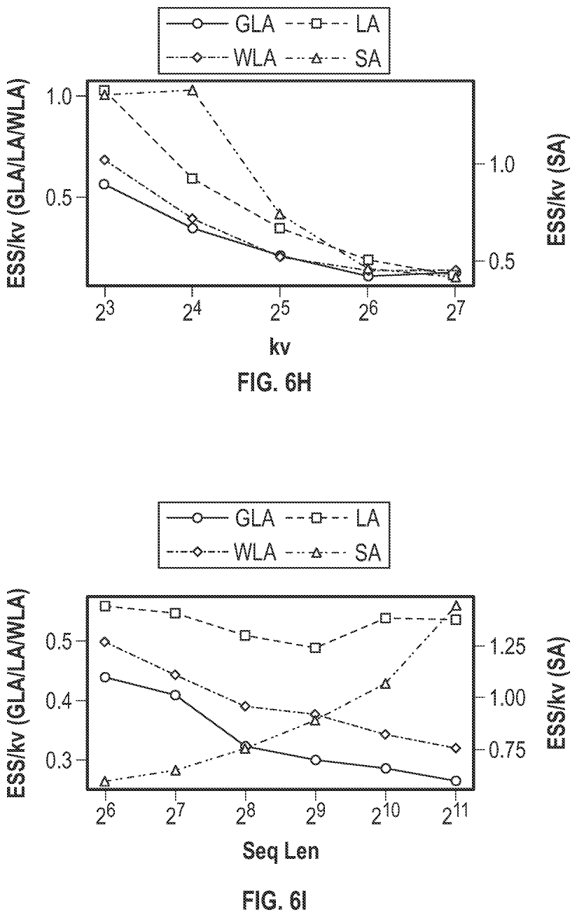

FIG. 6 illustrates the MQAR ESS/kv marginalized across different dimensions, according to some embodiments. For instance, FIG. 6A(i)-FIG. 6A(iv) illustrates MQAR entropy-ESS/kv marginalized across TSS versus kv for (i) GLA featurizer, (ii) LA featurizer, (iii) WLA featurizer, and (iv) SA featurizer. According to some embodiments, FIG. 6B(i)-FIG. 6B(iv) illustrates MQAR entropy-ESS/kv marginalized across total TSS versus kv for (i) GLA featurizer, (ii) LA featurizer, (iii) WLA featurizer, and (iv) SA featurizer. According to some embodiments, FIG. 6C(i)-FIG. 6C(iv) illustrates MQAR entropy-ESS/kv marginalized across TSS versus sequence length for (i) GLA featurizer, (ii) LA featurizer, (iii) WLA featurizer, and (iv) SA featurizer. According to some embodiments, FIG. 6D(i)-FIG. 6D(iv) illustrates MQAR entropy-ESS/kv marginalized across total TSS versus sequence length for (i) GLA featurizer, (ii) LA featurizer, (iii) WLA featurizer, and (iv) SA featurizer. According to some embodiments, FIG. 6E(i)-FIG. 6E(iv) illustrates MQAR entropy-ESS/kv marginalized across sequence length versus kv for (i) GLA featurizer, (ii) LA featurizer, (iii) WLA featurizer, and (iv) SA featurizer. FIG. According to some embodiments, 6F illustrates MQAR entropy-ESS/kv versus TSS. According to some embodiments, FIG. 6G illustrates MQAR entropy-ESS/kv versus total TSS. FIG. According to some embodiments, 6H illustrates MQAR entropy-ESS/kv versus kv. According to some embodiments, FIG. 6I illustrates MQAR entropy-ESS/kv versus sequence length.

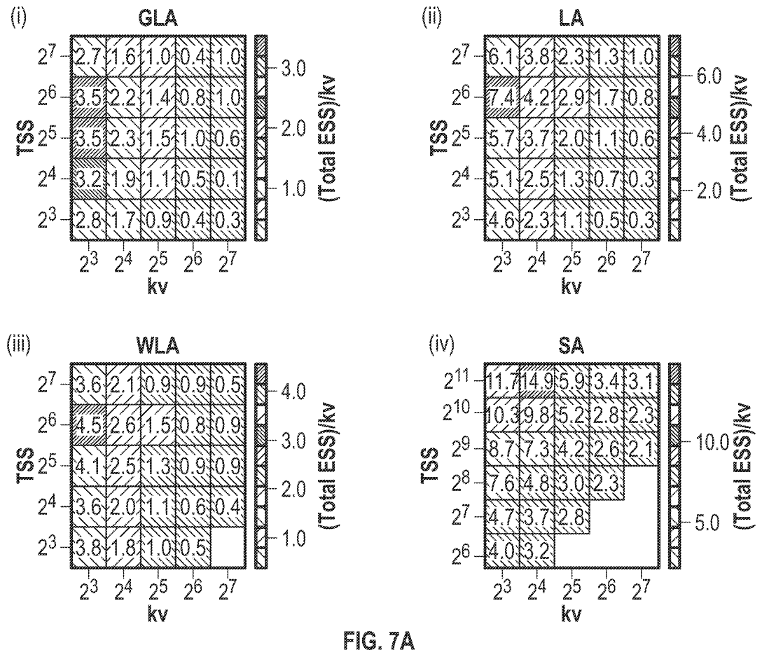

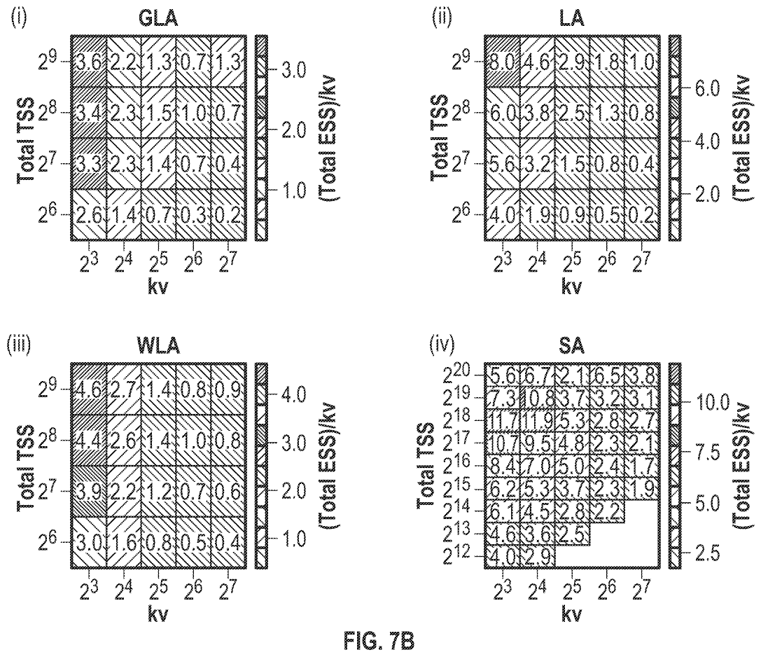

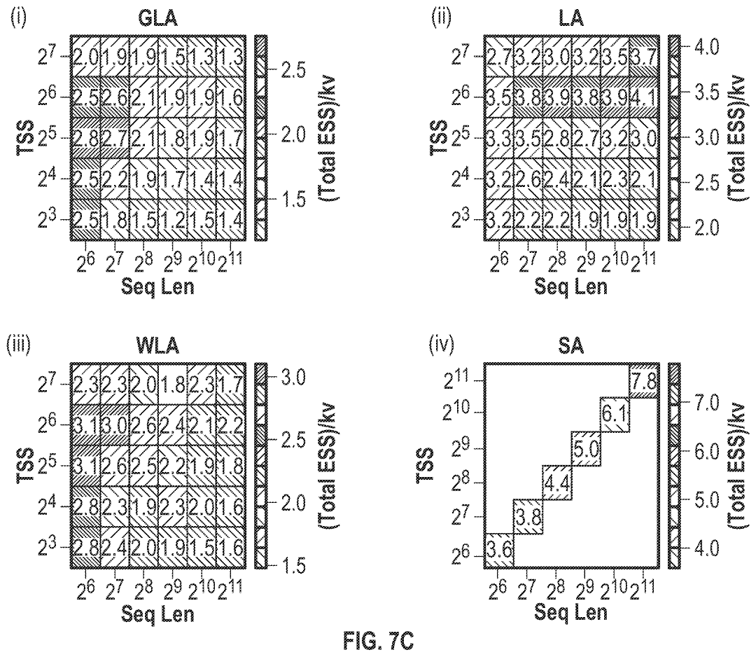

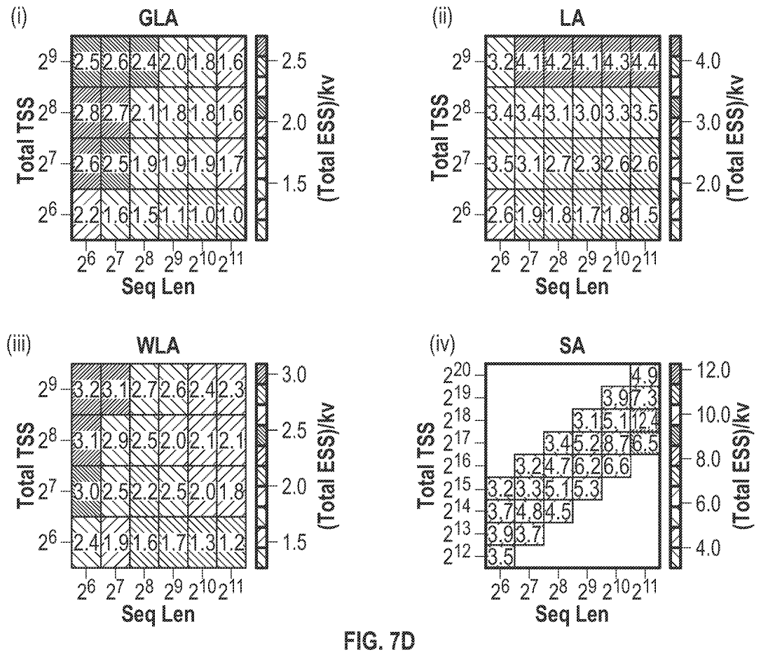

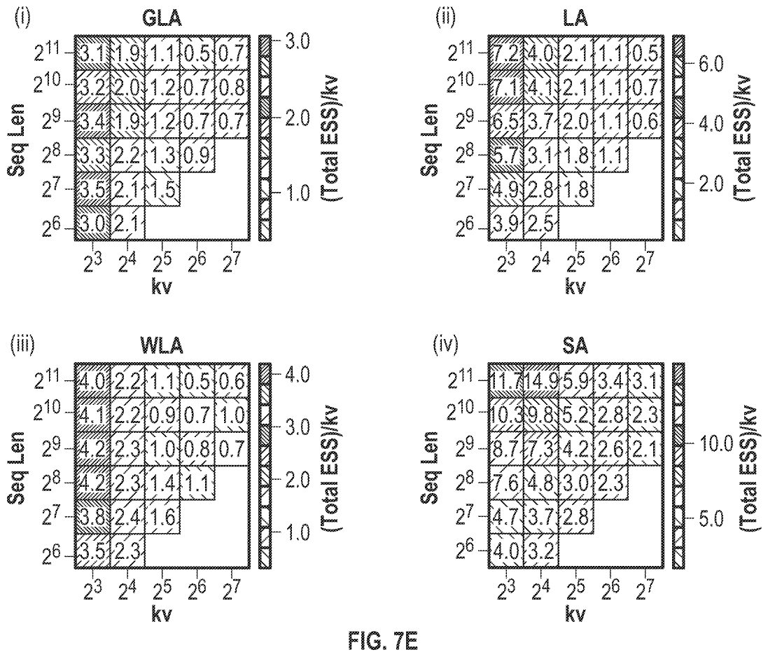

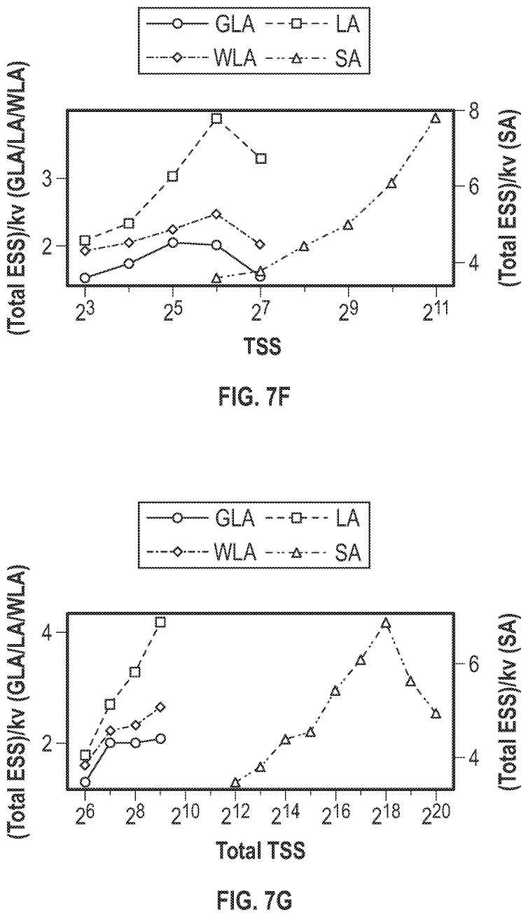

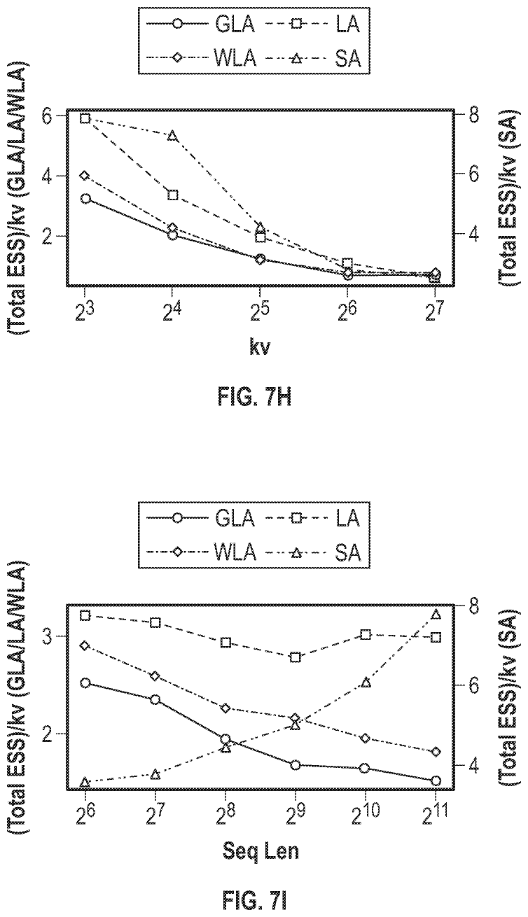

FIG. 7 illustrates MQAR (total ESS)/kv marginalized across different dimensions, according to some embodiments. For instance, FIG. 7A(i)-FIG. 7A(iv) illustrates MQAR (total entropy-ESS)/kv marginalized across TSS versus kv for (i) GLA featurizer, (ii) LA featurizer, (iii) WLA featurizer, and (iv) SA featurizer. According to some embodiments, FIG. 7B(i)-FIG. 7B(iv) illustrates MQAR (total entropy-ESS)/kv marginalized across total TSS versus kv for (i) GLA featurizer, (ii) LA featurizer, (iii) WLA featurizer, and (iv) SA featurizer. According to some embodiments, FIG. 7C(i)-FIG. 7C(iv) illustrates MQAR (total entropy-ESS)/kv marginalized across TSS versus sequence length for (i) GLA featurizer, (ii) LA featurizer, (iii) WLA featurizer, and (iv) SA featurizer. According to some embodiments, FIG. 7D(i)-FIG. 7D(iv) illustrates MQAR (total entropy-ESS)/kv marginalized across total TSS versus sequence length for (i) GLA featurizer, (ii) LA featurizer, (iii) WLA featurizer, and (iv) SA featurizer. According to some embodiments, FIG. 7E(i)-FIG. 7E(iv) illustrates MQAR (total entropy-ESS)/kv marginalized across sequence length versus kv for (i) GLA featurizer, (ii) LA featurizer, (iii) WLA featurizer, and (iv) SA featurizer. According to some embodiments, FIG. 7F illustrates MQAR (total entropy-ESS)/kv versus TSS. According to some embodiments, FIG. 7G illustrates MQAR (total entropy-ESS)/kv versus total TSS. According to some embodiments, FIG. 7H illustrates MQAR (total entropy-ESS)/kv versus kv. According to some embodiments, FIG. 7I illustrates MQAR (total entropy-ESS)/kv versus sequence length.

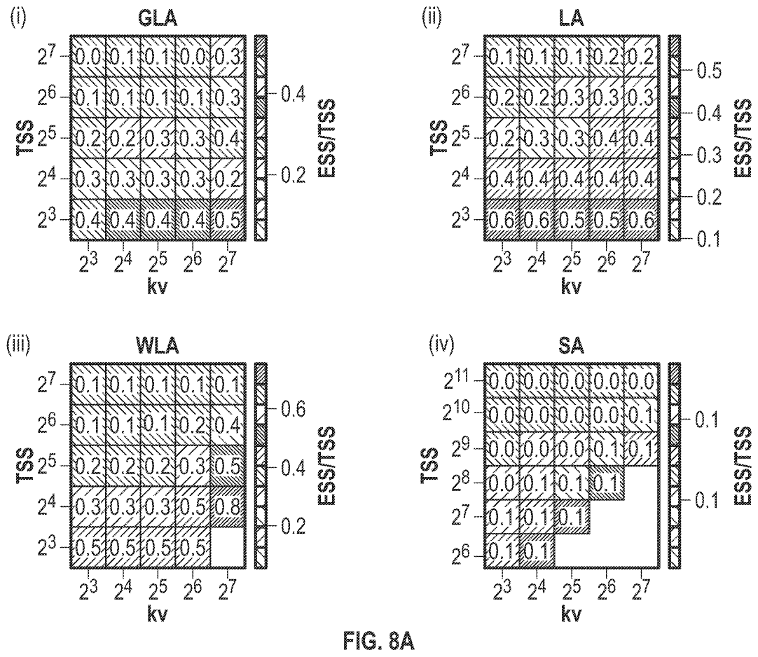

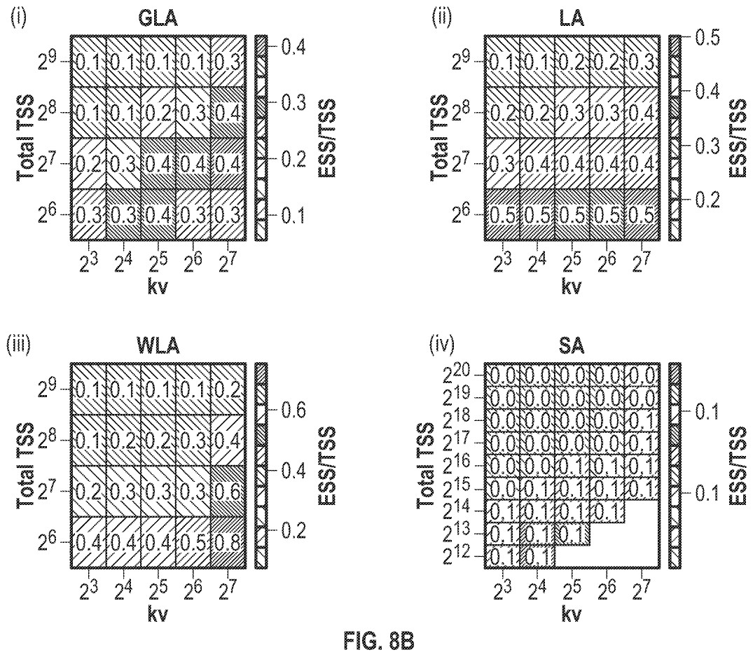

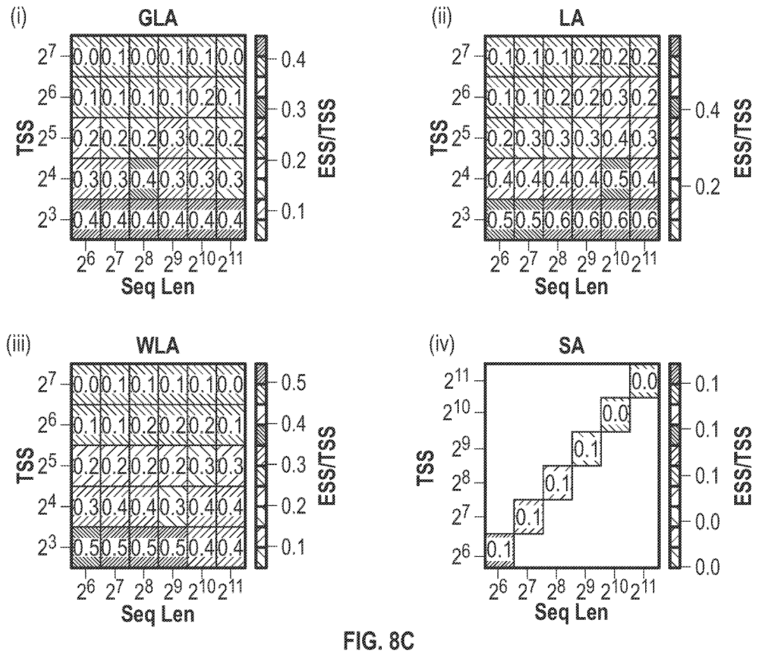

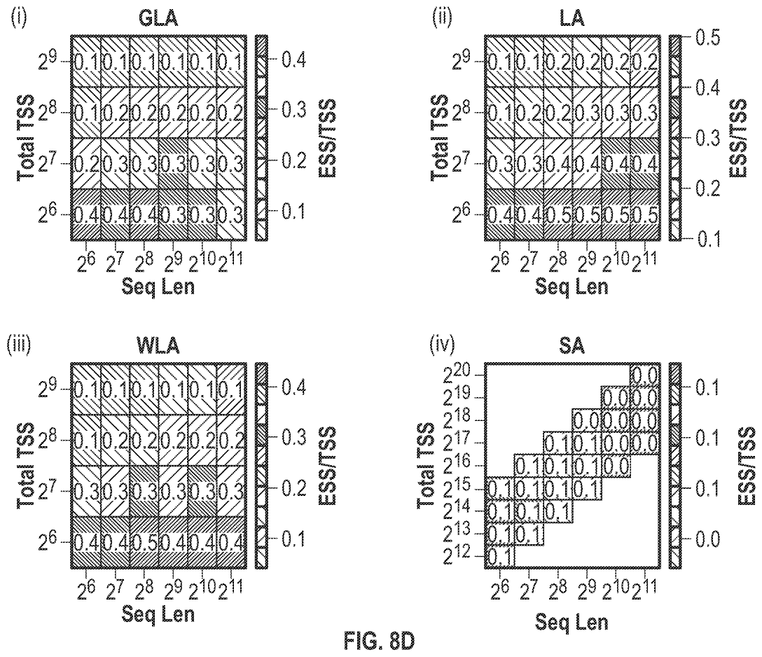

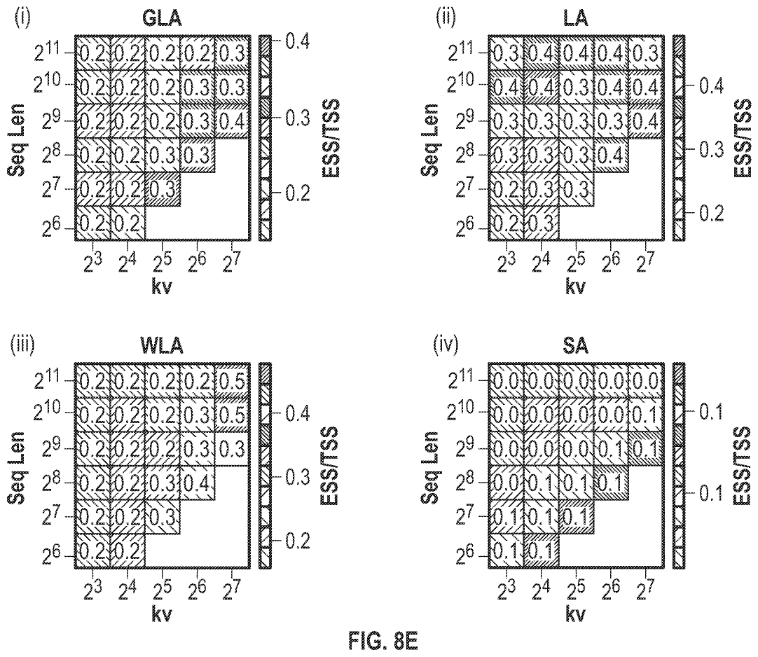

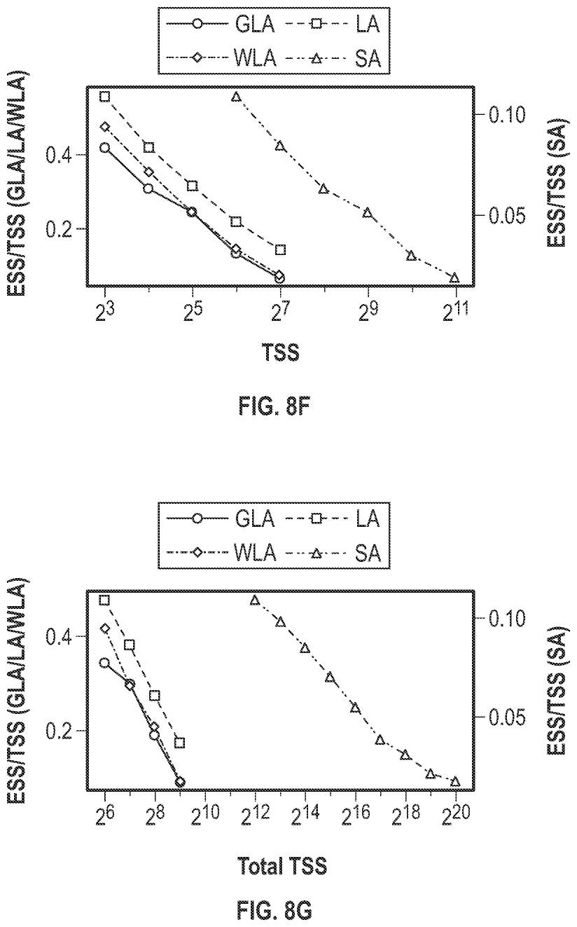

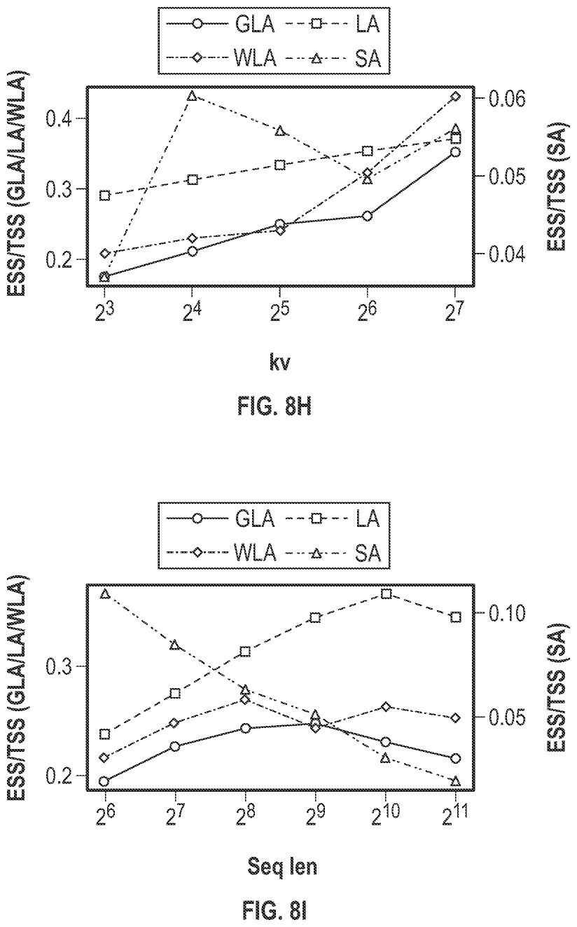

FIG. 8 illustrates MQAR ESS/TSS marginalized across different dimensions, according to some embodiments. For instance, FIG. 8A(i)-FIG. 8A(iv) illustrates MQAR entropy-ESS/TSS marginalized across TSS versus kv for (i) GLA featurizer, (ii) LA featurizer, (iii) WLA featurizer, and (iv) SA featurizer. FIG. 8B(i)-FIG. 8B(iv) illustrates MQAR entropy-ESS/TSS marginalized across total TSS versus kv for (i) GLA featurizer, (ii) LA featurizer, (iii) WLA featurizer, and (iv) SA featurizer, according to some embodiments. FIG. 8C(i)-FIG. 8C(iv) illustrates MQAR entropy-ESS/TSS marginalized across TSS versus sequence length for (i) GLA featurizer, (ii) LA featurizer, (iii) WLA featurizer, and (iv) SA featurizer, according to some embodiments. FIG. 8D(i)-FIG. 8D(iv) illustrates MQAR entropy-ESS/TSS marginalized across total TSS versus sequence length for (i) GLA featurizer, (ii) LA featurizer, (iii) WLA featurizer, and (iv) SA featurizer, according to some embodiments. FIG. 8E(i)-FIG. 8E(iv) illustrates MQAR entropy-ESS/TSS marginalized across sequence length versus kv for (i) GLA featurizer, (ii) LA featurizer, (iii) WLA featurizer, and (iv) SA featurizer, according to some embodiments. FIG. 8F illustrates MQAR entropy-ESS/TSS versus TSS, according to some embodiments. FIG. 8G illustrates MQAR entropy-ESS/TSS versus total TSS, according to some embodiments. FIG. 8H illustrates MQAR entropy-ESS/TSS versus kv, according to some embodiments. FIG. 8I illustrates MQAR entropy-ESS/TSS versus sequence length, according to some embodiments.

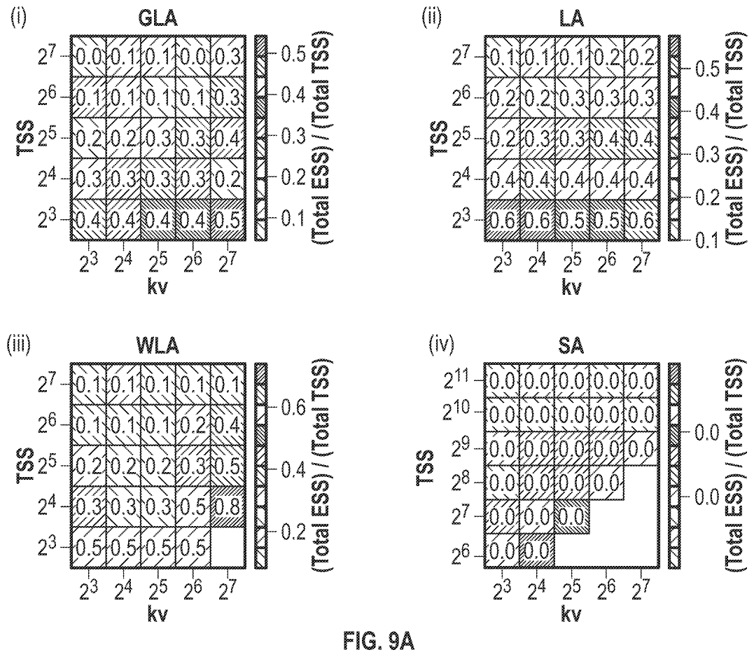

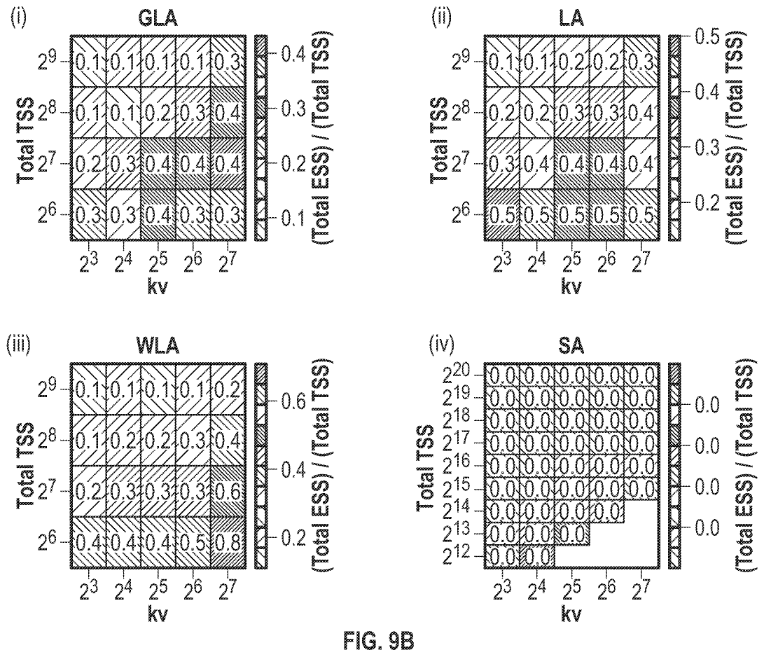

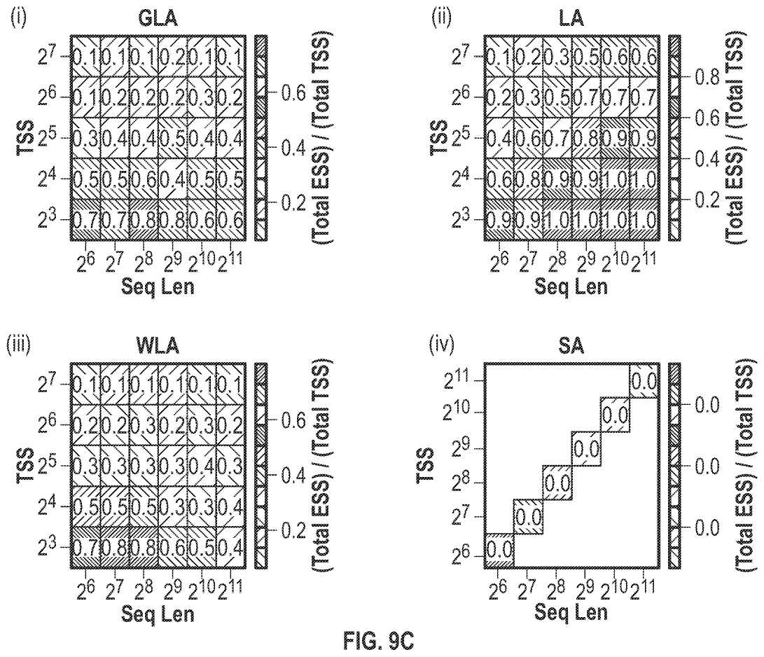

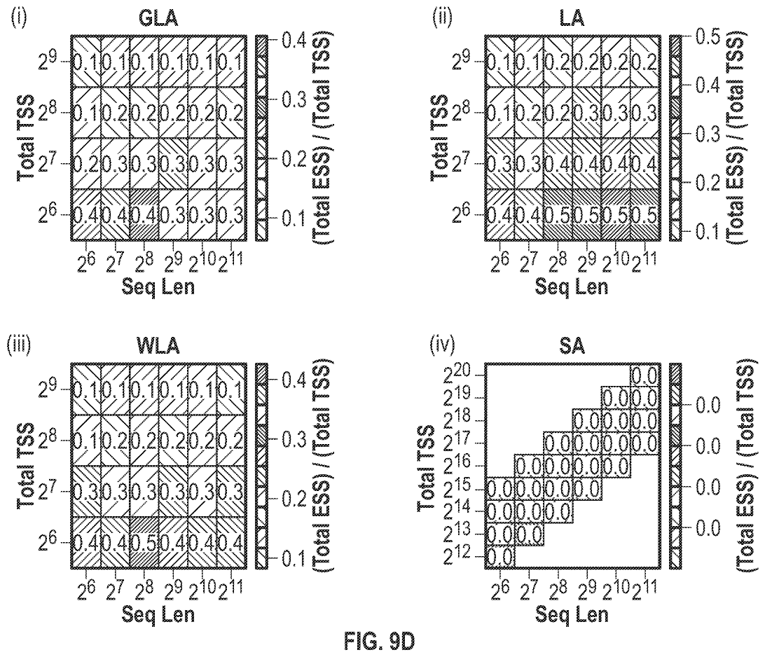

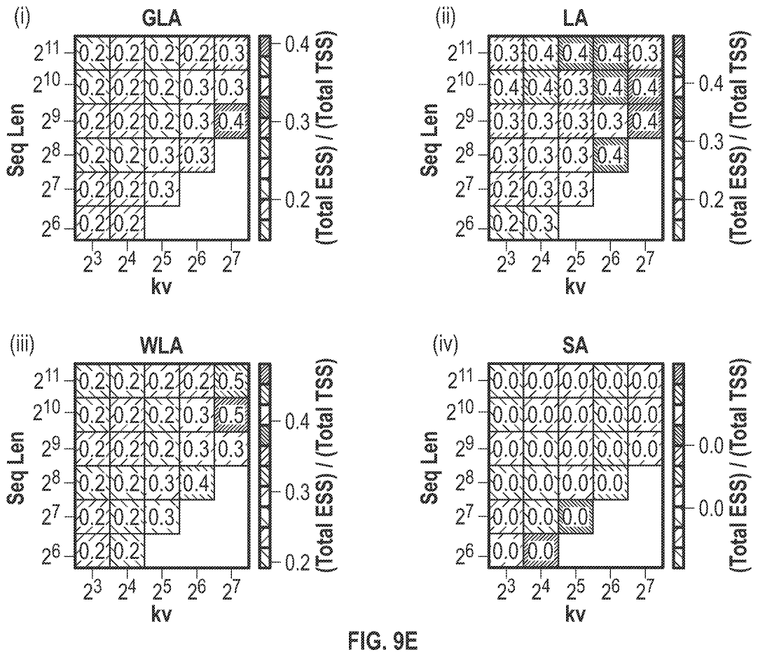

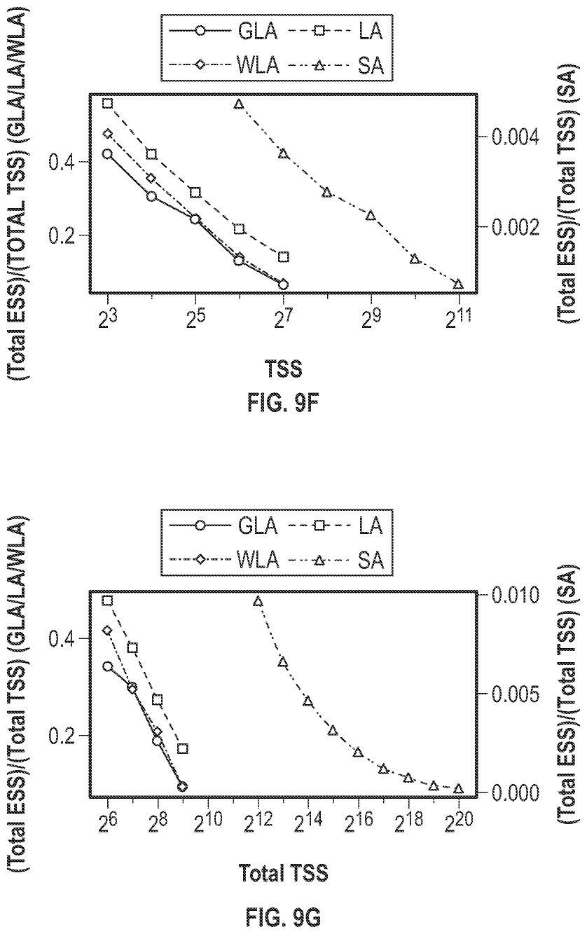

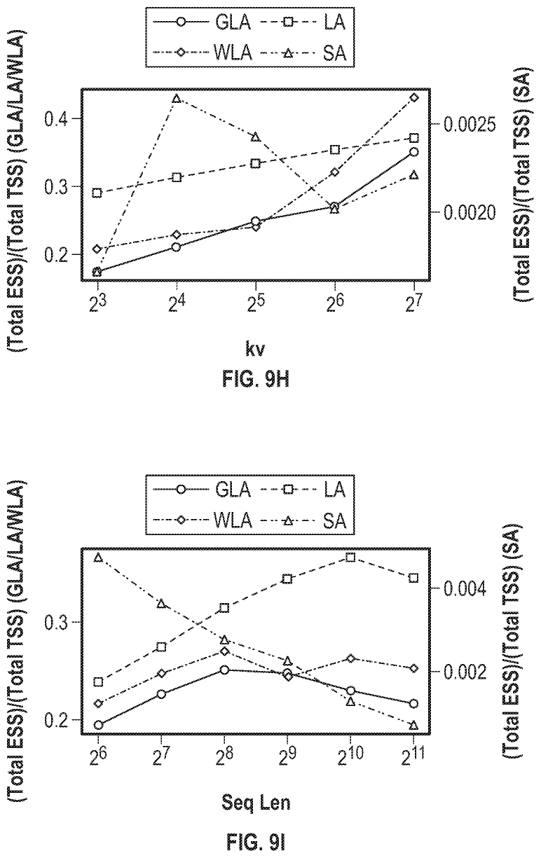

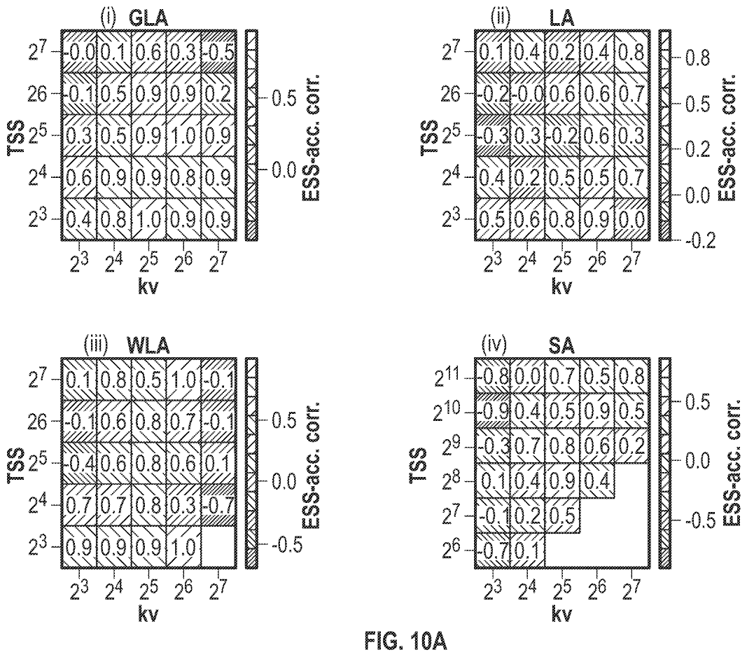

FIG. 9 illustrates MQAR (total ESS)/(total TSS) marginalized across different dimensions, according to some embodiments. For instance, FIG. 9A(i)-FIG. 9A(iv) illustrates MQAR (total entropy-ESS)/(total TSS) marginalized across TSS versus kv for (i) GLA featurizer, (ii) LA featurizer, (iii) WLA featurizer, and (iv) SA featurizer, according to some embodiments. FIG. 9B(i)-FIG. 9B(iv) illustrates MQAR (total entropy-ESS)/(total TSS) marginalized across total TSS versus kv for (i) GLA featurizer, (ii) LA featurizer, (iii) WLA featurizer, and (iv) SA featurizer, according to some embodiments. FIG. 9C(i)-FIG. 9C(iv) illustrates MQAR (total entropy-ESS)/(total TSS) marginalized across TSS versus sequence length for (i) GLA featurizer, (ii) LA featurizer, (iii) WLA featurizer, and (iv) SA featurizer, according to some embodiments. FIG. 9D(i)-FIG. 9D(iv) illustrates MQAR (total entropy-ESS)/(total TSS) marginalized across total TSS versus sequence length for (i) GLA featurizer, (ii) LA featurizer, (iii) WLA featurizer, and (iv) SA featurizer, according to some embodiments. FIG. 9E(i)-FIG. 9E(iv) illustrates MQAR (total entropy-ESS)/(total TSS) marginalized across sequence length versus kv for (i) GLA featurizer, (ii) LA featurizer, (iii) WLA featurizer, and (iv) SA featurizer, according to some embodiments. FIG. 9F illustrates MQAR (total entropy-ESS)/(total TSS) versus TSS, according to some embodiments. FIG. 9G illustrates MQAR (total entropy-ESS)/(total TSS) versus total TSS, according to some embodiments. FIG. 9H illustrates MQAR (total entropy-ESS)/(total TSS) versus kv, according to some embodiments. FIG. 9I illustrates MQAR (total entropy-ESS)/(total TSS) versus sequence length, according to some embodiments.

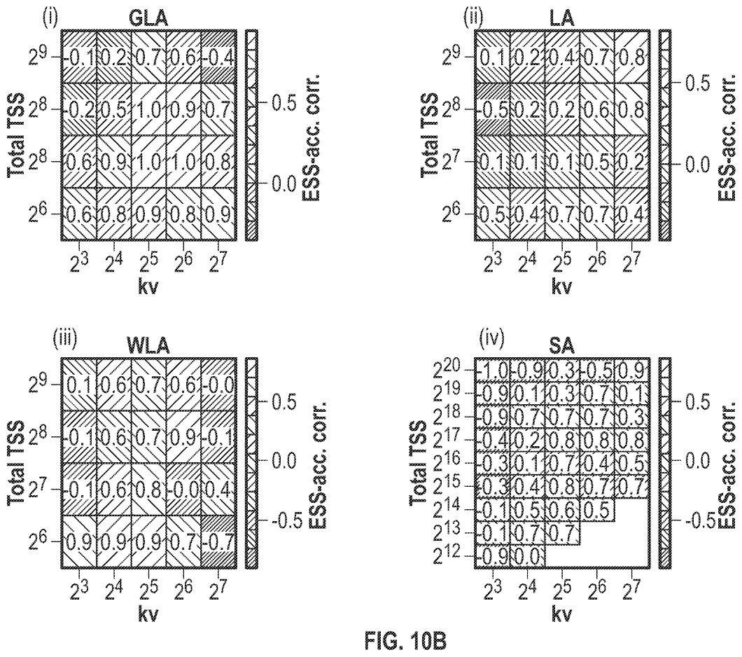

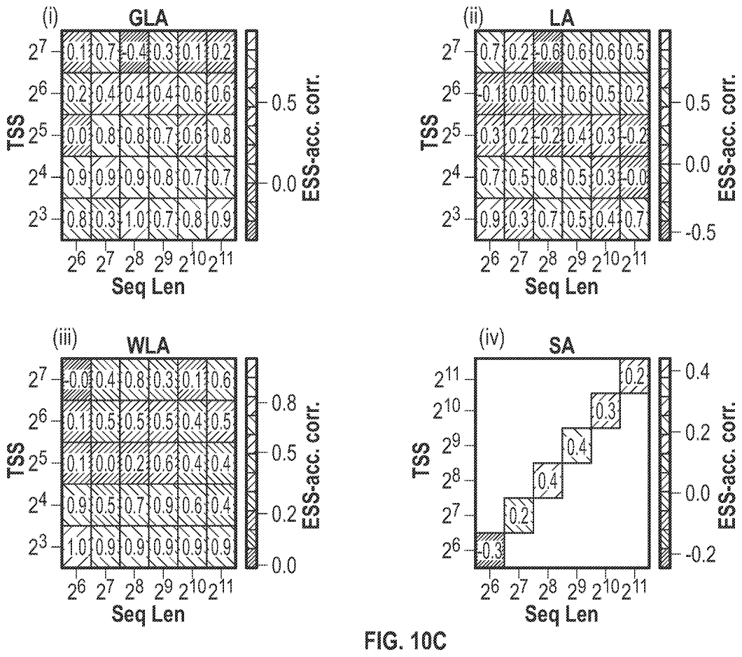

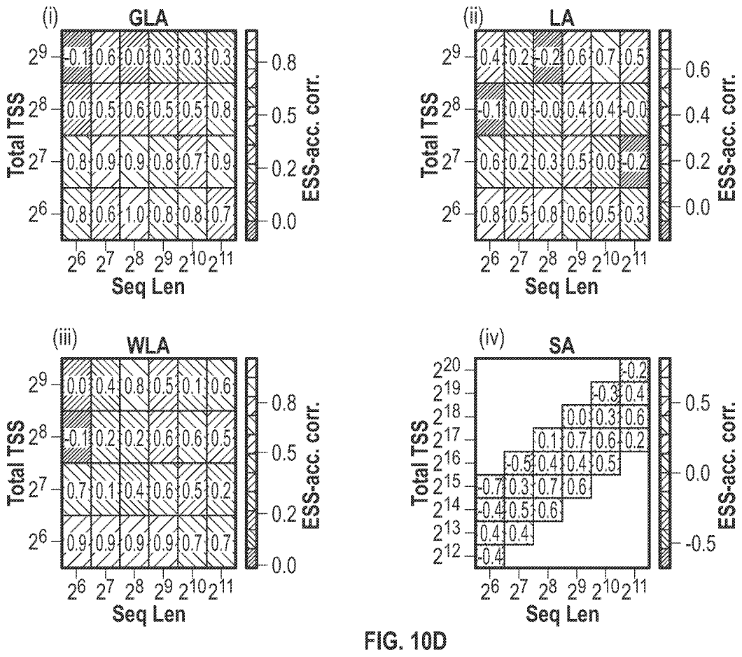

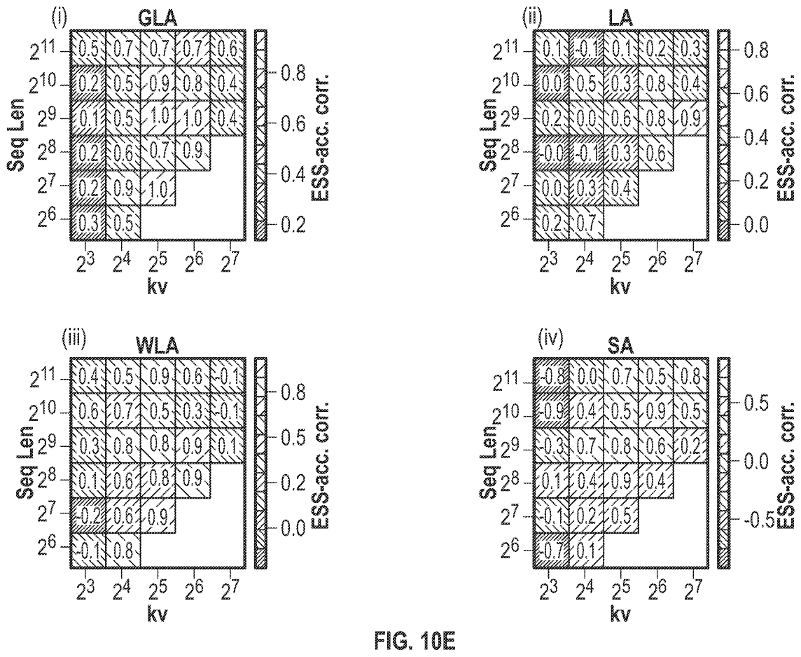

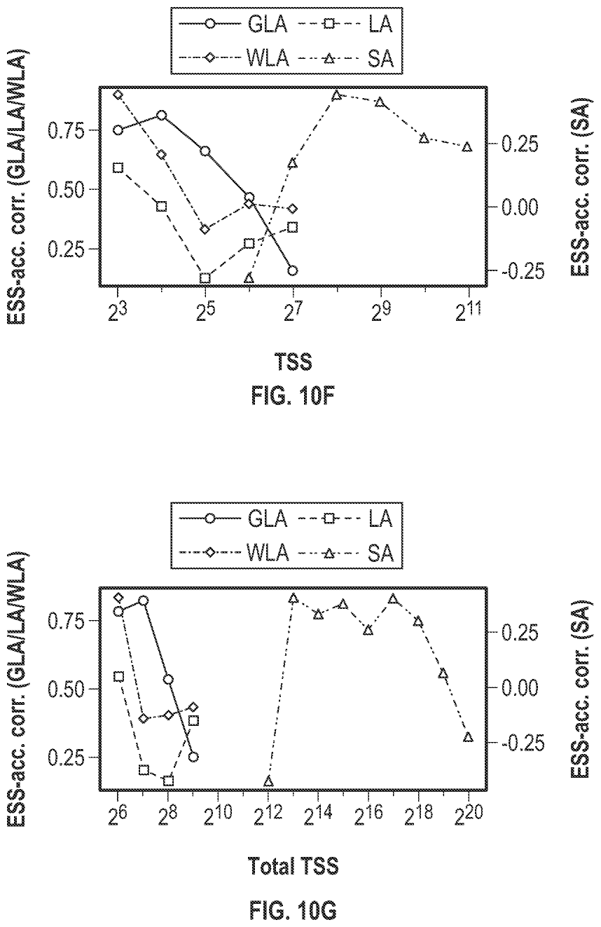

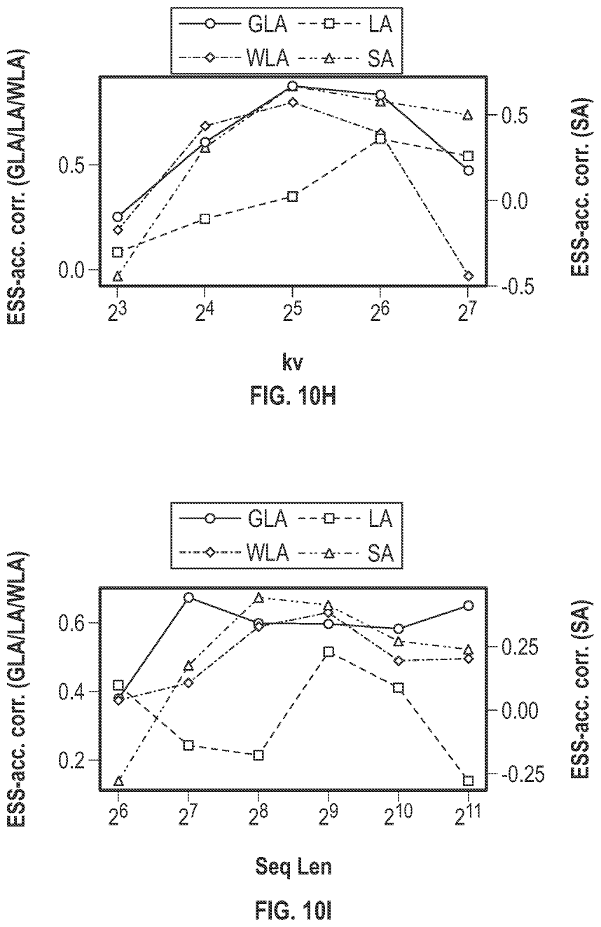

FIG. 10 illustrates MQAR ESS-accuracy correlations computed over training marginalized across different dimensions, according to some embodiments. For instance, FIG. 10A(i)-FIG. 10A(iv) illustrates MQAR entropy-ESS-accuracy correlations computed over training marginalized across TSS versus kv for (i) GLA featurizer, (ii) LA featurizer, (iii) WLA featurizer, and (iv) SA featurizer, according to some embodiments. FIG. 10B(i)-FIG. 10B(iv) illustrates MQAR entropy-ESS-accuracy correlations computed over training marginalized across total TSS versus kv for (i) GLA featurizer, (ii) LA featurizer, (iii) WLA featurizer, and (iv) SA featurizer, according to some embodiments. FIG. 10C(i)-FIG. 10C(iv) illustrates MQAR entropy-ESS-accuracy correlations computed over training marginalized across TSS versus sequence length for (i) GLA featurizer, (ii) LA featurizer, (iii) WLA featurizer, and (iv) SA featurizer, according to some embodiments. FIG. 10D(i)-FIG. 10D(iv) illustrates MQAR entropy-ESS-accuracy correlations computed over training marginalized across total TSS versus sequence length for (i) GLA featurizer, (ii) LA featurizer, (iii) WLA featurizer, and (iv) SA featurizer, according to some embodiments. FIG. 10E(i)-FIG. 10E(iv) illustrates MQAR entropy-ESS-accuracy correlations computed over training marginalized across sequence length versus kv for (i) GLA featurizer, (ii) LA featurizer, (iii) WLA featurizer, and (iv) SA featurizer, according to some embodiments. FIG. 10F illustrates MQAR entropy-ESS-accuracy correlations computed over training versus TSS, according to some embodiments. FIG. 10G illustrates MQAR entropy-ESS-accuracy correlations computed over training versus total TSS, according to some embodiments. FIG. 10H illustrates MQAR entropy-ESS-accuracy correlations computed over training versus kv, according to some embodiments. FIG. 10I illustrates MQAR entropy-ESS-accuracy correlations computed over training versus sequence length, according to some embodiments.

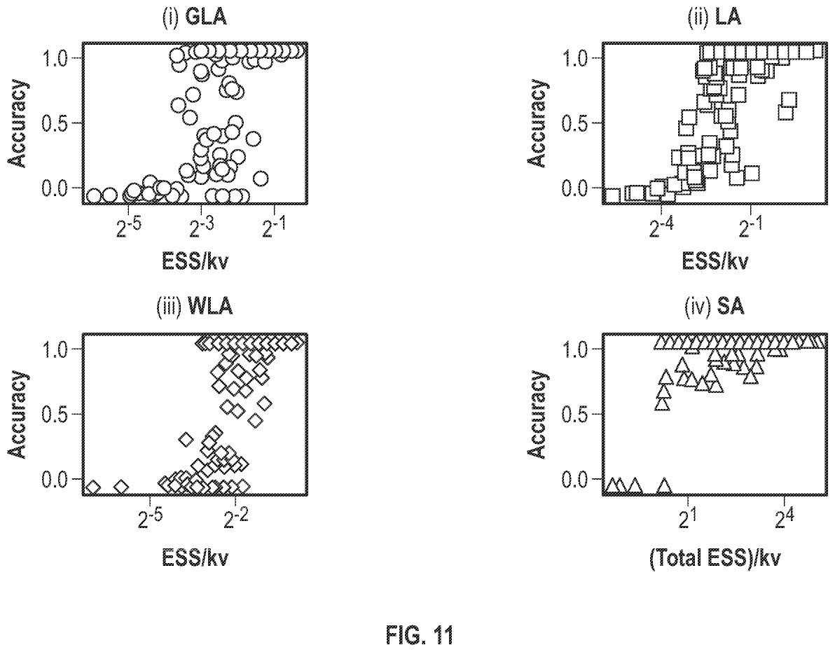

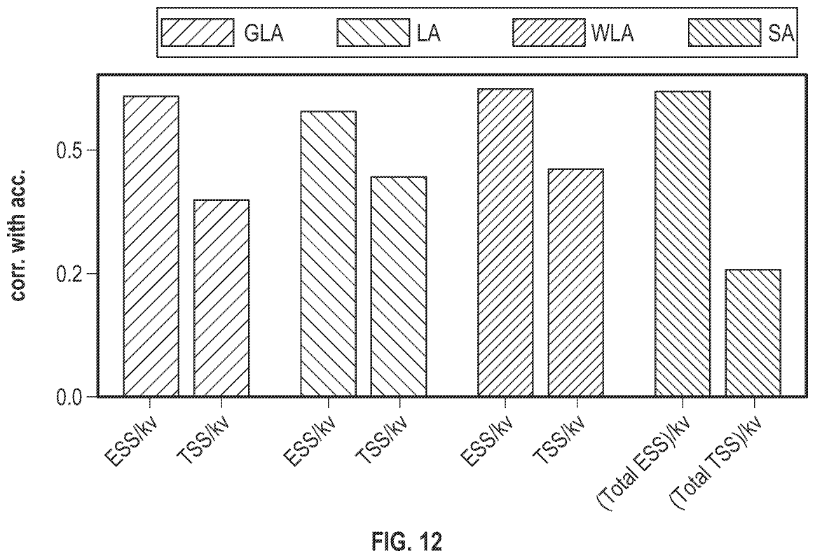

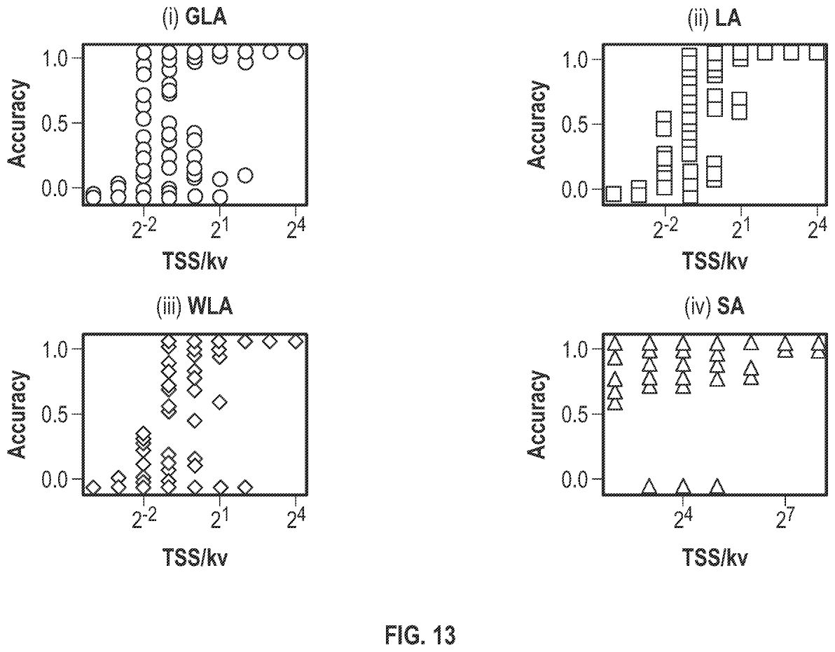

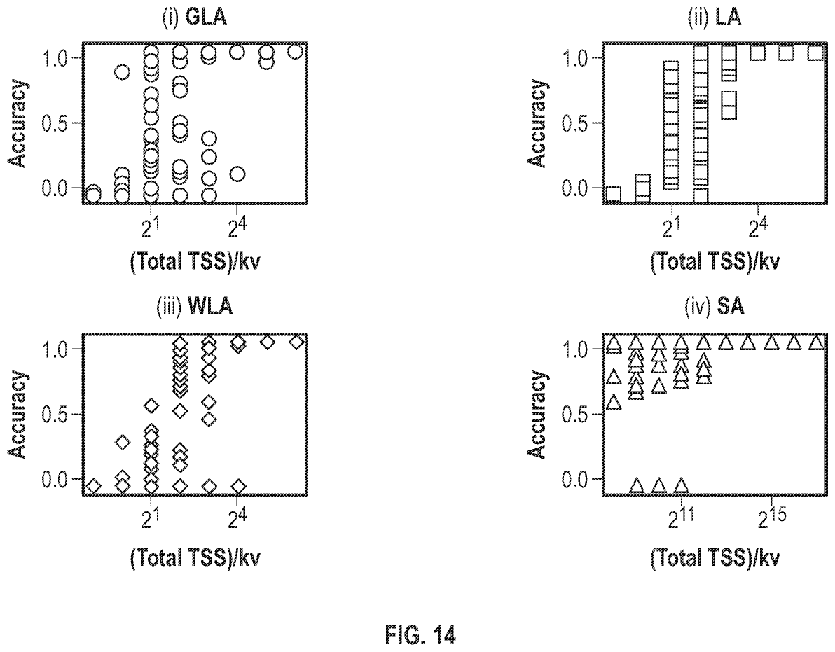

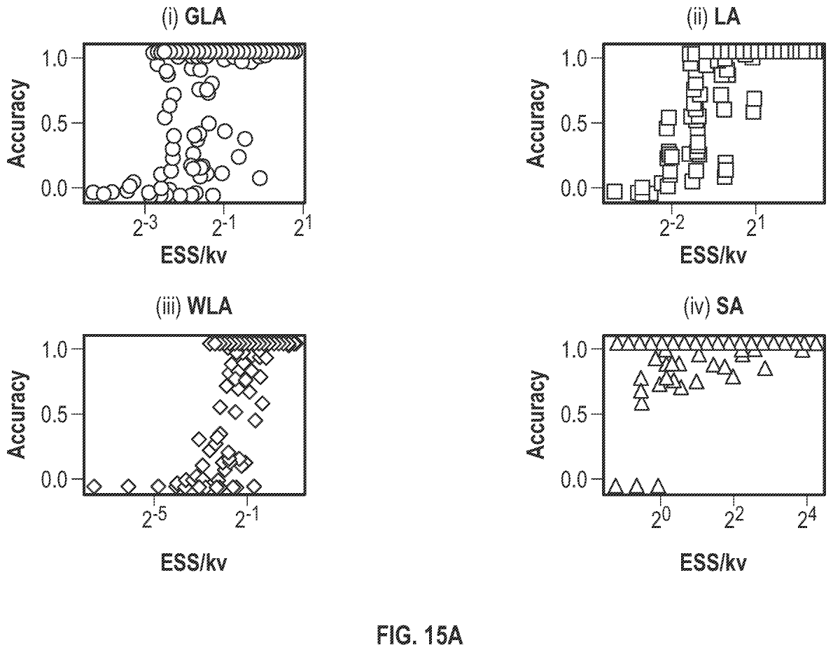

In some embodiments, measured over the entire task-model space, ESS/kv exhibits a significantly higher correlation with accuracy than TSS/kv, for example in FIG. 11-FIG. 14; ESS/kv may be an adjusted form of ESS that refers to ESS normalized by the memory demands of MQAR. The ESS analysis illustrated by FIG. 11-FIG. 14 is an average across 8 samples (e.g., batch size). FIG. 11(i)-FIG. 11(iv) illustrates scatter plots of accuracy versus ESS/kv for (i) GLA featurizer, (ii) LA featurizer, (iii) WLA featurizer, and (iv) SA featurizer, according to some embodiments, such that the task-model configurations illustrated in Table 1 are included in each scatter plot. FIG. 12 illustrates ESS/kv versus TSS/kv as a proxy for model performance as measured by correlation. FIG. 13(i)-FIG. 13(iv) illustrates accuracy versus TSS/kv for (i) GLA featurizer, (ii) LA featurizer, (iii) WLA featurizer, and (iv) SA featurizer. FIG. 13 demonstrates that TSS/kv (e.g., memory capacity) may be a worse proxy for model performance than ESS/kv. FIG. 14(i)-FIG. 14(iv) illustrates accuracy versus (total TSS)/kv for (i) GLA featurizer, (ii) LA featurizer, (iii) WLA featurizer, and (iv) SA featurizer. FIG. 14 demonstrates that (total TSS)/kv may be a worse proxy for model performance than (total ESS)/kv. In some embodiments, the strong correlation between ESS/kv and accuracy, shown herein by FIG. 11-FIG. 14, highlights the efficacy of ESS as a proxy for memory utilization. The strong correlation between ESS/kv and accuracy underscores a significant gap in the explanatory power between ESS and TSS, and shows the importance of ESS analysis in some applications and embodiments.

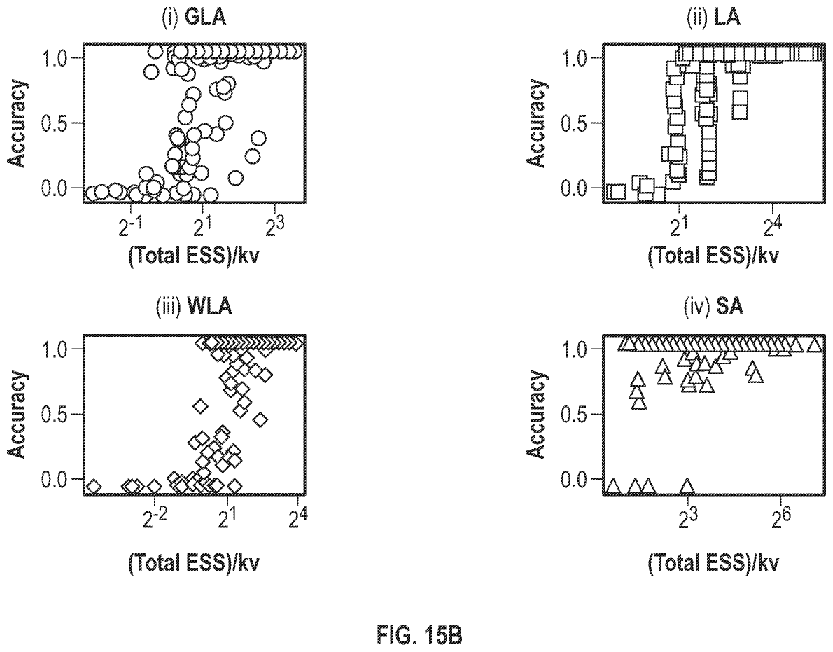

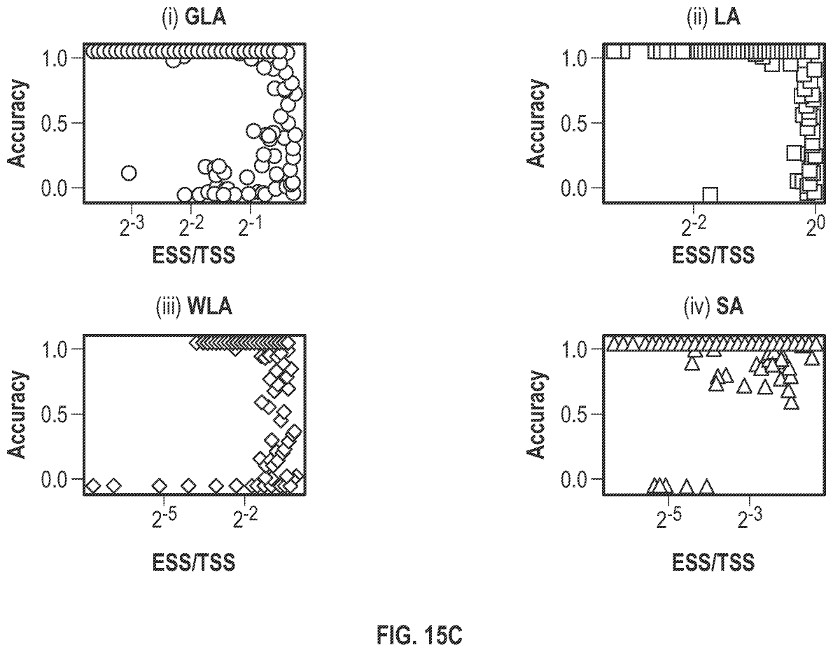

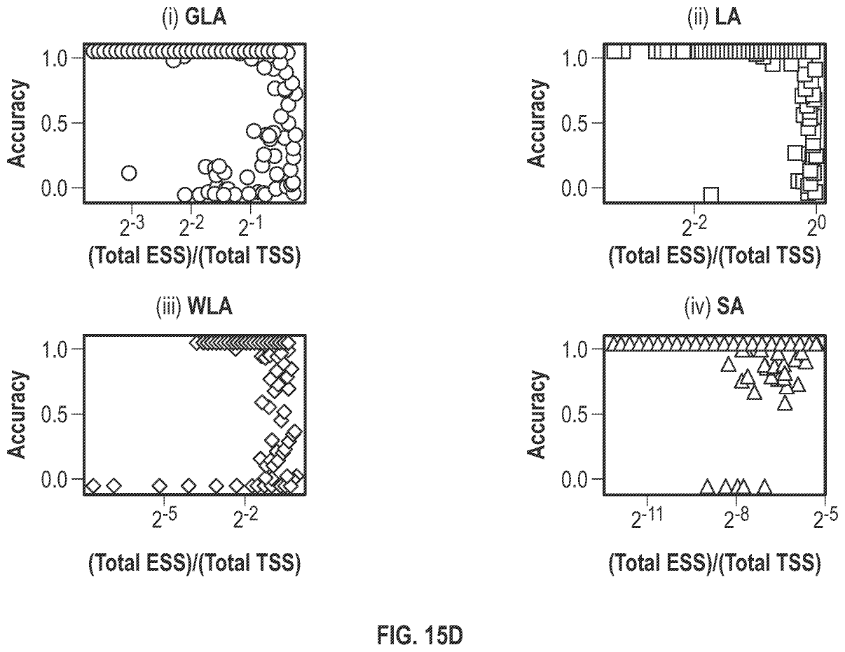

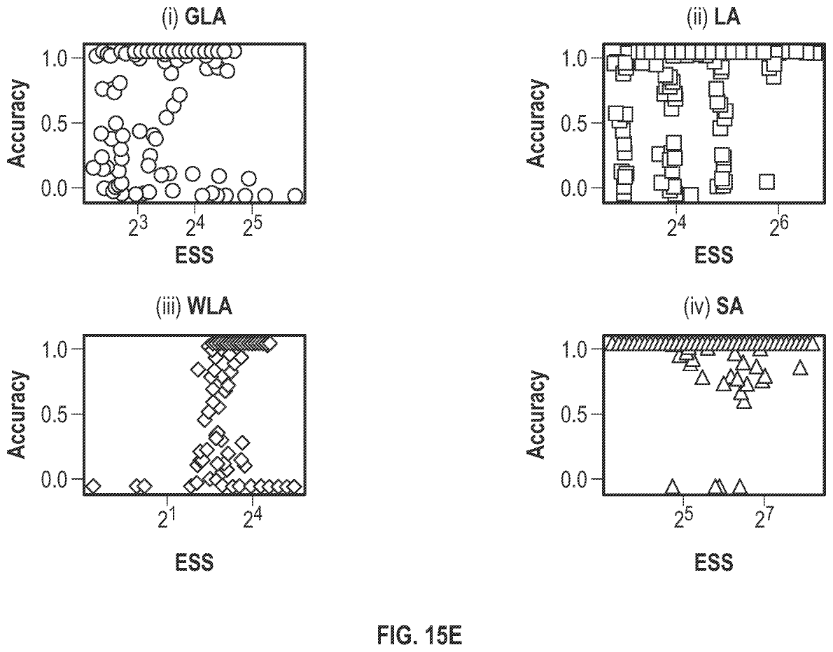

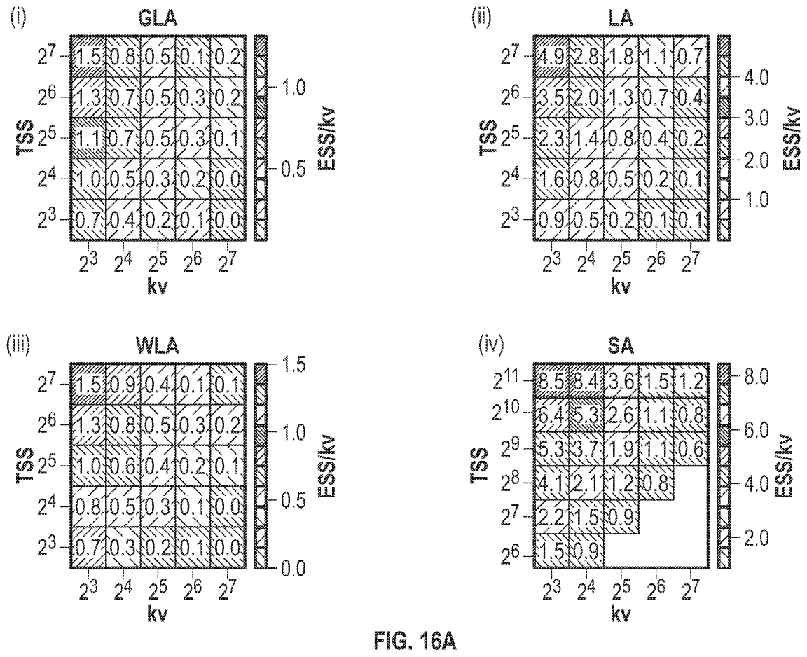

In some embodiments, tolerance-ESS, using a tolerance of 1e-3, is measured over the entire MQAR task-model space. The trends described here in reference to entropy-ESS measurements may largely remain the same for tolerance-ESS measurements. FIG. 15 illustrates accuracy versus various forms of tolerance ESS across task-model space, according to some embodiments. Specifically, FIG. 15A(i)-FIG. 15A(iv) illustrates ESS/kv versus accuracy for (i) GLA featurizer, (ii) LA featurizer, (iii) WLA featurizer, and (iv) SA featurizer. FIG. 15B(i)-FIG. 15B(iv) illustrates (total ESS)/kv versus accuracy for (i) GLA featurizer, (ii) LA featurizer, (iii) WLA featurizer, and (iv) SA featurizer. FIG. 15C(i)-FIG. 15C(iv) illustrates ESS/TSS versus accuracy for (i) GLA featurizer, (ii) LA featurizer, (iii) WLA featurizer, and (iv) SA featurizer. FIG. 15D(i)-FIG. 15D(iv) illustrates (total ESS)/(total TSS) versus accuracy for (i) GLA featurizer, (ii) LA featurizer, (iii) WLA featurizer, and (iv) SA featurizer. FIG. 15E(i)-FIG. 15E(iv) illustrates ESS versus accuracy for (i) GLA featurizer, (ii) LA featurizer, (iii) WLA featurizer, and (iv) SA featurizer. The plots in FIG. 15 are analogous to those in FIG. 3. In some embodiments, similar trends as FIG. 15 are observed for tolerance ESS measured with a tolerance of 1e-1 and 1e-5.

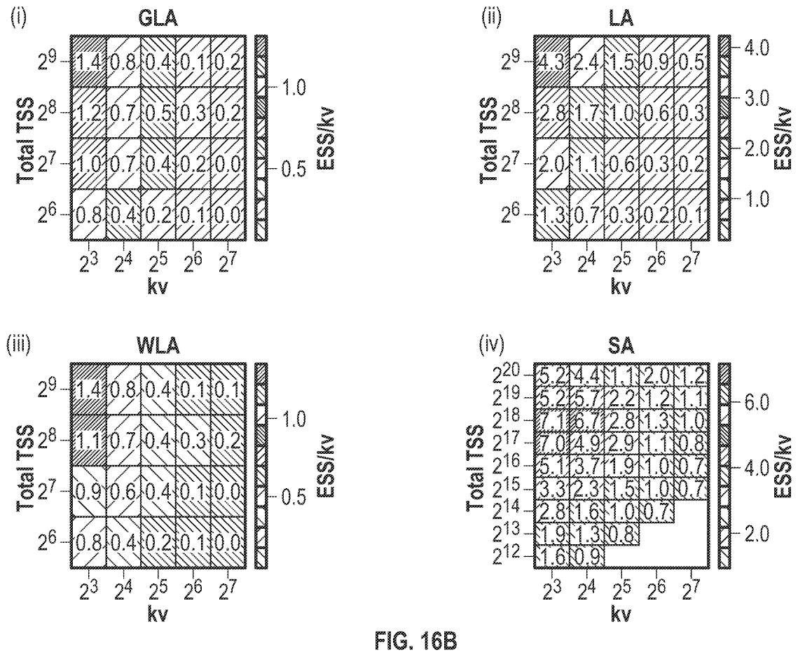

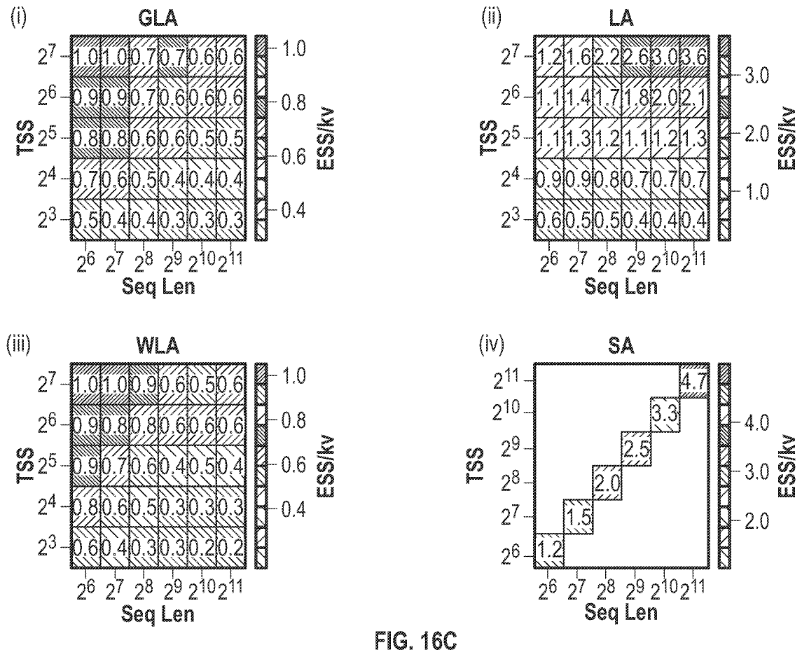

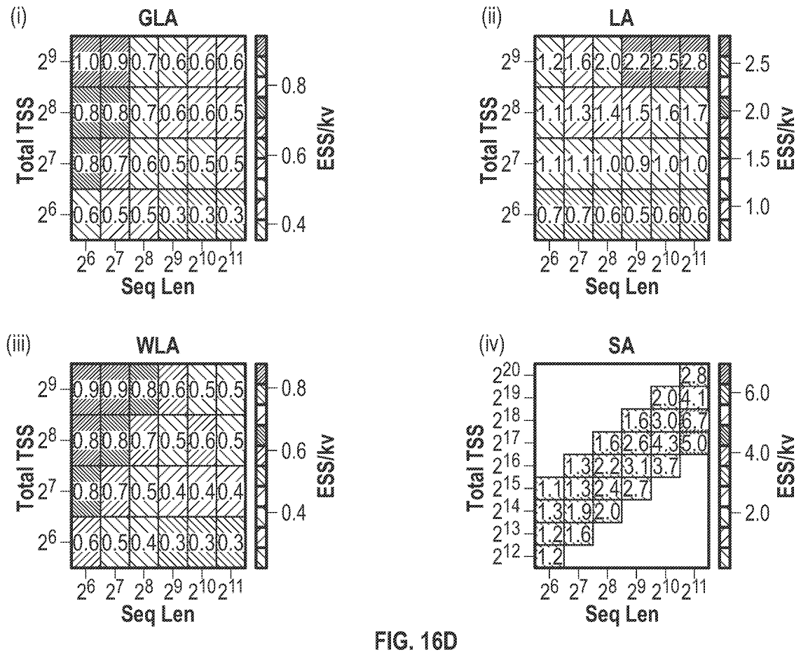

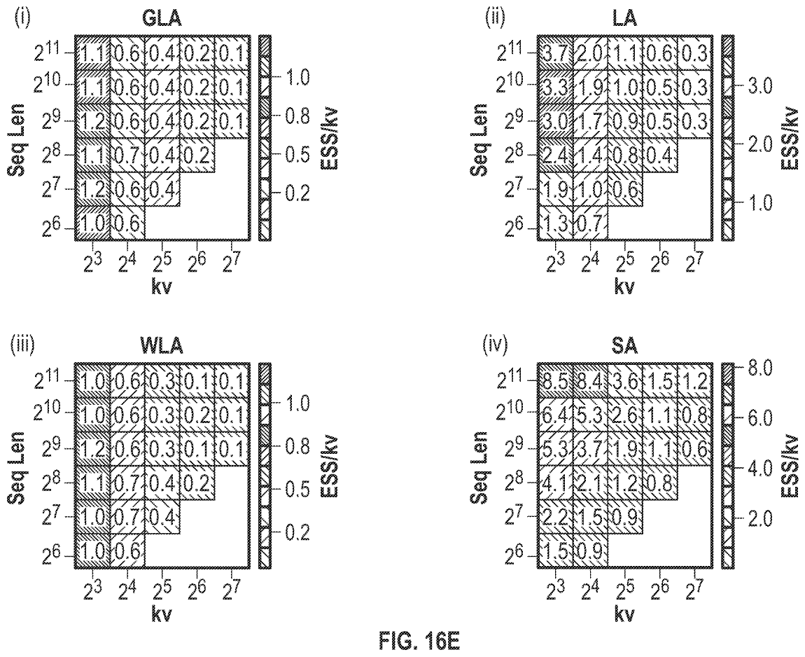

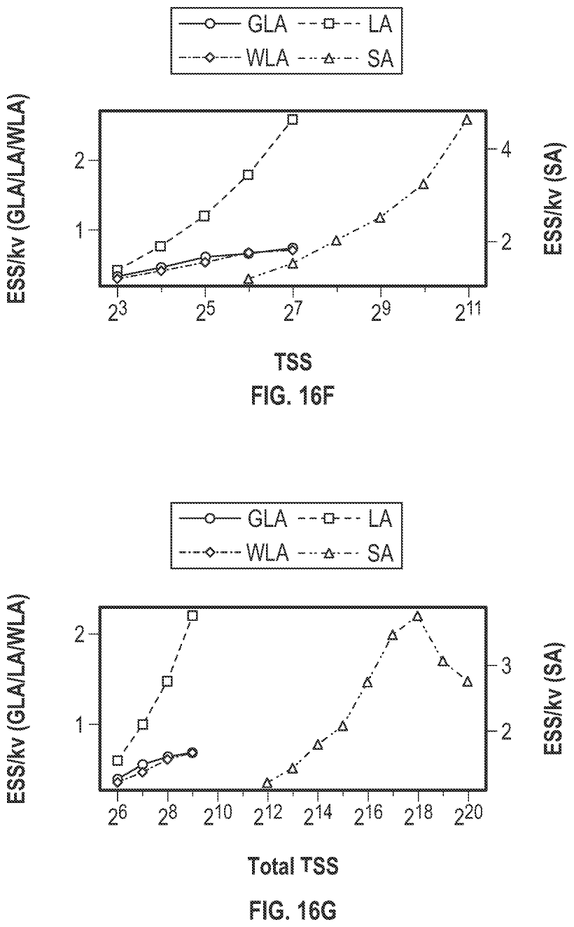

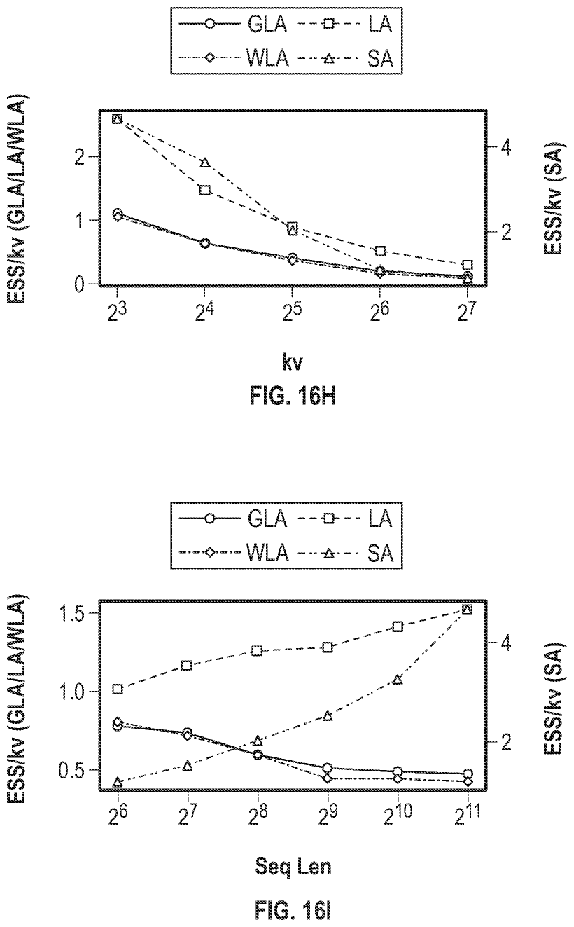

FIGS. 16-20 expand upon FIG. 15 by plotting the tolerance-ESS or TSS metric marginalized across different dimensions. FIG. 16 illustrates MQAR ESS/kv marginalized across different dimensions, according to some embodiments. For instance, FIG. 16A(i)-FIG. 16A(iv) illustrates MQAR tolerance-ESS/kv marginalized across TSS versus kv for (i) GLA featurizer, (ii) LA featurizer, (iii) WLA featurizer, and (iv) SA featurizer, according to some embodiments. FIG. 16B(i)-FIG. 16B(iv) illustrates MQAR tolerance-ESS/kv marginalized across total TSS versus kv for (i) GLA featurizer, (ii) LA featurizer, (iii) WLA featurizer, and (iv) SA featurizer, according to some embodiments. FIG. 16C(i)-FIG. 16C(iv) illustrates MQAR tolerance-ESS/kv marginalized across TSS versus sequence length for (i) GLA featurizer, (ii) LA featurizer, (iii) WLA featurizer, and (iv) SA featurizer, according to some embodiments. FIG. 16D(i)-FIG. 16D(iv) illustrates MQAR tolerance-ESS/kv marginalized across total TSS versus sequence length for (i) GLA featurizer, (ii) LA featurizer, (iii) WLA featurizer, and (iv) SA featurizer, according to some embodiments. FIG. 16E(i)-FIG. 16E(iv) illustrates MQAR tolerance-ESS/kv marginalized across sequence length versus kv for (i) GLA featurizer, (ii) LA featurizer, (iii) WLA featurizer, and (iv) SA featurizer, according to some embodiments. FIG. 16F illustrates MQAR tolerance-ESS/kv versus TSS, according to some embodiments. FIG. 16G illustrates MQAR tolerance-ESS/kv versus total TSS, according to some embodiments. FIG. 16H illustrates MQAR tolerance-ESS/kv versus kv, according to some embodiments. FIG. 16I illustrates MQAR tolerance-ESS/kv versus sequence length, according to some embodiments.

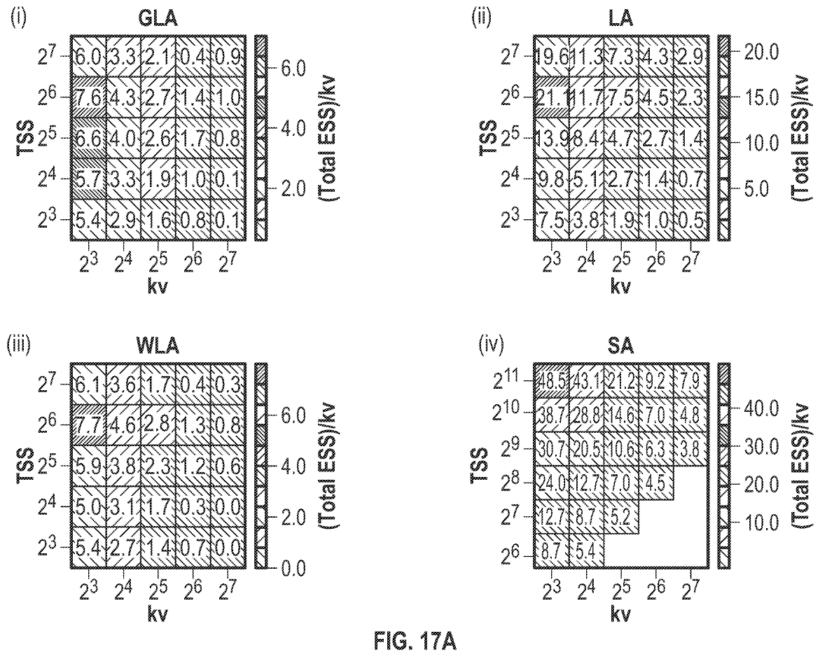

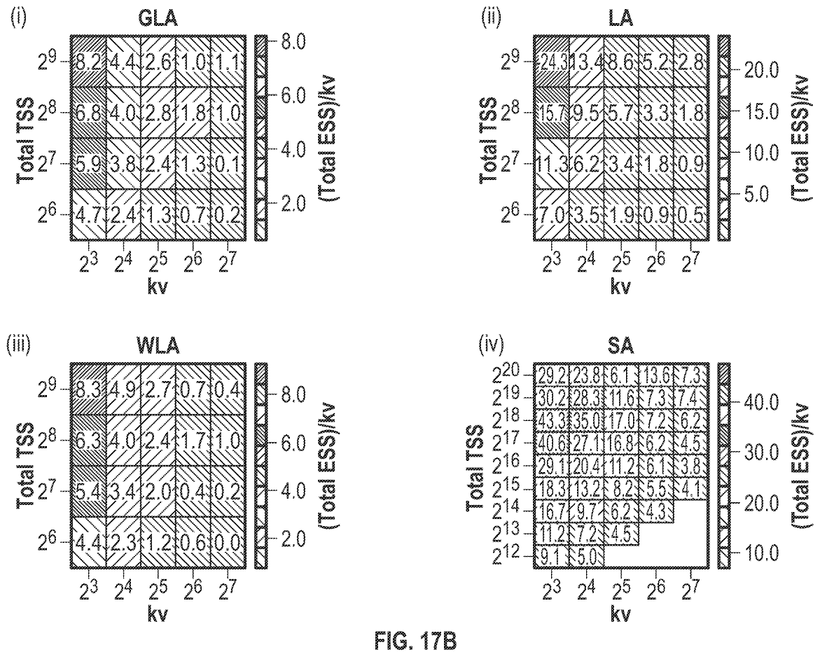

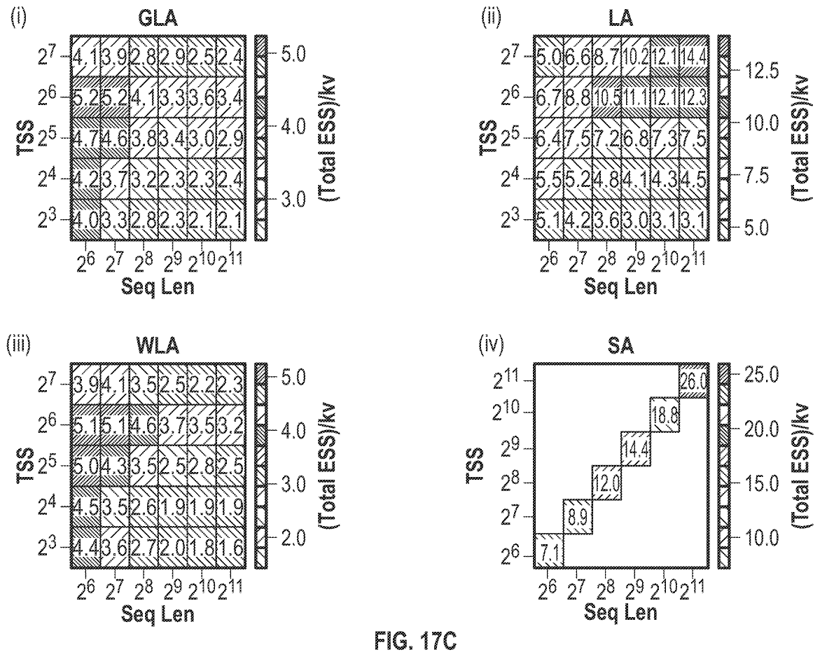

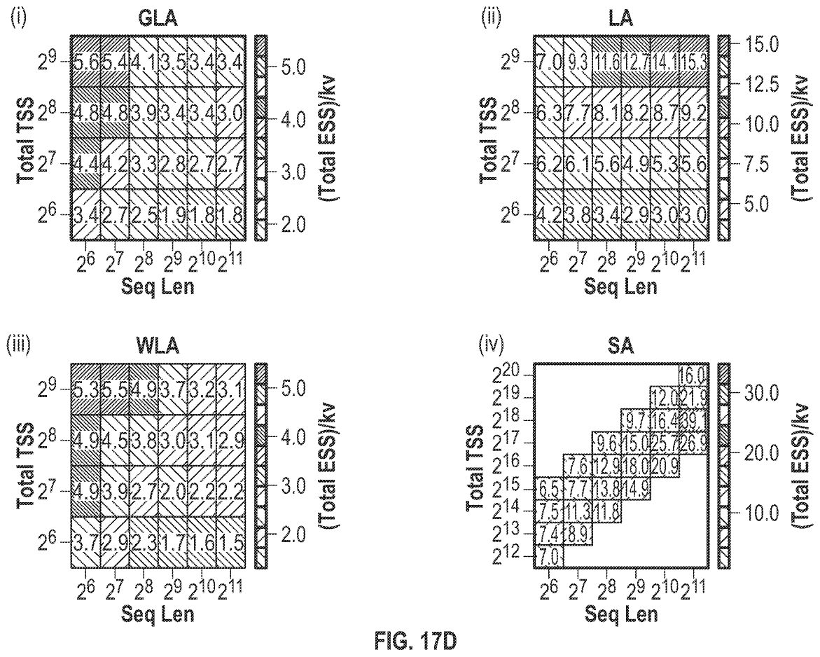

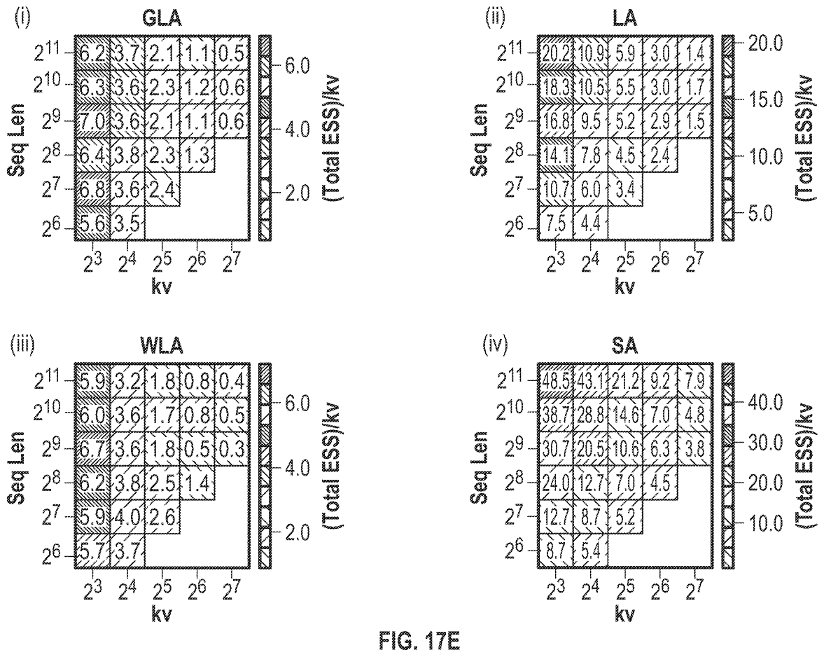

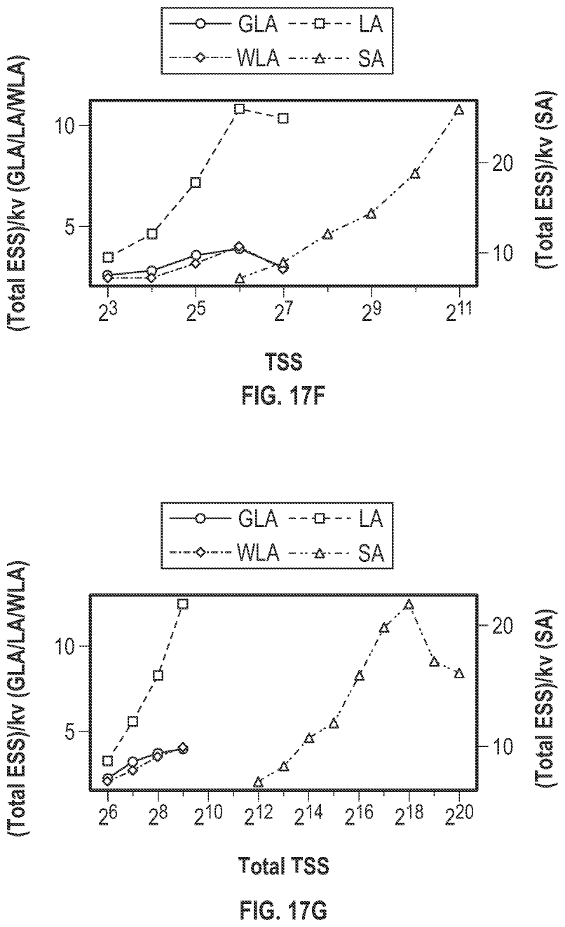

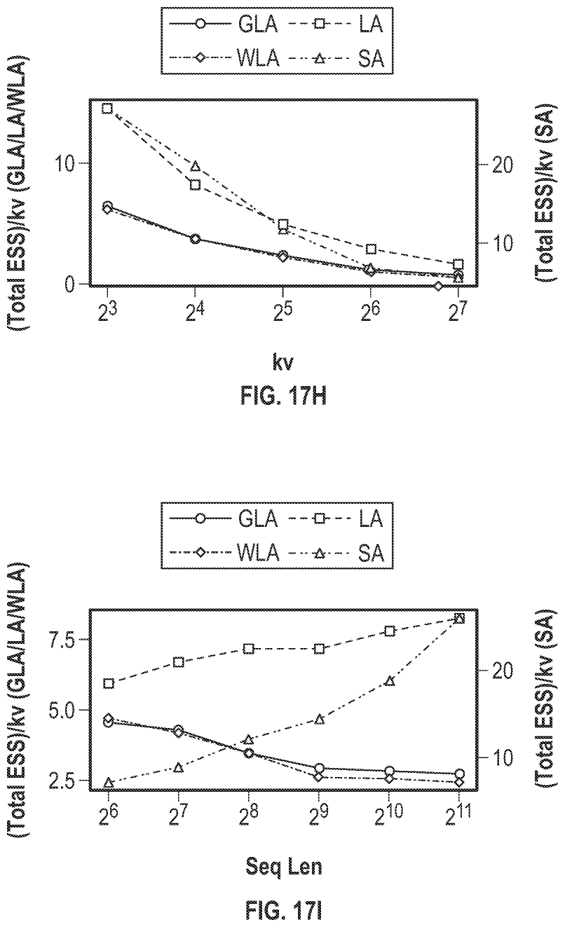

FIG. 17 illustrates MQAR (total ESS)/kv marginalized across different dimensions, according to some embodiments. For instance, FIG. 17A(i)-FIG. 17A(iv) illustrates MQAR (total tolerance-ESS)/kv marginalized across TSS versus kv for (i) GLA featurizer, (ii) LA featurizer, (iii) WLA featurizer, and (iv) SA featurizer, according to some embodiments. FIG. 17B(i)-FIG. 17B(iv) illustrates MQAR (total tolerance-ESS)/kv marginalized across total TSS versus kv for (i) GLA featurizer, (ii) LA featurizer, (iii) WLA featurizer, and (iv) SA featurizer, according to some embodiments. FIG. 17C(i)-FIG. 17C(iv) illustrates MQAR (total tolerance-ESS)/kv marginalized across TSS versus sequence length for (i) GLA featurizer, (ii) LA featurizer, (iii) WLA featurizer, and (iv) SA featurizer, according to some embodiments. FIG. 17D(i)-FIG. 17D(iv) illustrates MQAR (total tolerance-ESS)/kv marginalized across total TSS versus sequence length for (i) GLA featurizer, (ii) LA featurizer, (iii) WLA featurizer, and (iv) SA featurizer, according to some embodiments. FIG. 17E(i)-FIG. 17E(iv) illustrates MQAR (total tolerance-ESS)/kv marginalized across sequence length versus kv for (i) GLA featurizer, (ii) LA featurizer, (iii) WLA featurizer, and (iv) SA featurizer, according to some embodiments. FIG. 17F illustrates MQAR (total tolerance-ESS)/kv versus TSS, according to some embodiments. FIG. 17G illustrates MQAR (total tolerance-ESS)/kv versus total TSS, according to some embodiments. FIG. 17H illustrates MQAR (total tolerance-ESS)/kv versus kv, according to some embodiments. FIG. 17I illustrates MQAR (total tolerance-ESS)/kv versus sequence length, according to some embodiments.

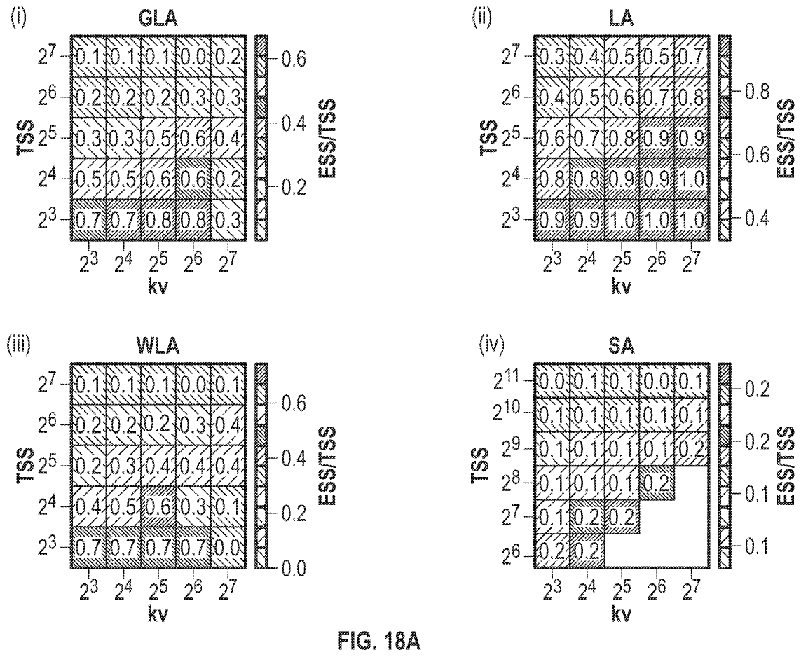

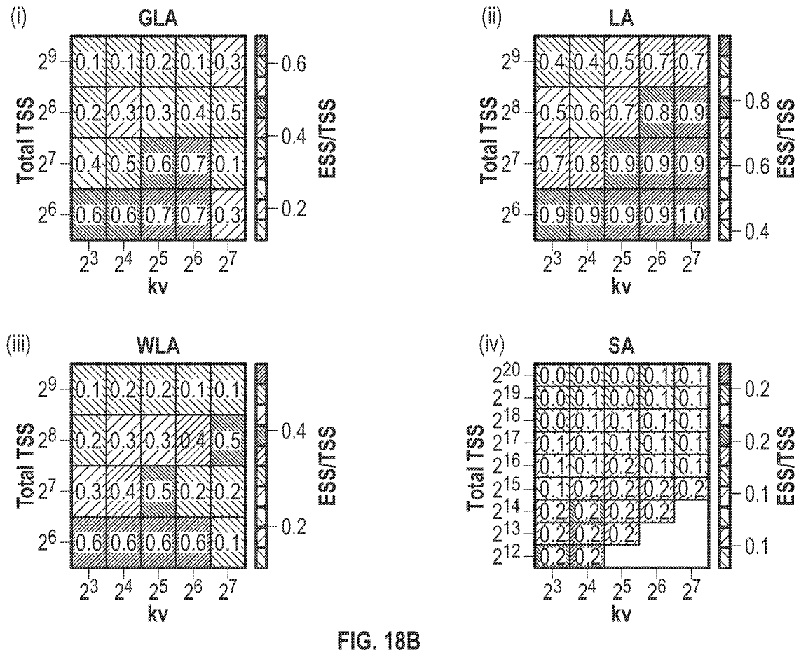

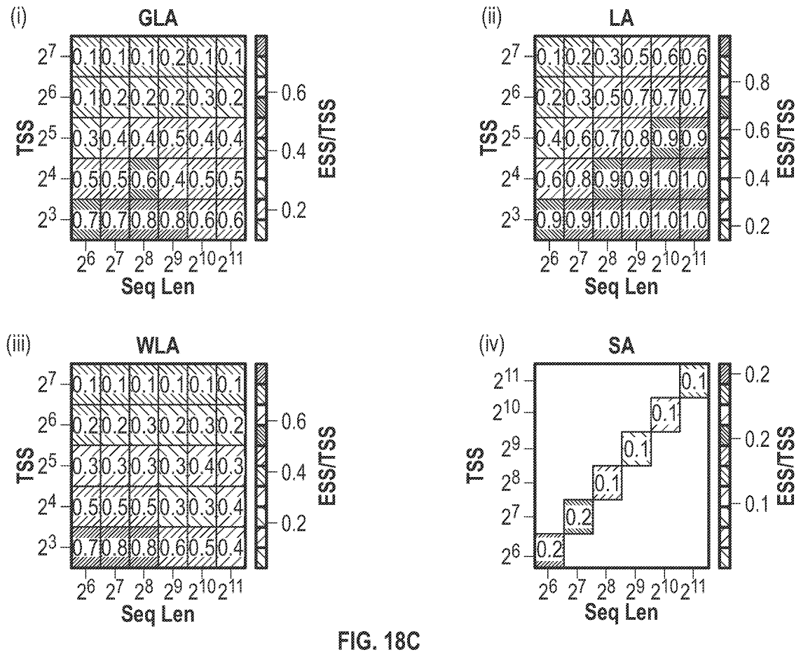

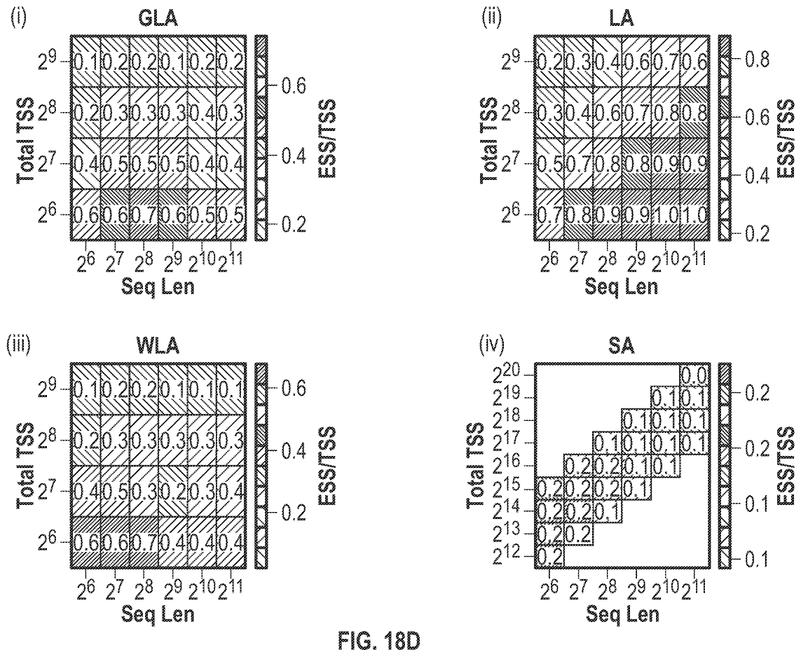

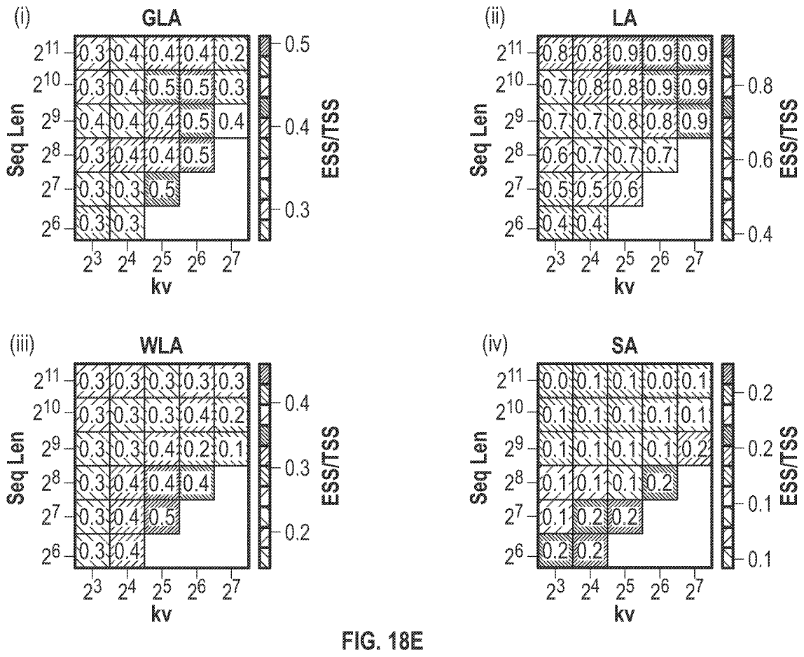

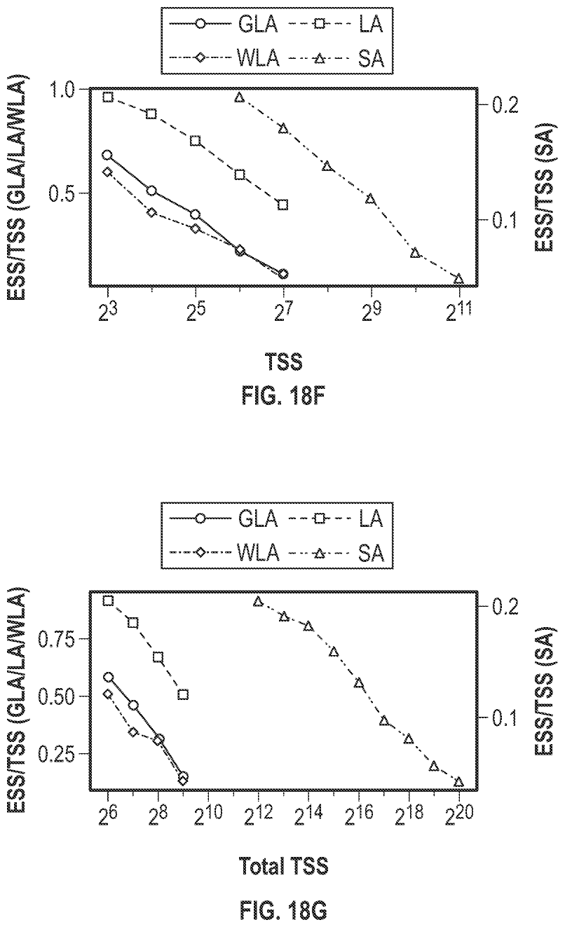

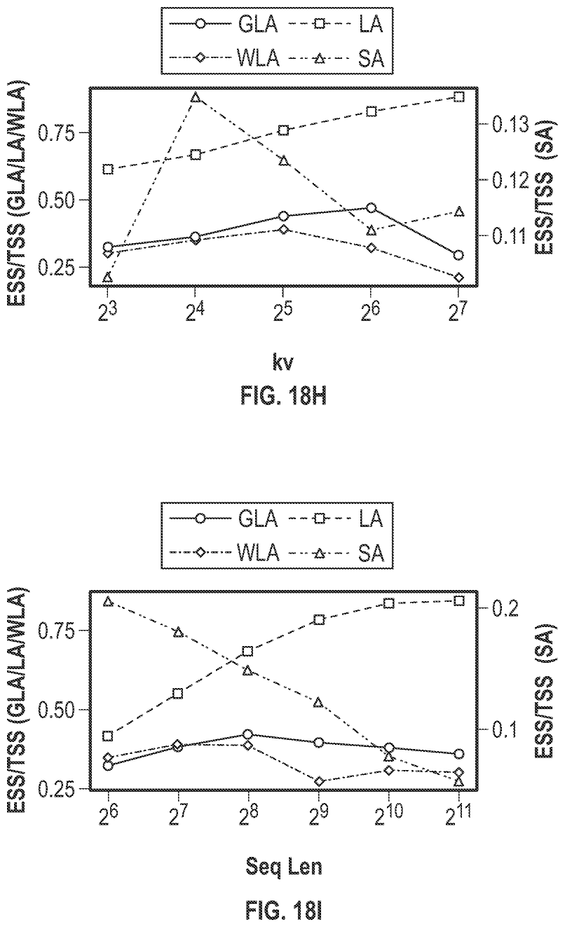

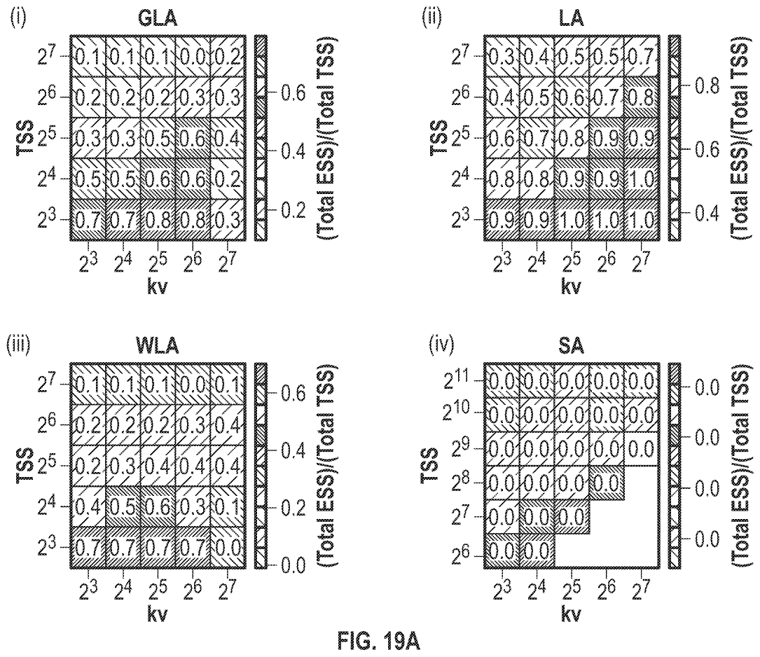

FIG. 18 illustrates MQAR ESS/TSS marginalized across different dimensions, according to some embodiments. For instance, FIG. 18A(i)-FIG. 18A(iv) illustrates MQAR tolerance-ESS/TSS marginalized across TSS versus kv for (i) GLA featurizer, (ii) LA featurizer, (iii) WLA featurizer, and (iv) SA featurizer, according to some embodiments. FIG. 18B(i)-FIG. 18B(iv) illustrates MQAR tolerance-ESS/TSS marginalized across total TSS versus kv for (i) GLA featurizer, (ii) LA featurizer, (iii) WLA featurizer, and (iv) SA featurizer, according to some embodiments. FIG. 18C(i)-FIG. 18C(iv) illustrates MQAR tolerance-ESS/TSS marginalized across TSS versus sequence length for (i) GLA featurizer, (ii) LA featurizer, (iii) WLA featurizer, and (iv) SA featurizer, according to some embodiments. FIG. 18D(i)-FIG. 18D(iv) illustrates MQAR tolerance-ESS/TSS marginalized across total TSS versus sequence length for (i) GLA featurizer, (ii) LA featurizer, (iii) WLA featurizer, and (iv) SA featurizer, according to some embodiments. FIG. 18E(i)-FIG. 18E(iv) illustrates MQAR tolerance-ESS/TSS marginalized across sequence length versus kv for (i) GLA featurizer, (ii) LA featurizer, (iii) WLA featurizer, and (iv) SA featurizer, according to some embodiments. FIG. 18F illustrates MQAR tolerance-ESS/TSS versus TSS, according to some embodiments. FIG. 18G illustrates MQAR tolerance-ESS/TSS versus total TSS, according to some embodiments. FIG. 18H illustrates MQAR tolerance-ESS/TSS versus kv, according to some embodiments. FIG. 18I illustrates MQAR tolerance-ESS/TSS versus sequence length, according to some embodiments.

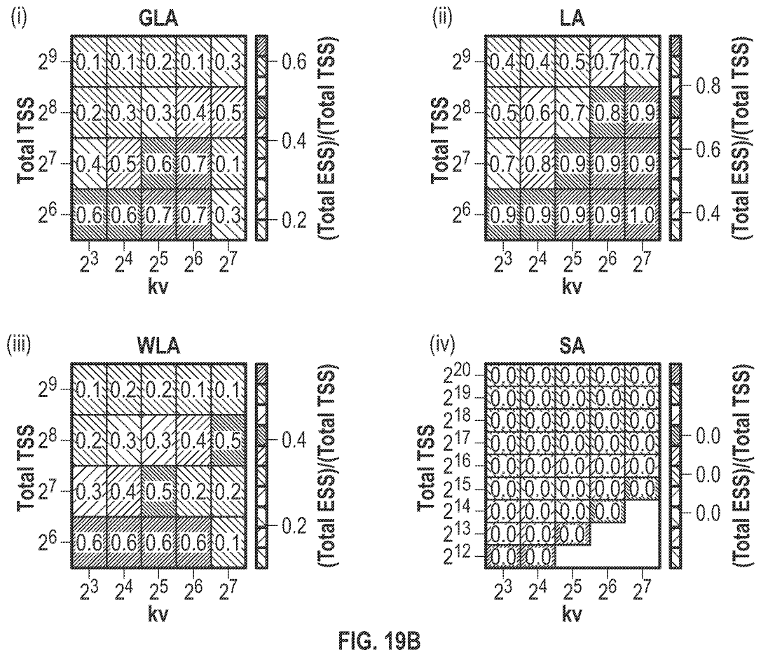

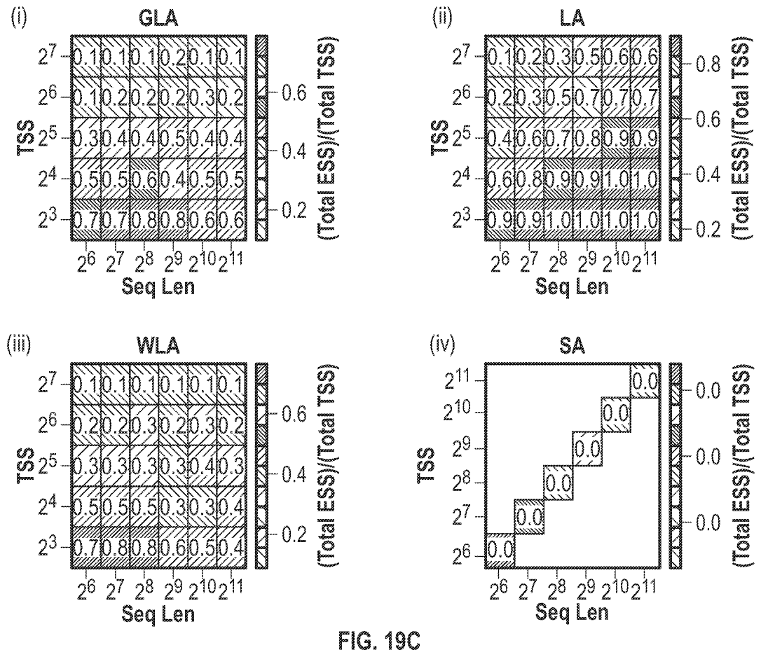

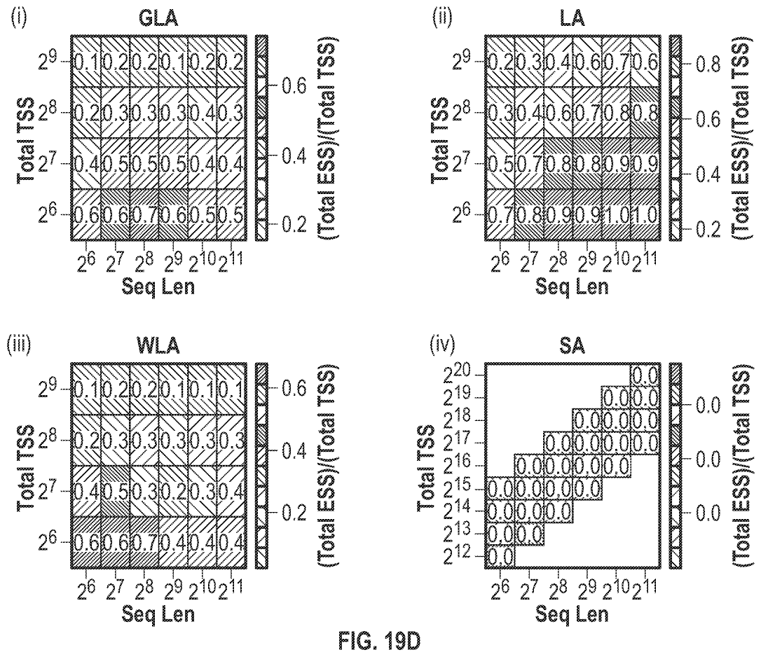

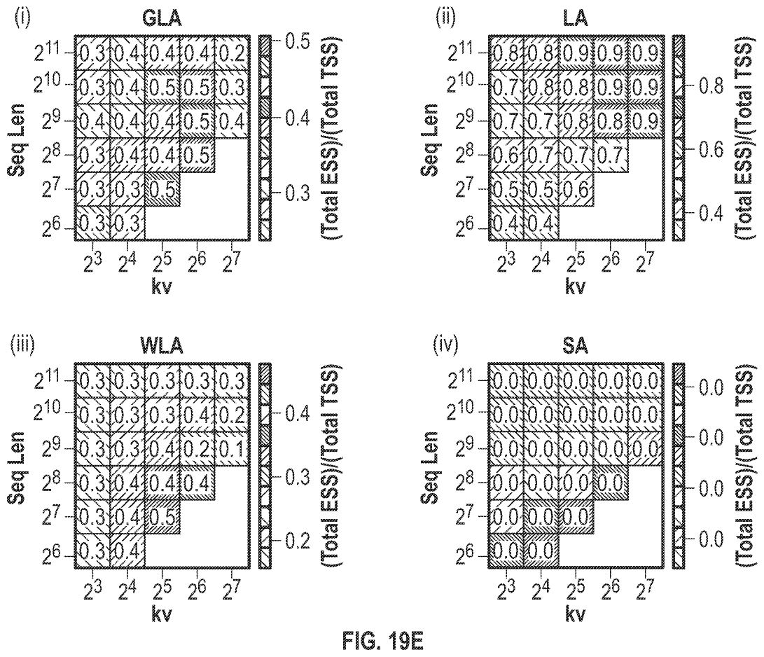

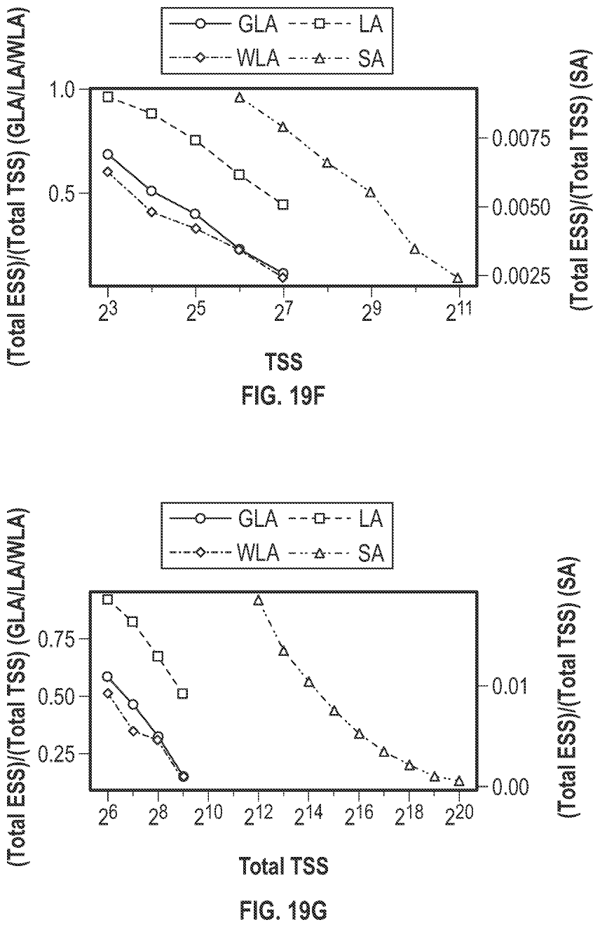

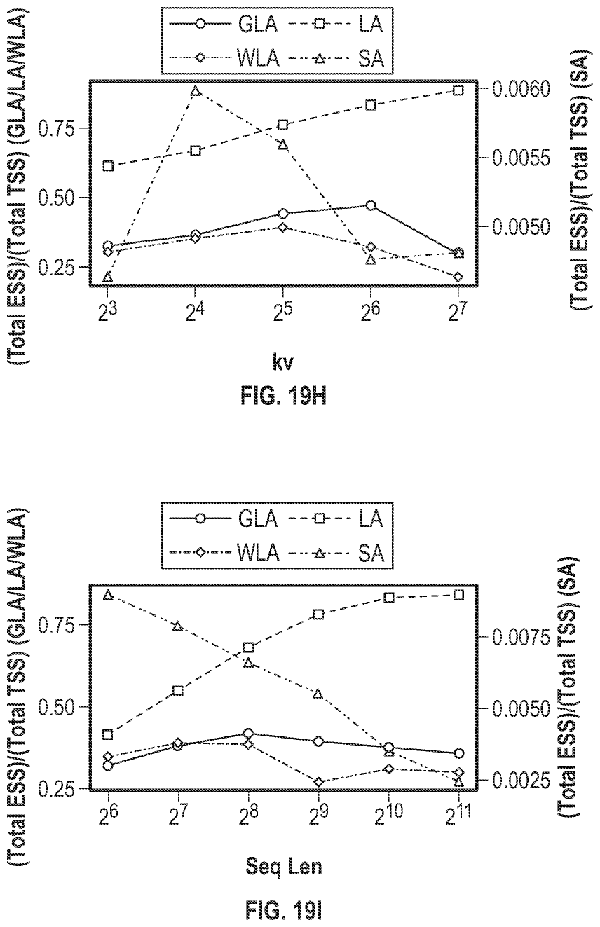

FIG. 19 illustrates MQAR (total ESS)/(total TSS) marginalized across different dimensions, according to some embodiments. For instance, FIG. 19A(i)-FIG. 19A(iv) illustrates MQAR (total tolerance-ESS)/(total TSS) marginalized across TSS versus kv for (i) GLA featurizer, (ii) LA featurizer, (iii) WLA featurizer, and (iv) SA featurizer, according to some embodiments. FIG. 19B(i)-FIG. 19B(iv) illustrates MQAR (total tolerance-ESS)/(total TSS) marginalized across total TSS versus kv for (i) GLA featurizer, (ii) LA featurizer, (iii) WLA featurizer, and (iv) SA featurizer, according to some embodiments. FIG. 19C(i)-FIG. 19C(iv) illustrates MQAR (total tolerance-ESS)/(total TSS) marginalized across TSS versus sequence length for (i) GLA featurizer, (ii) LA featurizer, (iii) WLA featurizer, and (iv) SA featurizer, according to some embodiments. FIG. 19D(i)-FIG. 19D(iv) illustrates MQAR (total tolerance-ESS)/(total TSS) marginalized across total TSS versus sequence length for (i) GLA featurizer, (ii) LA featurizer, (iii) WLA featurizer, and (iv) SA featurizer, according to some embodiments. FIG. 19E(i)-FIG. 19E(iv) illustrates MQAR (total tolerance-ESS)/(total TSS) marginalized across sequence length versus kv for (i) GLA featurizer, (ii) LA featurizer, (iii) WLA featurizer, and (iv) SA featurizer, according to some embodiments. FIG. 19F illustrates MQAR (total tolerance-ESS)/(total TSS) versus TSS, according to some embodiments. FIG. 19G illustrates MQAR (total tolerance-ESS)/(total TSS) versus total TSS, according to some embodiments. FIG. 19H illustrates MQAR (total tolerance-ESS)/(total TSS) versus kv, according to some embodiments. FIG. 19I illustrates MQAR (total tolerance-ESS)/(total TSS) versus sequence length, according to some embodiments.

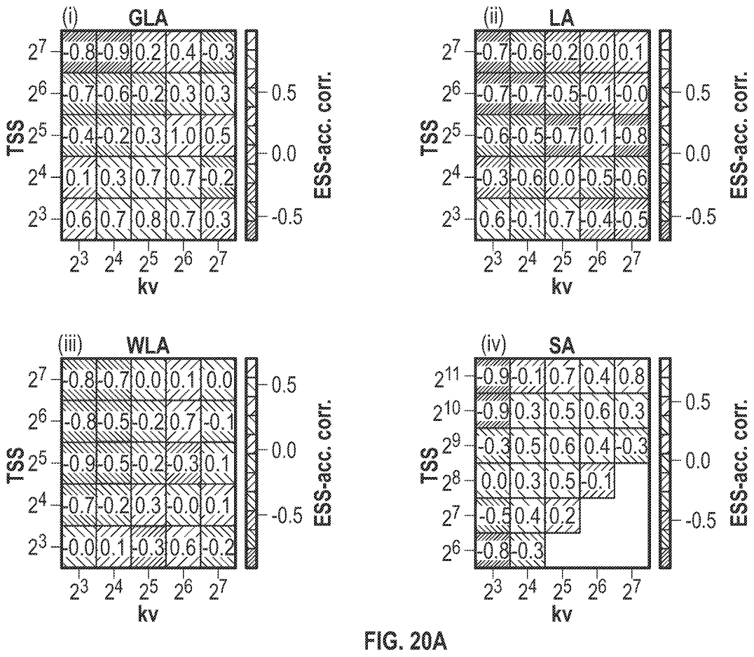

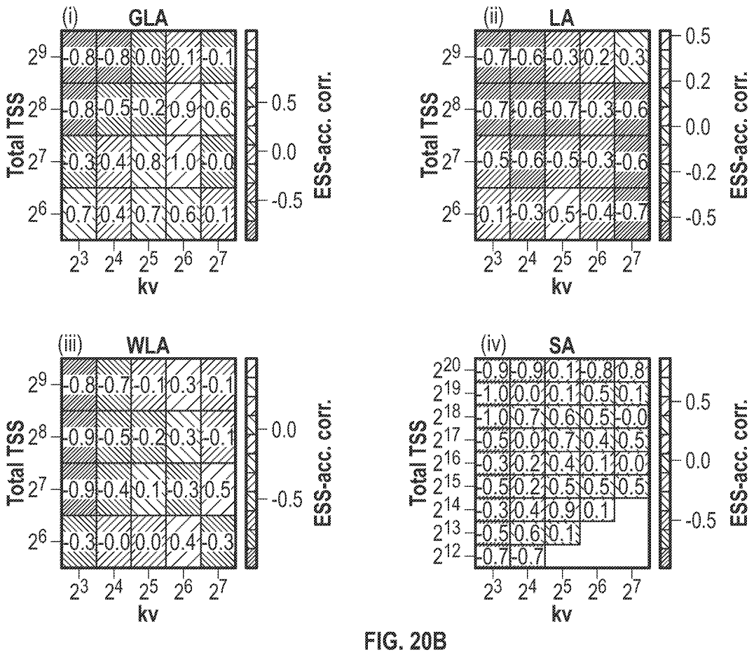

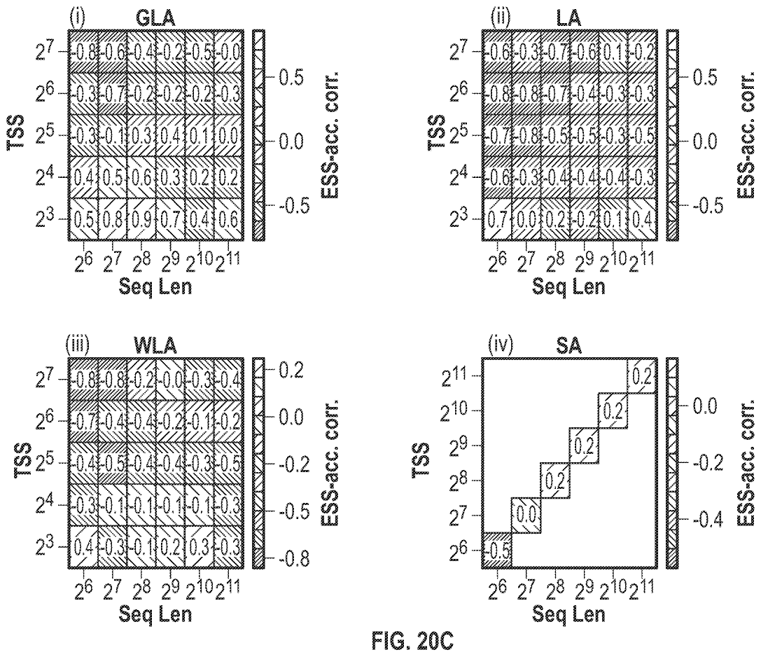

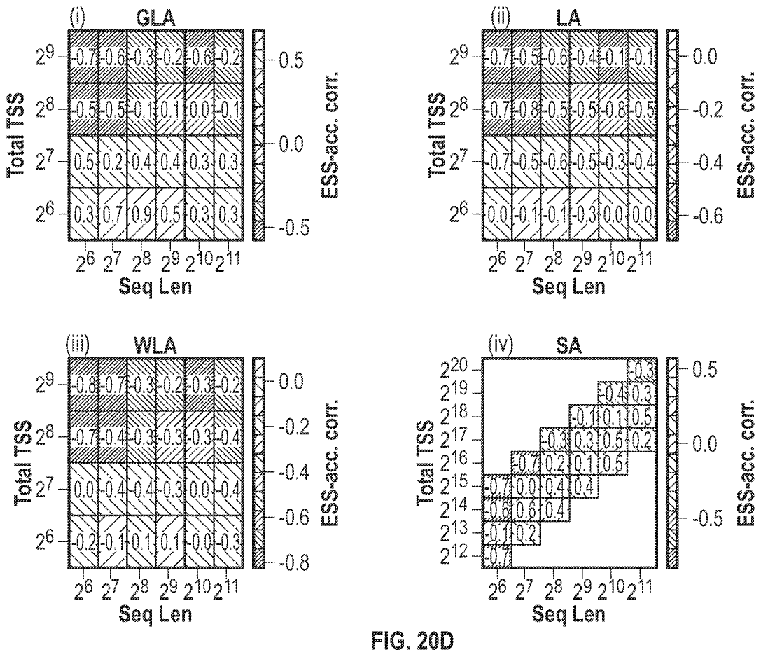

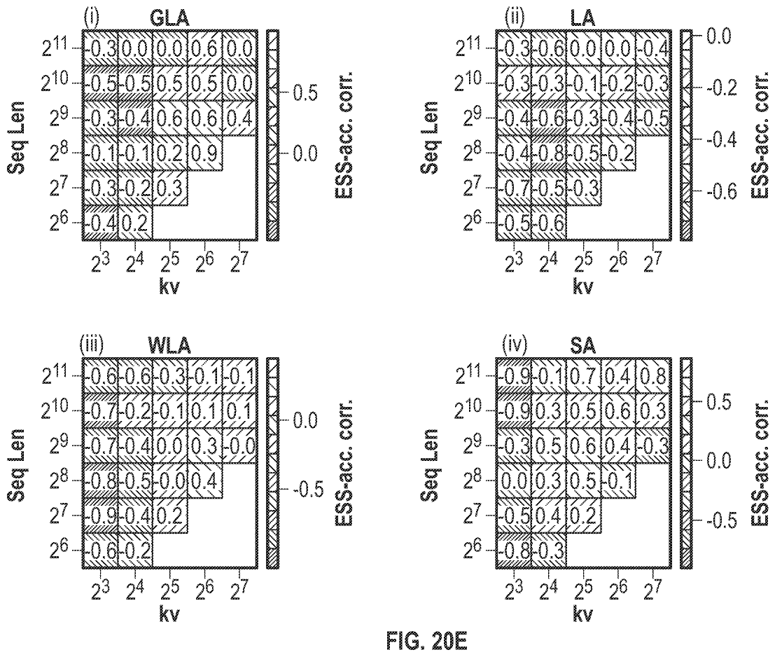

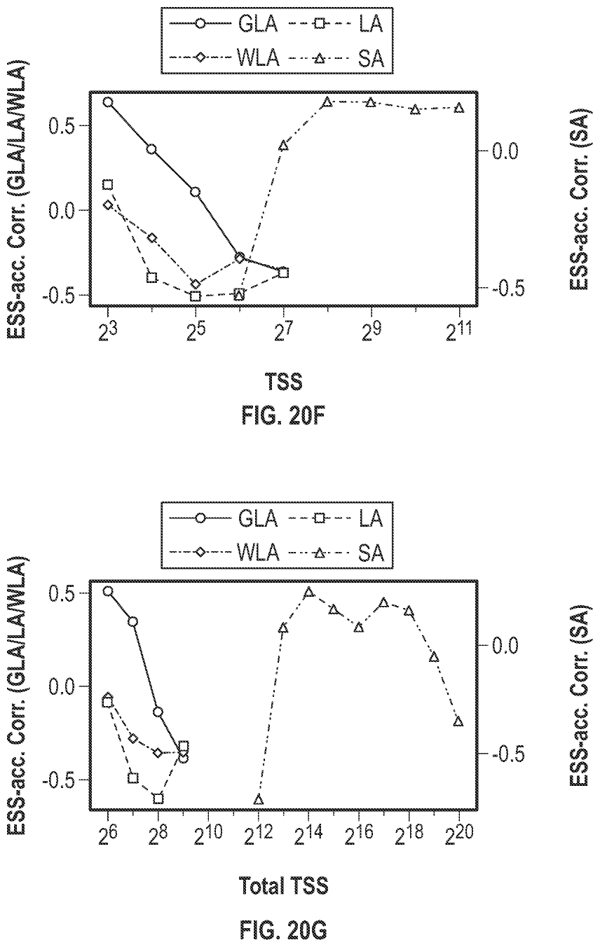

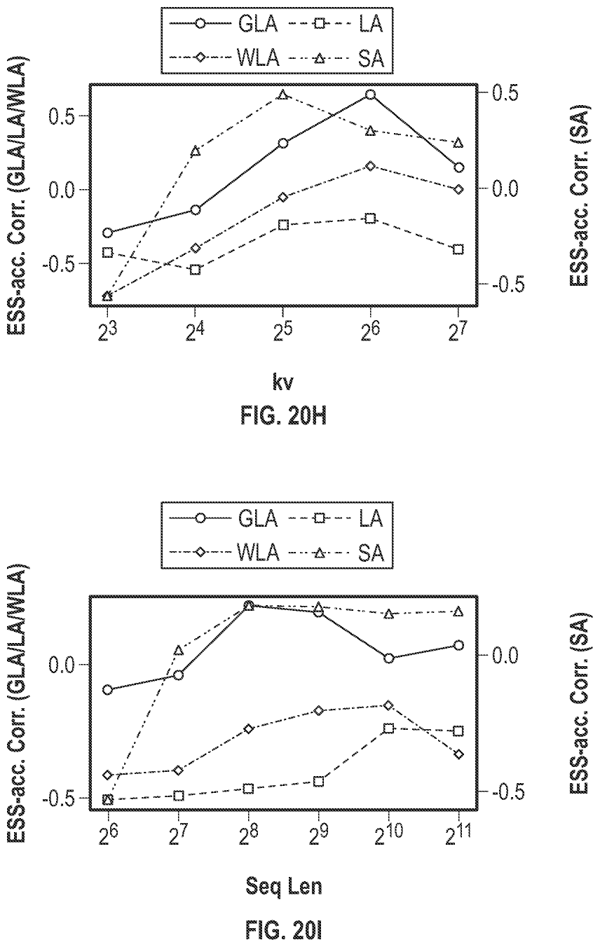

FIG. 20 illustrates MQAR ESS-accuracy correlations computed over training marginalized across different dimensions, according to some embodiments. For instance, FIG. 20A(i)-FIG. 20A(iv) illustrates MQAR tolerance-ESS-accuracy correlations computed over training marginalized across TSS versus kv for (i) GLA featurizer, (ii) LA featurizer, (iii) WLA featurizer, and (iv) SA featurizer, according to some embodiments. FIG. 20B(i)-FIG. 20B(iv) illustrates MQAR tolerance-ESS-accuracy correlations computed over training marginalized across total TSS versus kv for (i) GLA featurizer, (ii) LA featurizer, (iii) WLA featurizer, and (iv) SA featurizer, according to some embodiments. FIG. 20C(i)-FIG. 20C(iv) illustrates MQAR tolerance-ESS-accuracy correlations computed over training marginalized across TSS versus sequence length for (i) GLA featurizer, (ii) LA featurizer, (iii) WLA featurizer, and (iv) SA featurizer, according to some embodiments. FIG. 20D(i)-FIG. 20D(iv) illustrates MQAR tolerance-ESS-accuracy correlations computed over training marginalized across total TSS versus sequence length for (i) GLA featurizer, (ii) LA featurizer, (iii) WLA featurizer, and (iv) SA featurizer, according to some embodiments. FIG. 20E(i)-FIG. 20E(iv) illustrates MQAR tolerance-ESS-accuracy correlations computed over training marginalized across sequence length versus kv for (i) GLA featurizer, (ii) LA featurizer, (iii) WLA featurizer, and (iv) SA featurizer, according to some embodiments. FIG. 20F illustrates MQAR tolerance-ESS-accuracy correlations computed over training versus TSS, according to some embodiments. FIG. 20G illustrates MQAR tolerance-ESS-accuracy correlations computed over training versus total TSS, according to some embodiments. FIG. 20H illustrates MQAR tolerance-ESS-accuracy correlations computed over training versus kv, according to some embodiments. FIG. 20I illustrates MQAR tolerance-ESS-accuracy correlations computed over training versus sequence length, according to some embodiments. Similar trends as FIGS. 16-20 may be observed, in some embodiments, for tolerance-ESS measurements with a tolerance of 1e-1 and 1e-5.

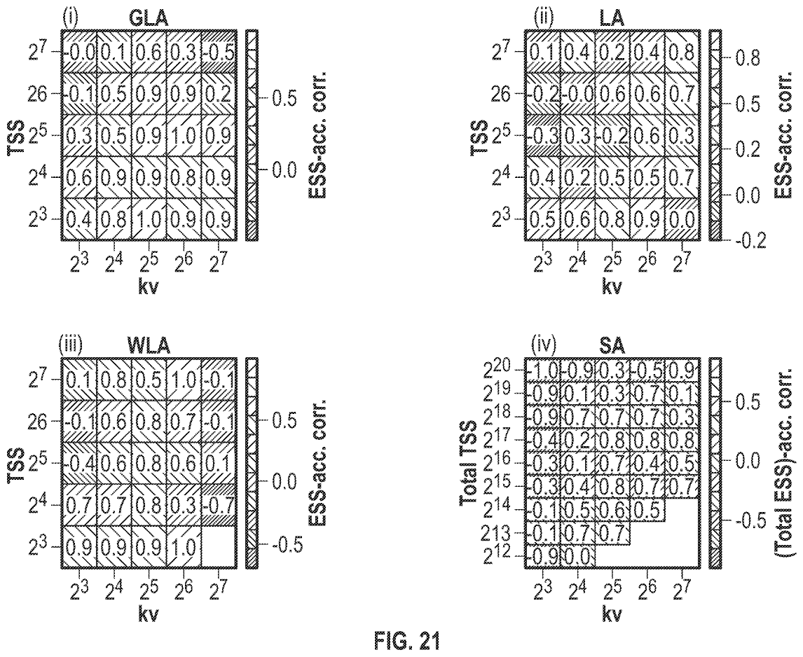

In some embodiments, ESS analysis may reveal how ESS evolves as a function of MQAR performance in a regime where TSS is kept fixed, and, therefore, does not correlate with accuracy; this ESS analysis may be performed by analyzing ESS-accuracy correlation on a per-model, per-task basis over the course of training. In some embodiments, ESS analysis includes an average across 8 samples (e.g., batch size). FIG. 21(i)-FIG. 21(iv) illustrates an exemplary correlation between ESS and accuracy over the course of model training bucketed by TSS and kv for (i) GLA featurizer, (ii) LA featurizer, (iii) WLA featurizer, and (iv) SA featurizer, according to some embodiments. The empty bucket in the WLA grid corresponds to a NaN from the entropy-ESS computation, and the empty buckets in the SA grid correspond to the MQAR task constraints described herein. In some embodiments, for less memory-intensive tasks trained using models with high TSS, the results of ESS analysis reveal a lower correlation between ESS and performance compared to more memory-intensive tasks trained using a lower TSS (see FIG. 21). FIG. 21 supports the interpretation of ESS as a measure of memory utilization. In some embodiments, for easier tasks that are learned by a model with high memory capacity, the model is not incentivized to increase its memory utilization beyond where it resides at initialization. In contrast, for difficult tasks that operate in a memory-constrained regime, the model may be forced to increase its memory utilization in order to learn, which may result in a strong positive correlation between accuracy and ESS over training. This ESS analysis may additionally reveal failure modes of model learning in recurrent frameworks with bounded TSS, for example state saturation and state collapse.

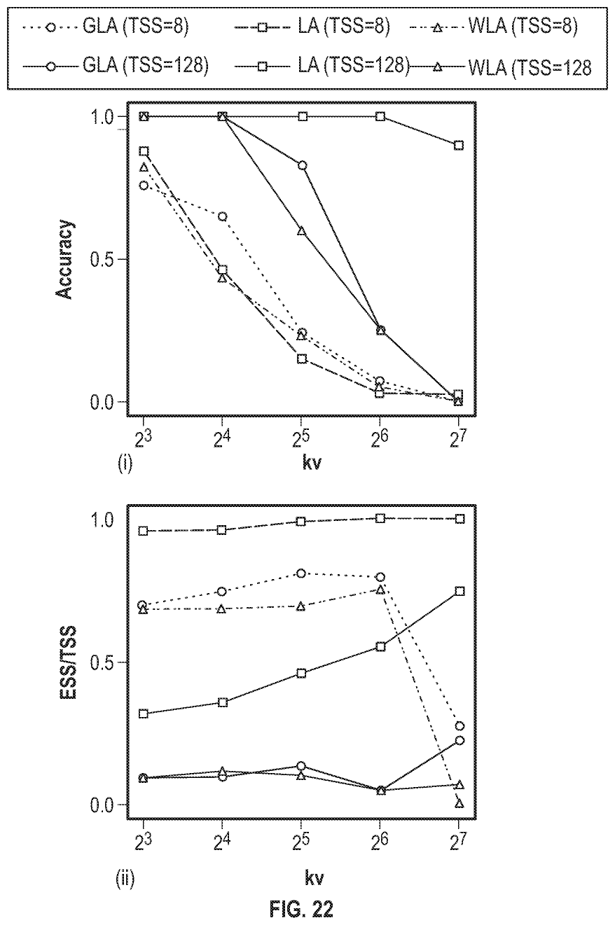

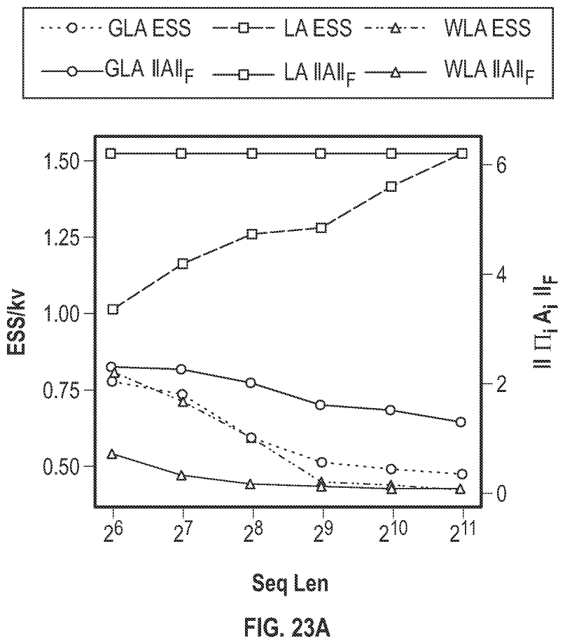

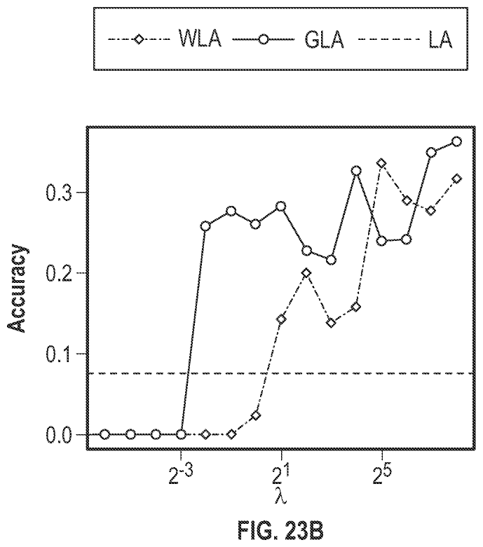

In some embodiments, state saturation refers to the scenario in which a model has insufficient TSS to fully learn a task, resulting in its ESS converging near its TSS. State saturation may be observed when a model's ESS/TSS, which may be referred to as state utilization, resides near 1. In some embodiments, state collapse refers to the scenario in which a model has sufficient TSS to learn, or partially learn, a task, but its ESS fails to increase during training, resulting in a heavily underutilized state. FIG. 22(i)-FIG. 22(ii) is an exemplary depiction of state saturation and state collapse, illustrating(i) accuracy and (ii) state utilization as a function of kv for low and high TSS models.

FIG. 22 illustrates that models with a TSS of 8 may perform worse as the task difficulty scales due to a saturated state. In some embodiments, state saturation may only be resolved by increasing TSS. FIG. 22 may also illustrates that, for GLA and WLA, state collapse may occurs in the high kv bucket of task-model space (e.g., kv=2⁷), whereas for LA it may not; this shows that LA may have higher state utilization than GLA and WLA. State collapse may occur for GLA and WLA models because these models have learnable Aᵢ matrices, where i denotes the index along the sequence dimension. The learnable Aᵢ matrices may contribute to state collapse because the values of the operator submatrices Hᵢ are disproportionately influenced by Aᵢ, due to the presence of terms in the form of Aᵢ₋₁ . . . A₁ for each i. Thus, the closer Aᵢ lies to the 0-matrix, the faster these terms decay, reducing the numerical rank of Hᵢ. FIG. 23A illustrates ESS/kv and ∥ΠᵢAᵢ∥_{F} as a function of sequence length, which demonstrates that for both GLA and WLA ESS/kv and ∥ΠᵢAᵢ∥_{F} decrease a function of sequence length.

FIG. 23A, according to some embodiments, also demonstrates that ESS/kv remains large as the sequence length grows for LA models, for which the A matrix is given by the identity. In some embodiments, the state collapse in GLA and WLA may be resolved by pushing the A matrices towards the identity by adding the following term to the loss function: λ∥A−I∥_{F}, where λ denotes the strength of the regularizer and I denotes the identity; this may be referred to as an ESS-based regularization scheme. In some embodiments, the regularization scheme is applied to sequence mixing layers. For example, regarding the two sequence mixing layers described herein, the regularization scheme may be applied such that both layers are regularized, only the first layer is regularized, or only the second layer is regularized. In some embodiments, only regularizing the second layer performs the best.

FIG. 23B illustrates the accuracy of models as a function of the ESS-based regularizer strength when only the second layer is regularized in a two-sequence mixing layer system, according to some embodiments. FIG. 23B demonstrates that GLA and WLA models trained using the ESS-based regularization scheme may outperform LA, but when performed without the ESS-based regularization scheme, may perform worse than LA. By utilizing the ESS-based regularization scheme and unlike LA, GLA and WLA can better leverage their increased expressivity, which stems from their learnable A matrices.

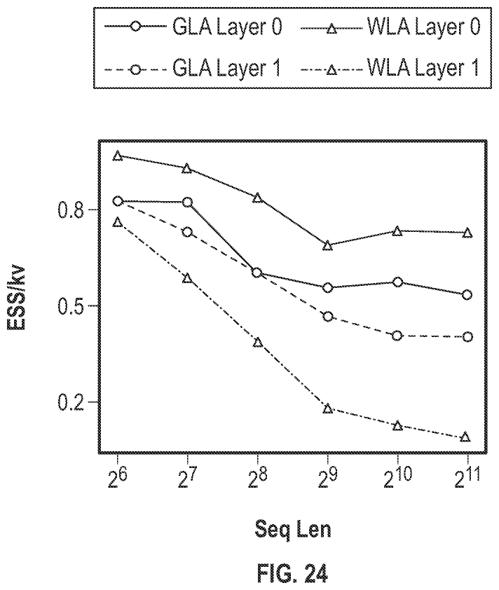

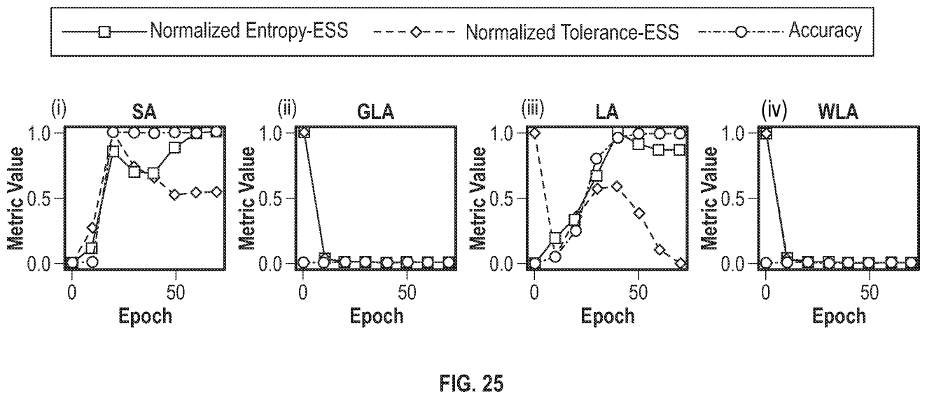

FIG. 24 illustrates the per-layer ESS/kv as a function of MQAR sequence length for the GLA and WLA featurizers, in which the ESS is computed using a tolerance of 1e-3 and the layers are 0-indexed, according to some embodiments. FIG. 25(i)-FIG. 25(iv) illustrates an example of the training dynamics of ESS in a (i) SA, (ii) GLA, (iii) LA, and (iv) WLA model (dmodel=512, heads=4) trained on MQAR (seqlen=2048, kv=128) that undergo state collapse (e.g., GLA and WLA), in which the ESS curves over the course of training are min-max normalized to emphasize the shape of the curve as opposite to the magnitude and the tolerance-ESS is computed using a tolerance of 1e-3, according to some embodiments. FIG. 24 demonstrates that layer 1 may realize a lower ESS/kv than layer 0, particularly in the case of WLA, which suggests that layer 1 contributes disproportionately to state collapse (see FIG. 25) and may need to be regularized more heavily. As described herein, the regularization scheme may be most effective when only the second layer is regularized. Introducing regularization terms for both layers may complicate optimization by creating potentially conflicting objectives, thus regularizing only the second layer is most effective. Additionally, introducing regularization terms for both layers may cause excessive decay of the A matrices towards the identity matrix such that the model reverts to the LA regime, which performs worse than GLA and WLA (see FIG. 23B), thus regularizing only the second layer may be most effective.

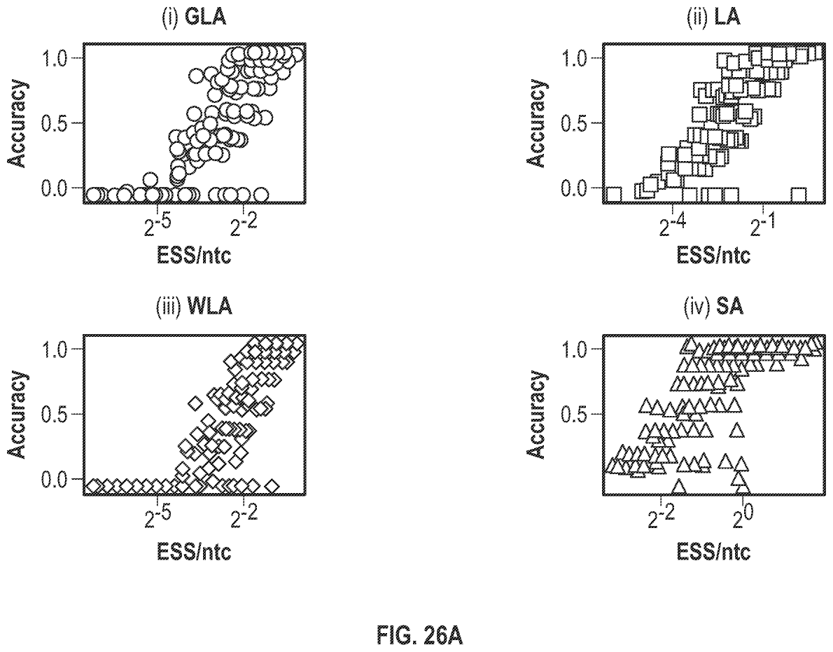

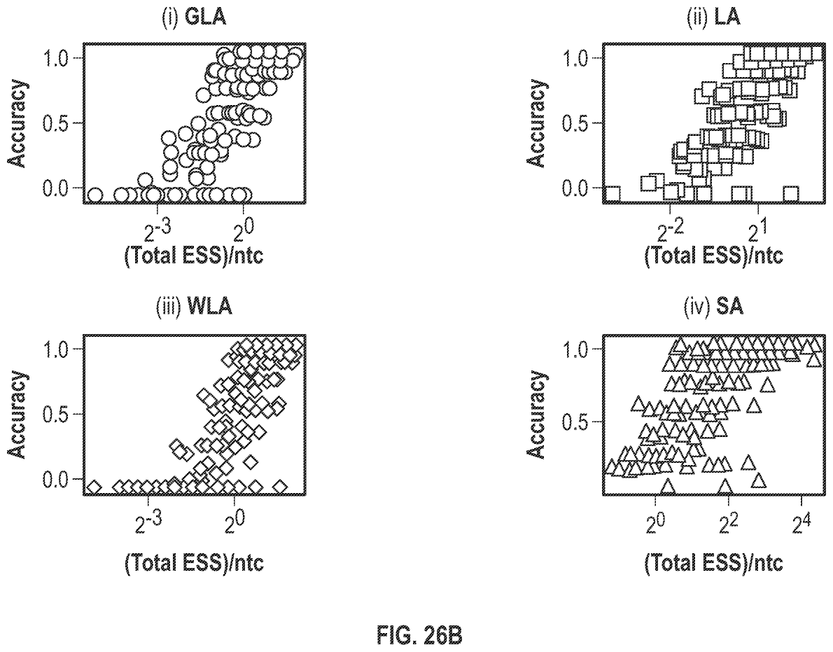

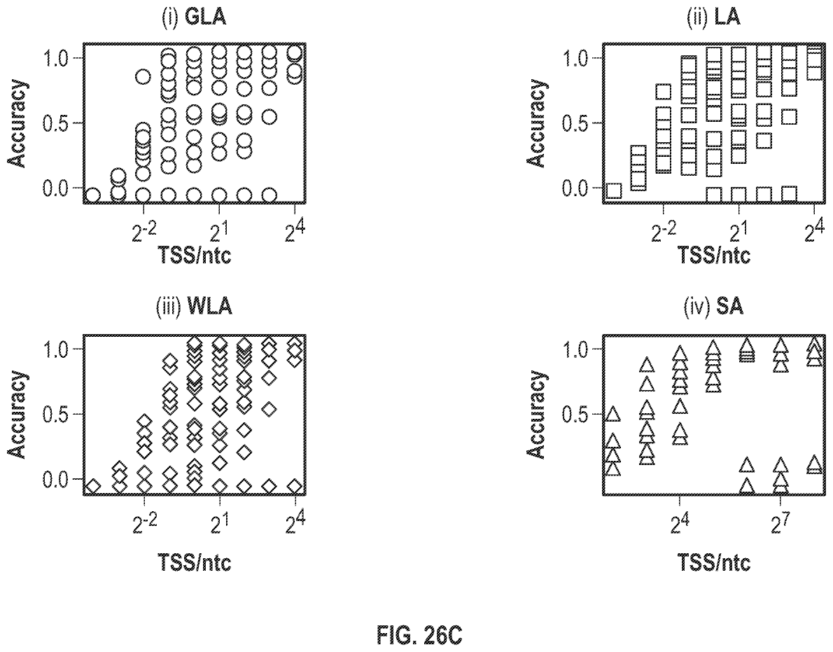

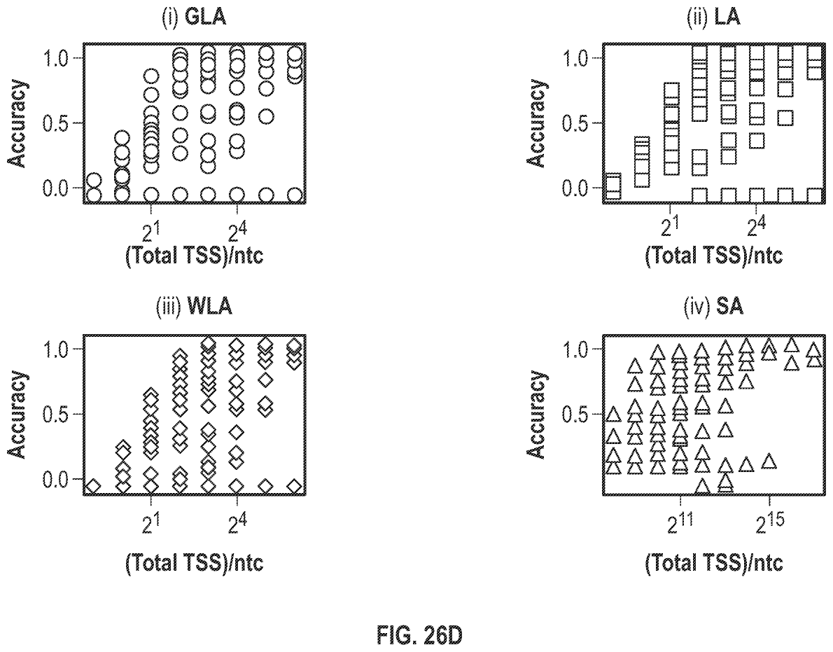

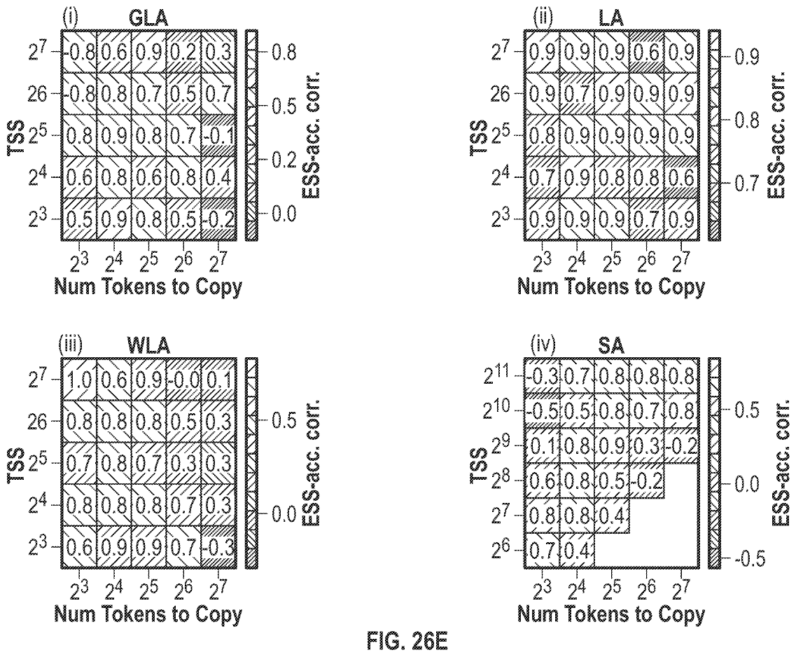

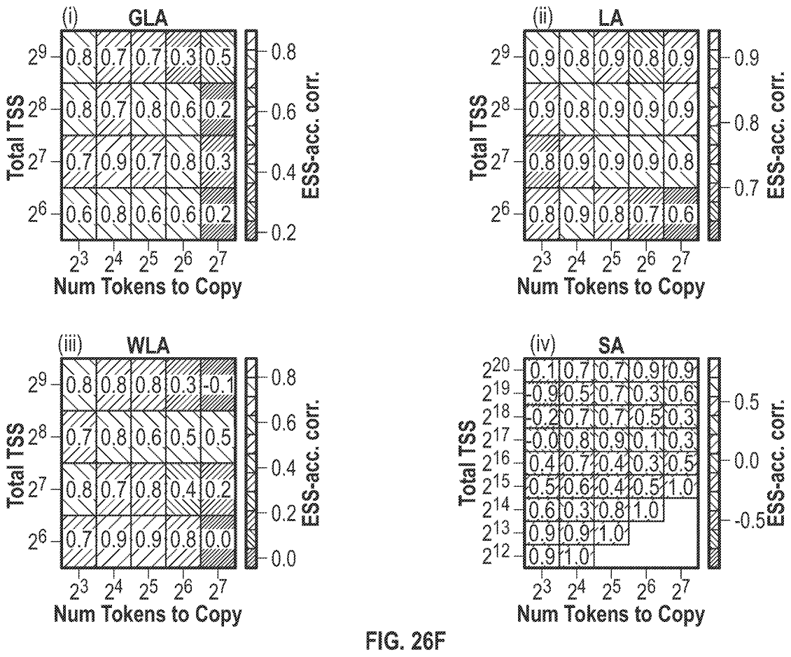

The following illustrates the ESS and TSS results for the selective copying and compression tasks. FIG. 26 illustrates results for a selective copying task in which ESS refers to entropy-ESS and number of tokens to copy is abbreviated as ntc. Specifically, FIG. 26A(i)-FIG. 26A(iv) illustrates accuracy versus ESS/ntc for (i) GLA featurizer, (ii) LA featurizer, (iii) WLA featurizer, and (iv) SA featurizer. FIG. 26B(i)-FIG. 26B(iv) illustrates accuracy versus (total ESS)/ntc for (i) GLA featurizer, (ii) LA featurizer, (iii) WLA featurizer, and (iv) SA featurizer. FIG. 26C(i)-FIG. 26C(iv) illustrates accuracy versus TSS/ntc for (i) GLA featurizer, (ii) LA featurizer, (iii) WLA featurizer, and (iv) SA featurizer. FIG. 26D(i)-FIG. 26D(iv) illustrates accuracy versus (total TSS)/ntc for (i) GLA featurizer, (ii) LA featurizer, (iii) WLA featurizer, and (iv) SA featurizer. FIG. 26E(i)-FIG. 26E(iv) illustrates ESS-accuracy correlation computed over the course of training in (TSS, kv) buckets for (i) GLA featurizer, (ii) LA featurizer, (iii) WLA featurizer, and (iv) SA featurizer. FIG. 26F(i)-FIG. 26F(iv) illustrates the ESS-accuracy correlation computed over the course of training in (total TSS, kv) buckets for (i) GLA featurizer, (ii) LA featurizer, (iii) WLA featurizer, and (iv) SA featurizer.

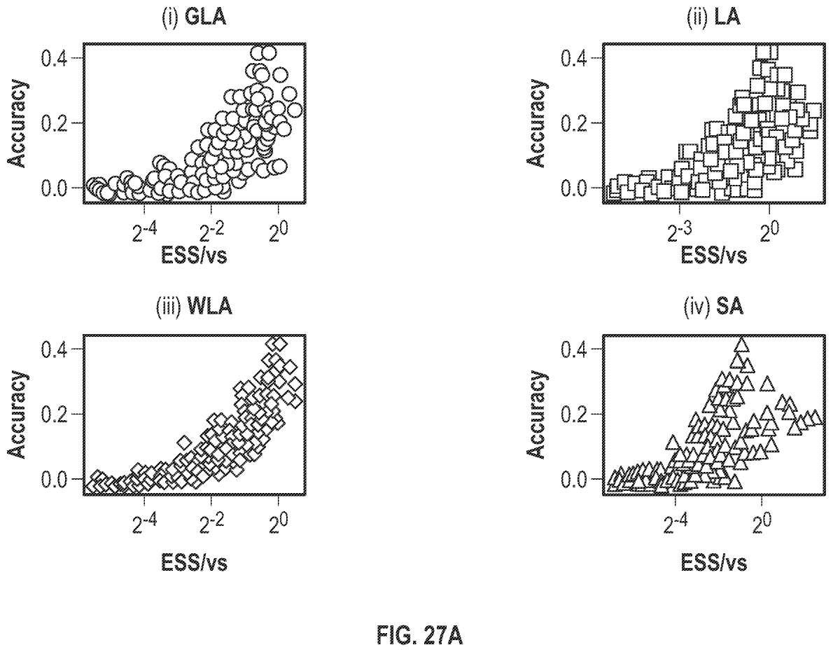

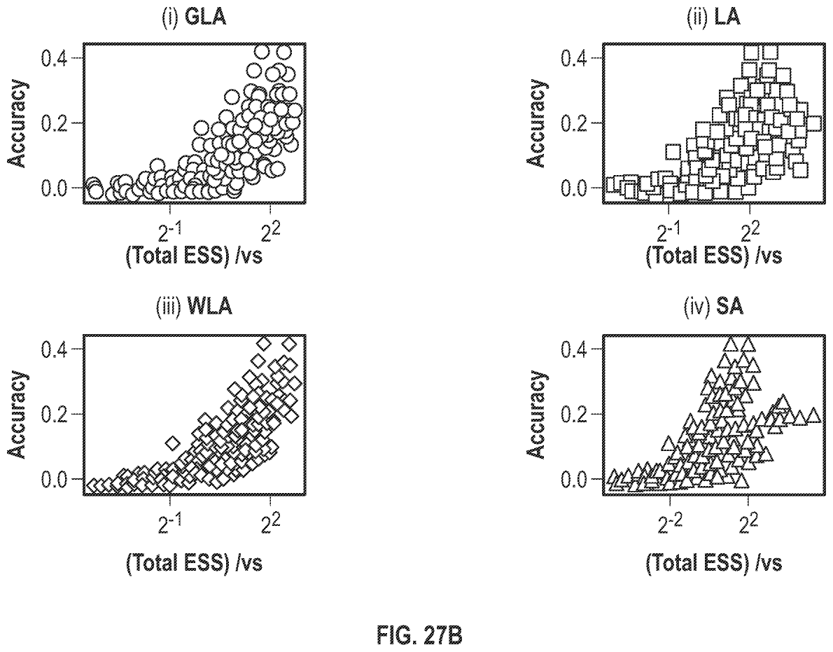

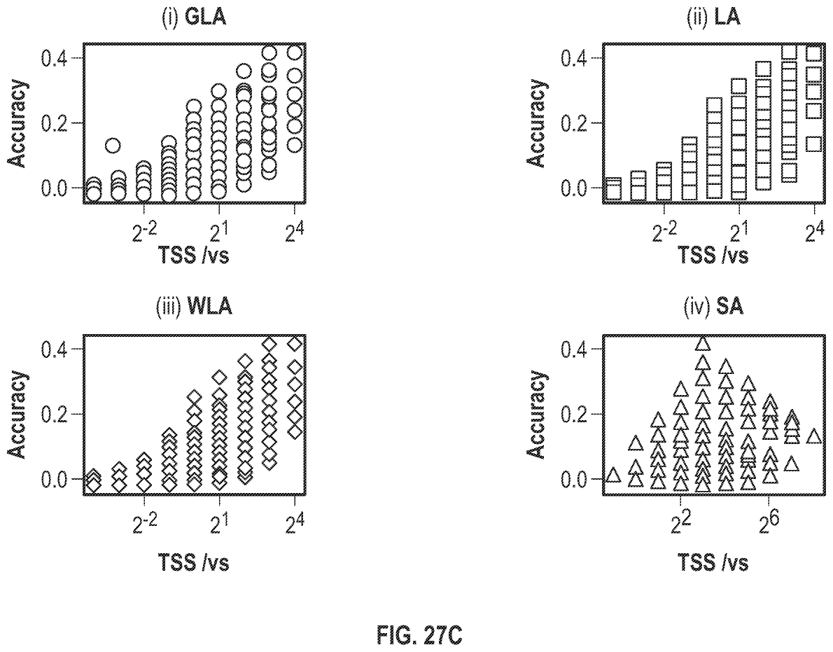

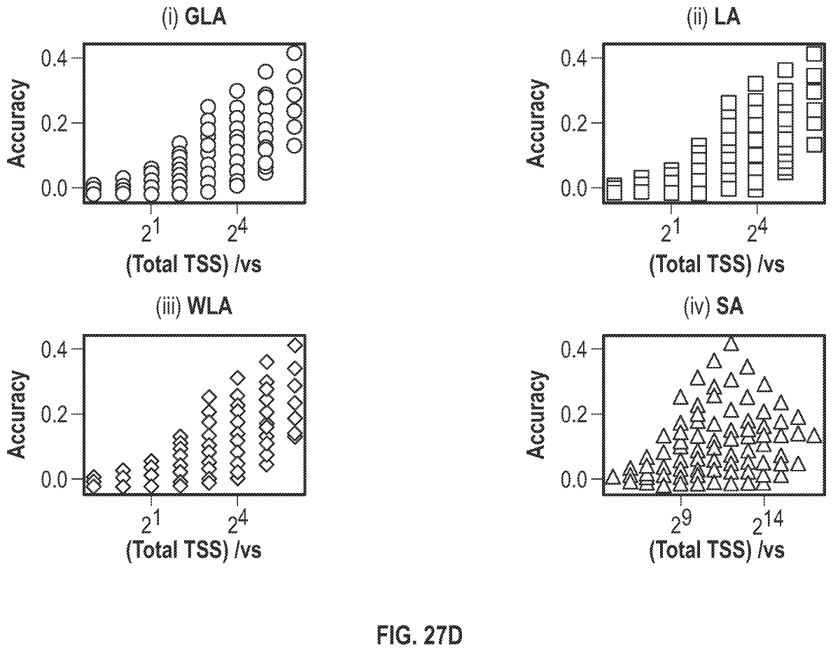

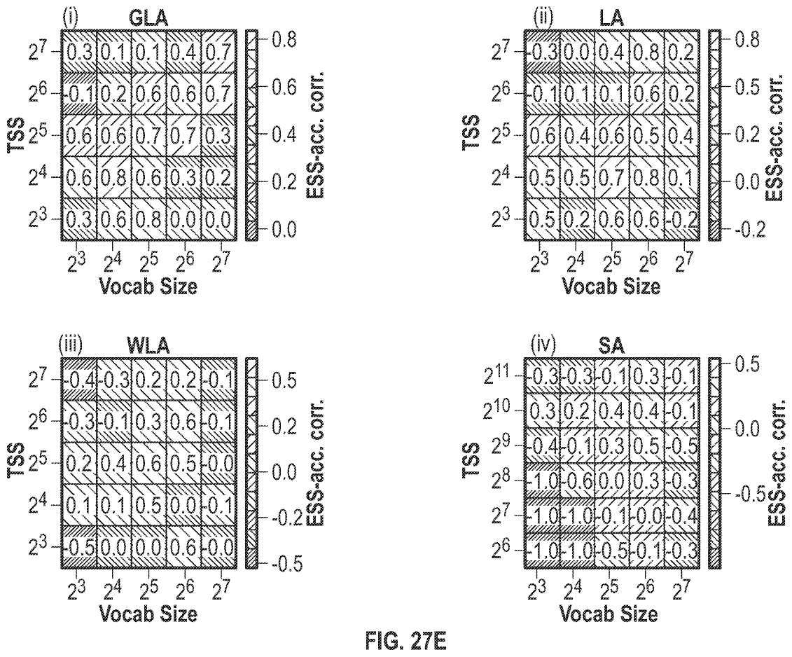

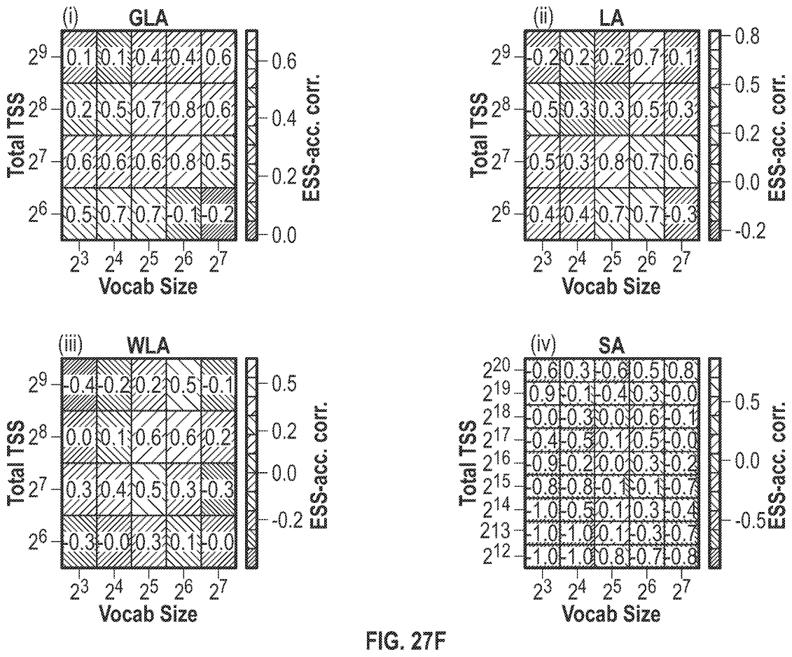

FIG. 27 illustrates results for a compression task in which ESS refers to entropy-ESS and vocab size is abbreviated as vs. Specifically, FIG. 27A(i)-FIG. 27A(iv) illustrates accuracy versus ESS/vs for (i) GLA featurizer, (ii) LA featurizer, (iii) WLA featurizer, and (iv) SA featurizer. FIG. 27B(i)-FIG. 27B(iv) illustrates accuracy versus (total ESS)/vs for (i) GLA featurizer, (ii) LA featurizer, (iii) WLA featurizer, and (iv) SA featurizer. FIG. 27C(i)-FIG. 27C(iv) illustrates accuracy versus TSS/vs for (i) GLA featurizer, (ii) LA featurizer, (iii) WLA featurizer, and (iv) SA featurizer. FIG. 27D(i)-FIG. 27D(iv) illustrates accuracy versus (total TSS)/vs for (i) GLA featurizer, (ii) LA featurizer, (iii) WLA featurizer, and (iv) SA featurizer. FIG. 27E(i)-FIG. 27E(iv) illustrates ESS-accuracy correlation computed over the course of training in (TSS, kv) buckets for (i) GLA featurizer, (ii) LA featurizer, (iii) WLA featurizer, and (iv) SA featurizer. FIG. 27F illustrates the ESS-accuracy correlation computed over the course of training in (total TSS, kv) buckets for (i) GLA featurizer, (ii) LA featurizer, (iii) WLA featurizer, and (iv) SA featurizer. In some embodiments, task-adjusted ESS is a better proxy for model performance than task-adjusted TSS for both selective copying and compression (FIGS. 26A, 26C, 27A, 27C). Regarding within-task-model trends, similar patterns for selective copying may be observed in MQAR (FIG. 26E), except that ESS and accuracy are positively correlated across a larger portion of the task-model space in selectively copying than in MQAR. Compression results may have different task-model trends than selective copying and MQAR (FIG. 27E) because the compression task is significantly more difficult than the MQAR and selective copying tasks, as noted by the lower accuracies in FIG. 27A, leading to more instabilities over the course of training. In some embodiments, the strength of ESS as a proxy for model performance changes as a function of the task.

Unlike TSS, which is a fixed hyperparameter of the model, ESS can be modulated by changing various aspects of the model pipeline. In some embodiments, outside of the state collapse regime, the positive correlation between ESS and performance across the task-model space illustrates that increasing ESS is a beneficial approach to improving model performance without sacrificing efficiency. In some embodiments, changes in ESS are correlated with changes in performance, both across models and during model training, indicating its importance beyond just interpretability. Accordingly, the systems disclosed herein may be configured to automatically select and execute model modifications configured to increase ESS when ESS analysis shows a scenario (such one or more of those described above) in which state utilization is low, state collapse occurs, or ESS is otherwise shown to be able to be increased for a model.

Featurizer Selection from ESS Analysis

ESS analysis may be used to analyze a selected featurizer of a model, and optionally to select and apply one or more modified featurizers for the model, for example as described with reference to blocks 106 and 124 in FIG. 1. The following provides an exemplary ESS analysis for a selected featurizer, specifically a featurizer for an S6 model. The exemplary ESS results presented in this section are an average across 32 samples (e.g., batch size). To effectively explore the relationship between memory capacity and memory utilization in S6, the short convolutional layer in Mamba blocks may be removed and two blocks modified as such (e.g., removing the short convolutional layer) may be stacked between SwiGLUs. Table 2 illustrates the S6 hyperparameters used for the ESS analysis in this example.

TABLE 2

| Configuration | Value |
|---|---|
| Model width | 128 |
| State expansion (d_state) | 16 |

Table 3 illustrates the MQAR task settings used during the ESS analysis of the featurizer selection in this example. The MQAR task settings may be the MQAR task settings from Poli et al. (2024).

TABLE 3

| Configuration | Value |
|---|---|
| Sequence length | 2048 |
| Num. KV Pairs | 128 |
| KV Dist. Const. | 0.1 |
| Optimizer | AdamW |
| Learning Rate | 0.002 |
| Weight Decay | 0.1 |
| Batch Size | 64 |
| Epochs | 70 |
| Steps Per Epoch | 2000 |
| Num. Training Samples | 128k |
| Num. Testing Samples | 6.4k |
| Vocabulary Size | 8192 |

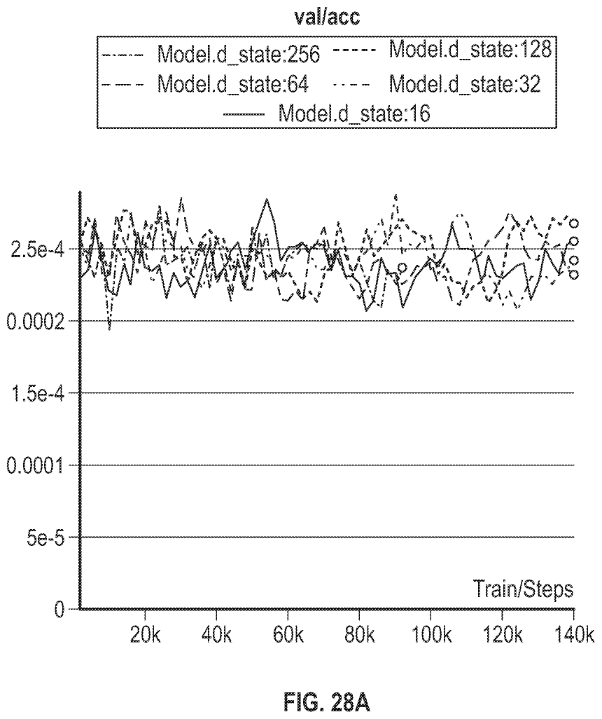

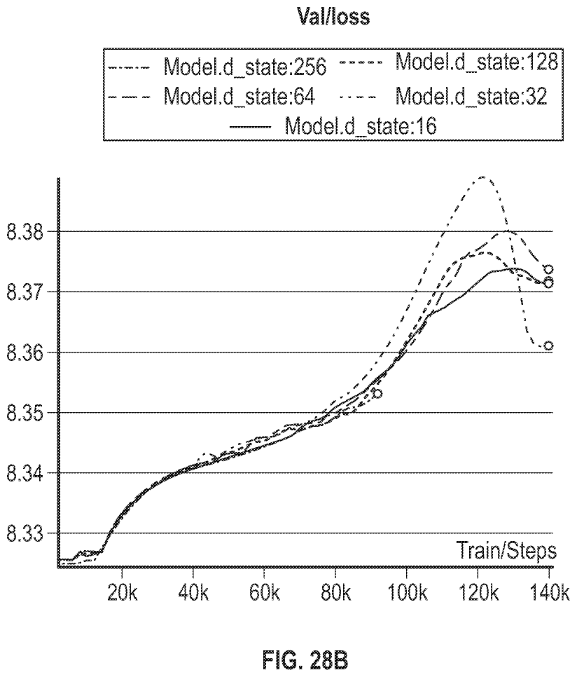

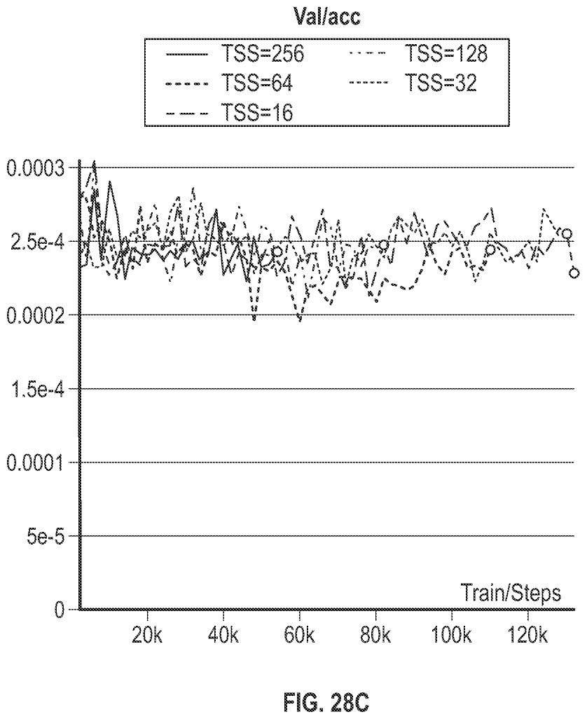

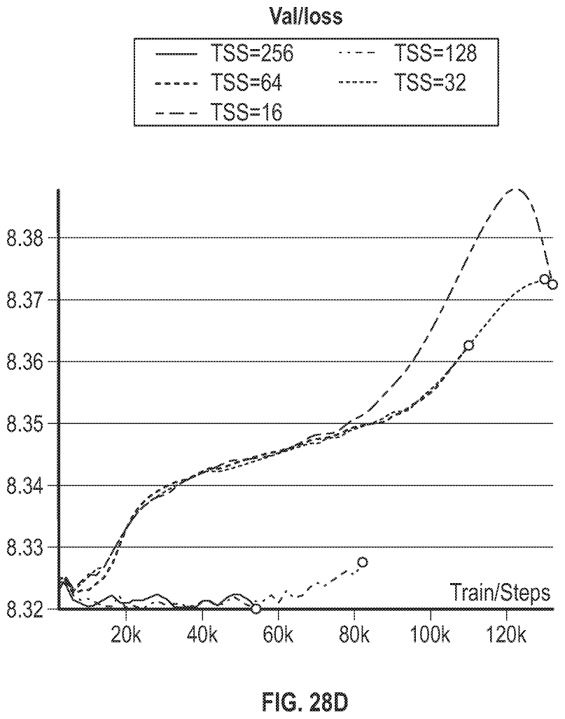

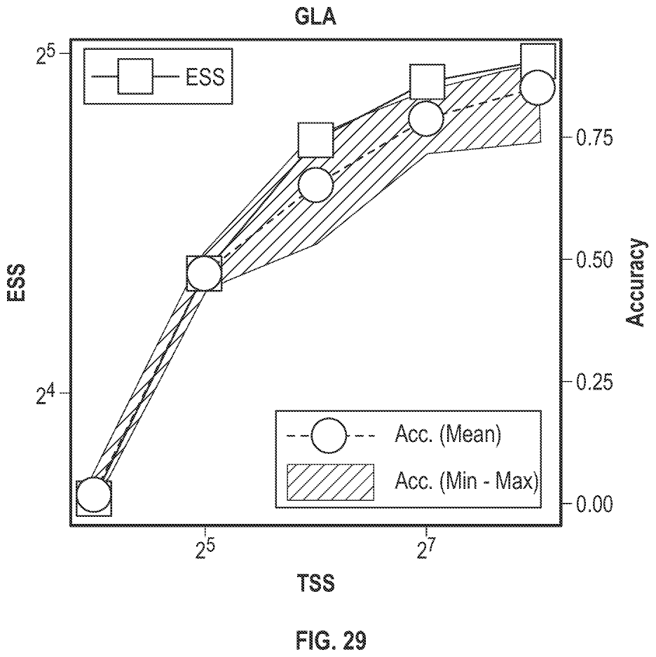

FIG. 28A illustrates the validation accuracy of S6, FIG. 28B illustrates the validation loss of S6, FIG. 28C illustrates the validation accuracy of GLA-S6, and FIG. 28D illustrates the validation loss of GLA-S6. FIG. 29 illustrates the ESS and MQAR accuracy as a function of TSS on a custom task regime (sequence length=1024, num. kv pairs=256), according to some embodiments. FIG. 29 illustrates a strong correlation between MQAR accuracy, ESS, and TSS.

FIGS. 28A and 28B illustrate the S6 model's inability to learn MQAR. In some embodiments, S6 is entirely unable to learn MQAR (accuracy ~0) across multiple scales of TSS (16-256). The inability of the S6 model to learn MQAR aligns with previous demonstrations of the poor performance of S6 without the additional short convolution layer on a different in-context recall task. The inability of the S6 model to learn MQAR is further analyzed herein by computing its ESS when processing a Gaussian noise input prior to training; this additional ESS analysis reveals how S6 is preconditioned to utilize its memory.

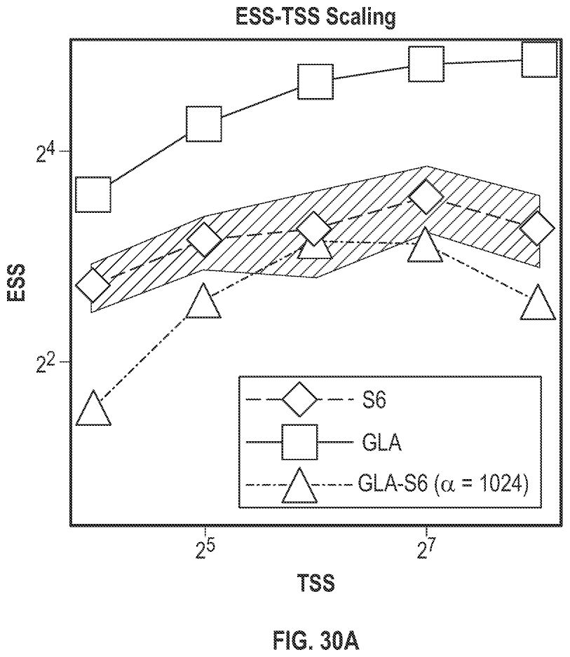

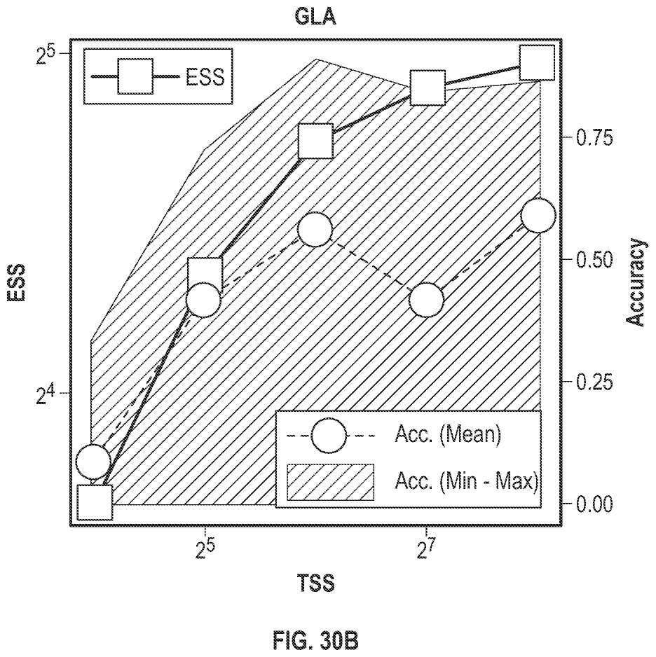

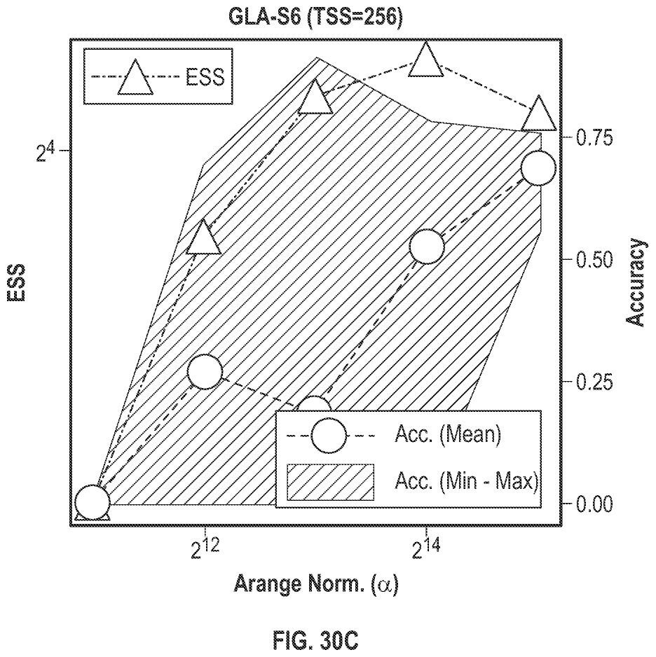

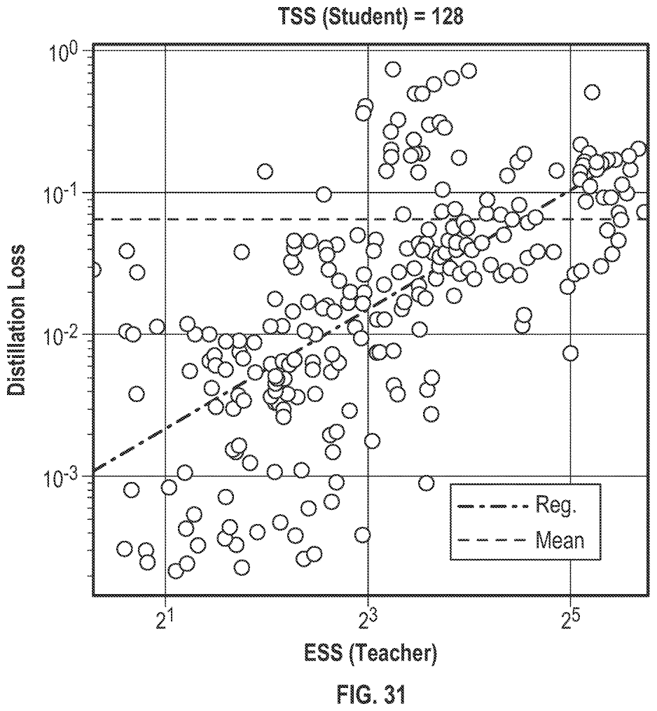

FIG. 30A illustrates ESS-TSS scaling in the S6, GLA, and GLA-S6 featurizers. FIG. 30A demonstrates that the ESS of S6 layers at initialization may scale poorly with respect to TSS, notability failing to increase monotonically. In contrast, GLA layers configured with hyperparameters to match the TSS, model width, number of layers, and hidden-state normalization of the S6 model, may exhibit greater and monotonically increasing ESS-TSS scaling at initialization. Table 4 illustrates the GLA layer hyperparameters described herein, where a is for GLA-S6 and b is used to vary TSS.

TABLE 4

| Configuration | Value |
|---|---|
| Model width | 128 |
| Num. heads | 8 |
| arange Norm. (α)^{a} | 1000 |
| Logit Norm. (β) | 16 |
| K-expansion^{b} | 1 |

FIG. 30B illustrates the ESS and accuracy on MQAR as a function of TSS in GLA. FIG. 30B demonstrates that, despite architectural similarities between the S6 and GLA layers, GLA achieves accuracy improvements that correlate with increases in both TSS and ESS, unlike S6. In some embodiments, the poor ESS-TSS scaling of S6 prevents the model from effectively utilizing all of its states, irrespective of increases in memory capacity. In some embodiments, the ESS-TSS scaling, as well as the ESS and accuracy on MQAR as a function of TSS results, may be used to select and apply one or more modified featurizers for the model. For example, one or more modified featurizers for the model may be applied if the ESS analysis yields poor ESS-TSS scaling (e.g., falling below a predefined threshold).

Initialization Selection from ESS Analysis

ESS analysis may be used to analyze a selected initialization for a model, and optionally to select and apply one or more modified initializations for the model, for example as described with reference to blocks 104 and 122 in FIG. 1. The following provides an exemplary ESS analysis for a selected initialization, specifically an initialization for a GLA-S6 model described herein. The ESS results presented herein are an average across 32 samples (e.g., batch size). In the example shown, the GLA-S6 fails to learn MQAR across multiple scales of TSS (16-256) (see FIG. 28C and FIG. 28D) and exhibits poor initialization-ESS scaling (see FIG. 30A). As shown, the poor ESS scaling is caused by the arange term ([1 2 . . . n]), such that with each new state introduced, the arange term exponentially pushes new entries of A towards zero, negating the effects of additional states despite the increase in TSS.

In some embodiments, the poor ESS scaling may be resolved by increasing the normalization factor. FIG. 30C illustrates the ESS and accuracy on MQAR as a function of normalization factor for initialization in GLA-S6. FIG. 30C illustrates that by scaling the normalization factor (α), the GLA-S6 achieves improvements in MQAR accuracy post-training, reflecting the impact of increasing its initialization-ESS, despite the models having identical memory capacities. In some embodiments, the ESS scaling may be altered in accordance with altering the initialization hyperparameters, such as the hyperparameters illustrated in Table 2 and Table 4. In some embodiments, the ESS scaling may be used to select and apply one or more modified initializations for the model or select and apply a different initialization for the model. For example, one or more modified initializations for the model or a different initialization for the model may be applied if the ESS analysis yields poor ESS scaling (e.g., falling below a predefined threshold).

Model-Order Modification from ESS Analysis

ESS analysis may be used to modify the model-order for a model, for example as described with reference to block 128 in FIG. 1. The following provides an exemplary ESS analysis for modifying the model-order. The ESS results presented herein are an average across 32 samples (e.g., batch size). In some embodiments, multiple GLA models (with TSS=256) are distilled across various task regimes to understand how the ESS of the original model (e.g., the teacher model) influences its ability to be distilled into a smaller student model. In some embodiments, the teacher model is a 2-layer GLA model (Yang et al., 2024a) with dimension=128, TSS=256, num_heads=8, and expand_k=16. In some embodiments, the following process may be applied: (1) match the operators

$$( min ( ‖ {T}_{( s )} - {T}_{( t )} ‖ {}_{F}^{2} / ‖ {T}_{( t )} ‖ {}_{F}^{2} ‖ ) ) ,$$

and (2) match the output activations

$$( min ( ‖ {y}_{( s )} - {y}_{( t )} ‖ {}_{2}^{2} / ‖ {y}_{( t )} ‖ {}_{2}^{2} ‖ ) ) .$$

In some embodiments, the models, while training on MQAR across different task difficulties, are checkpointed every 10 epochs. In some embodiments, the task ranges are sequence length=[512, 1024, 2048] and number of key-value pairs=[64, 128]. Additional default MQAR task settings may be illustrated in Table 3. In some embodiments, for each task difficulty pair, the training run was repeated with three different seeds. In some embodiments, for each teacher model checkpoint, both layers were distilled independently with student models of different state-sizes (e.g., 16, 32, 64, and 128). Table 5 illustrates the distillation settings used in this example.

TABLE 5

| Configuration | Value |
|---|---|
| Optimizer | AdamW |
| Batch Size | 1 |
| Learning Rate | 0.001 |
| Weight Decay | 0.0 |
| Training Steps (Operator) | 800 |
| Dropout (Operator) | 0.2 |
| Training Steps (Activation) | 3200 |
| Dropout (Activation) | 0.2 |

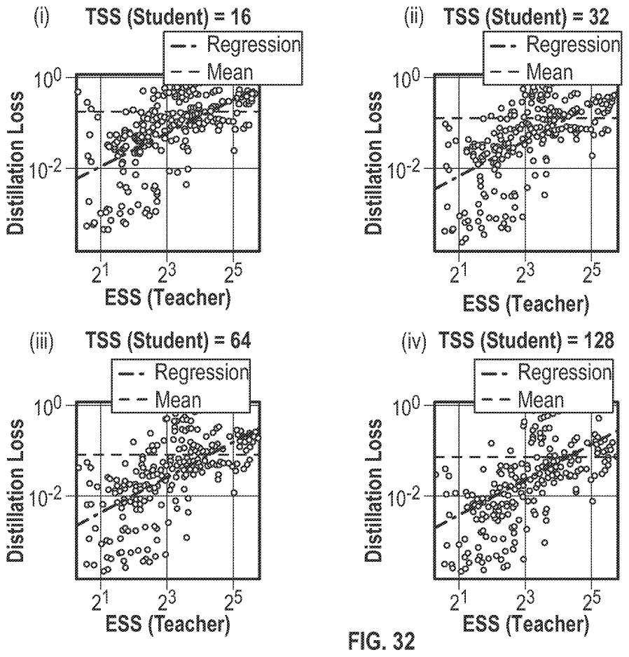

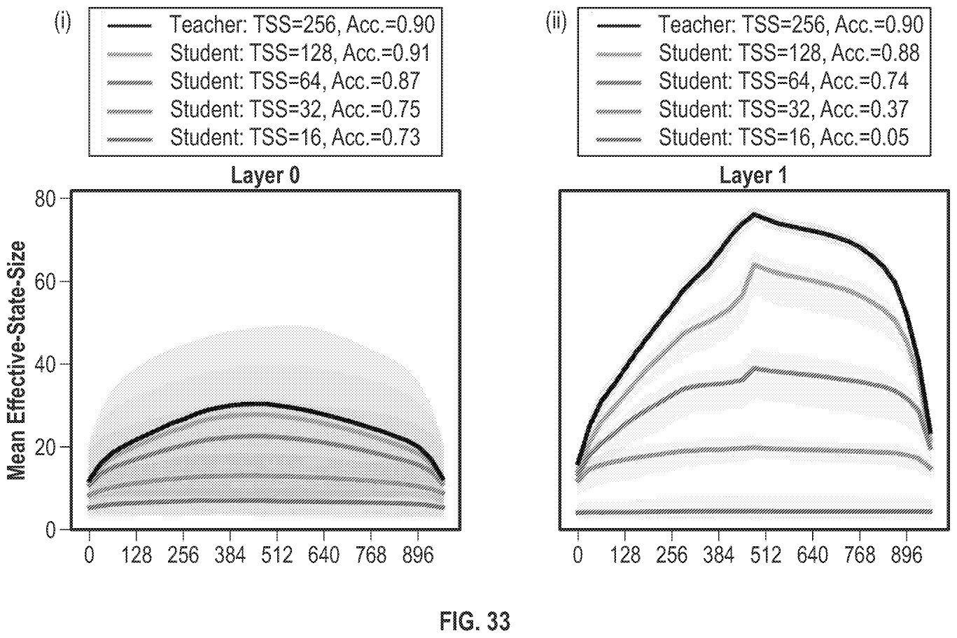

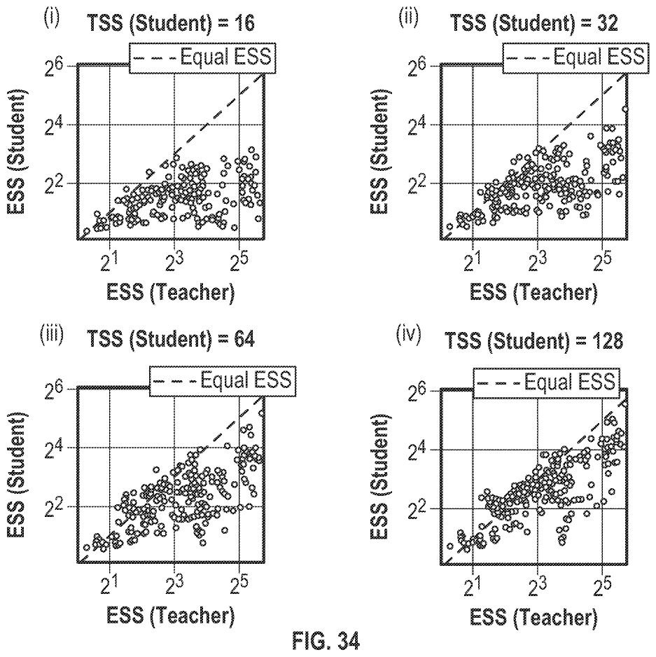

FIG. 31 illustrates the distillation loss versus ESS of the teacher model, specifically the final activation loss during distillation versus ESS of the teacher model. FIG. 32 illustrates the distillation loss versus ESS of the teacher model more comprehensively, specifically illustrating the correlation between ESS and distillation loss across multiple student TSSs (reduction ratios) for which the original teacher models have a TSS of 256. Specifically, FIG. 32(i)-FIG. 32(iv) illustrates the distillation loss versus ESS for (i) student TSS of 16, (ii) student TSS of 32, (iii) student TSS of 64, and (iv) student TSS of 128. FIG. 33(i)-FIG. 33(i) illustrates the comparison between MQAR accuracy and ESS across reduction scales for (i) layer 0 and (ii) layer 1, according to some embodiments. In some embodiments, the higher teacher ESS correlates with greater activation loss. In some embodiments, the downstream performance after single-layer distillation depends on both the teacher model's average ESS and student model's TSS, with higher teacher ESS and lower student TSS resulting in greater performance loss (see FIG. 33). FIG. 34 illustrates the distilled student ESS versus the teacher ESS, according to some embodiments. Specifically, FIG. 34(i)-FIG. 34(iv) illustrates distilled student ESS versus teacher ESS for (i) student TSS of 16, (ii) student TSS of 32, (iii) student TSS of 64, and (iv) student TSS of 128. FIG. 34 demonstrates that an increase in the student TSS may result in the student's ESS more closely matching the teacher's ESS. Plots such as FIG. 34 may provide additional context during the distillation process. The ESS metric in FIGS. 31, 32, and 34 was computed by taking the minimum across input samples and model channels, evaluated at the mid-point of the sequence (l/2). Using the mid-point of the sequence as a summary statistic may save compute. Additionally, the mid-point may retain the largest amount of information from the original operator because it is the point in the sequence at which Hᵢ has the greatest dimensions. In some embodiments, the midpoint statistic shows the clearest trends when compared to computing the ESS metric by taking the maximum or average across the sequence. In some embodiments, the model-order is modified based on the correlation between teacher ESS and distillation loss across student TSSs resulting from ESS analysis, such that a model-order may be modified if the correlation is not a strong positive correlation (e.g., above a predefined threshold). In some embodiments, the model-order is also modified based on the downstream performance predicted from ESS analysis, such that a model-order may be modified if the teacher model has a higher average ESS (e.g., above a predefined threshold), while the student model has a lower TSS (e.g., below a predefined threshold).

Hybridization Policy Modification from ESS Analysis

ESS analysis may be used to modify the hybridization policy, for example as described with reference to block 130 in FIG. 1. The following provides an exemplary ESS analysis and resulting modification of the hybridization policy of GLA-SA hybrids, specifically an 8-layer hybrid and a 16-layer hybrid. The 8-layer hybrid network may include 4 sequence mixing layers (e.g., one of GLA or SA) and 4 channel mixing layers (e.g., MLPs). All possible 8-layer hybrid networks (of which there are 16) are trained and post-training, per-layer ESS analysis is performed on all possible 8-layer networks. In some embodiments, tolerance-based ESS is used so that the failure modes of learning in the hybrid network can be analyzed. All possible 8-layer hybrid networks may be trained on MQAR with the default task-model settings illustrated in Table 6.

TABLE 6

| Configuration | Value |
|---|---|
| Sequence length | 2048 |
| Num. KV Pairs | 512 |
| KV Dist. Const. | 0.1 |
| Optimizer | AdamW |
| Learning Rate | 0.002 |
| Weight Decay | 0.1 |
| Batch Size | 64 |
| Epochs | 70 |
| Steps Per Epoch | 2000 |
| Num. Training Samples | 128k |
| Num. Testing Samples | 6.4k |
| Vocabulary Size | 8192 |
| Model width | 64 |
| Num. heads | 4 |

The 16-layer hybrid network may include 8 sequence mixing layers (e.g., one of GLA or SA) and 8 channel mixing layers (e.g., MLPs). All possible 16-layer hybrid networks that follow the Jamba hybridization policy (Lieber et al., 2024) may be trained and post-training, per-layer ESS analysis may be performed all possible 16-layer hybrid networks following the Jamba hybridization policy. In some embodiments, tolerance-based ESS is used so that the failure modes of learning in the hybrid network can be analyzed. All possible 16-layer hybrid networks following the Jamba hybridization policy may be trained on MQAR with the default task-model settings illustrated in Table 7. Compared to the 8-layer hybrid network training settings in Table 6, the 16-layer hybrid network training settings may reduce the model dimension of the network and make the task more difficult to better determine performance differences across architectures.

TABLE 7

| Configuration | Value |
|---|---|
| Sequence length | 4096 |
| Num. KV Pairs | 1024 |
| KV Dist. Const. | 0.1 |
| Optimizer | AdamW |
| Learning Rate | 0.002 |
| Weight Decay | 0.1 |
| Batch Size | 64 |
| Epochs | 70 |
| Steps Per Epoch | 2000 |
| Num. Training Samples | 128k |
| Num. Testing Samples | 6.4k |
| Vocabulary Size | 8192 |
| Model width | 16 |
| Num. heads | 2 |

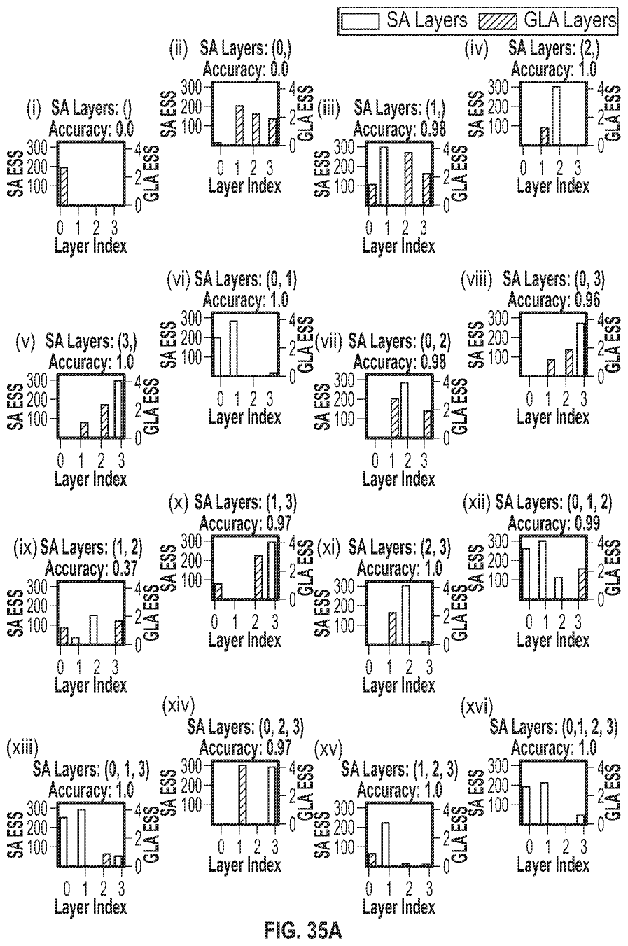

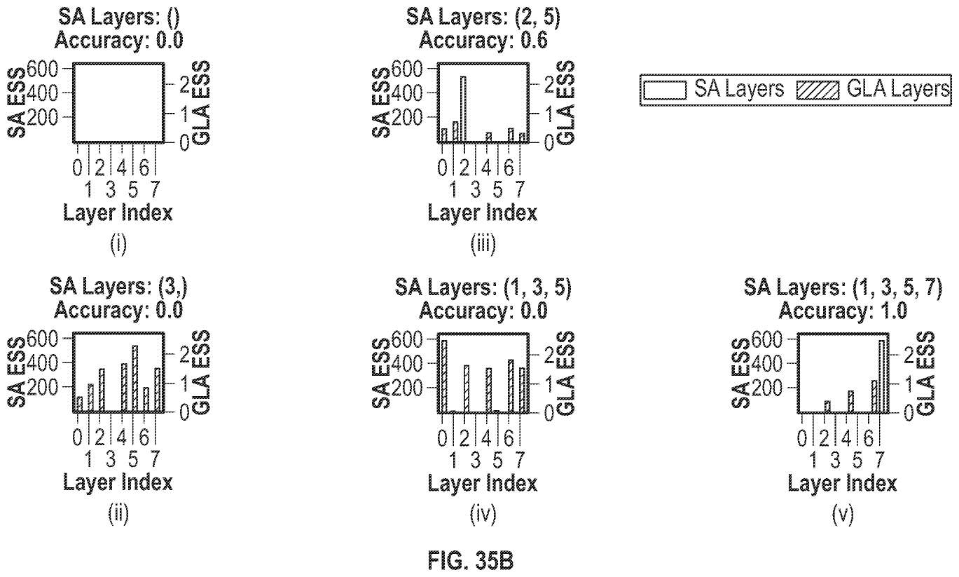

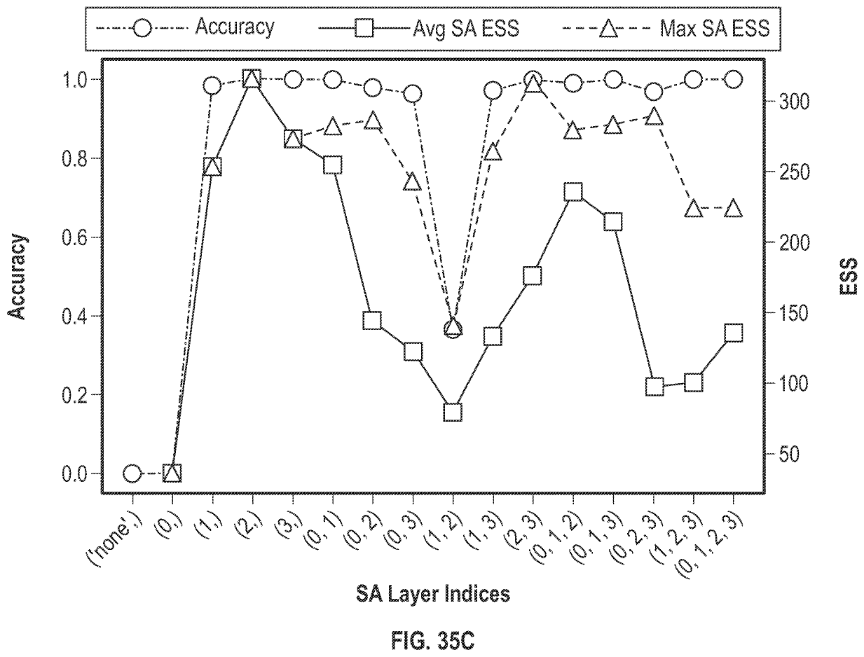

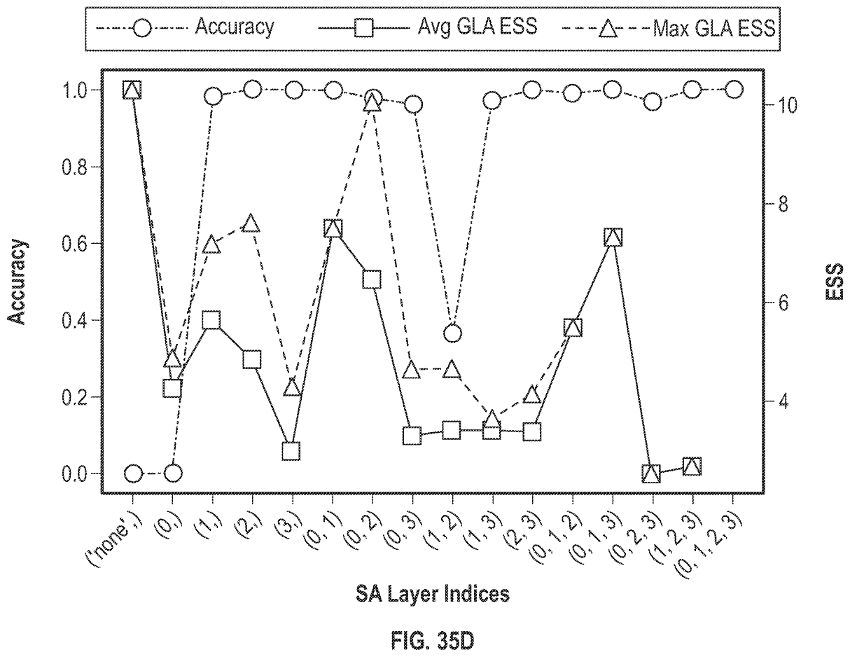

FIG. 35 illustrates the tolerance-based ESS analysis with a tolerance at 1e-1 performed on the 4-layer and 8-layer GLA-SA hybrid networks, according to some embodiments. FIG. 35A(i)-FIG. 35A (xvi) illustrates the per-layer ESS of all possible 4-layer GLA-SA hybrid networks, FIG. 35B(i)-FIG. 35B (v) illustrates the per-layer ESS of all possible 8-layer GLA-SA Jamba-inspired hybrid networks, FIG. 35C illustrates the model accuracy and max/average ESS of SA layers in the 4-layer GLA-SA hybrid networks, and FIG. 35D illustrates the model accuracy and max/average ESS of GLA layers in the 4-layer GLA-SA hybrid networks.

FIG. 35A demonstrates, by the tolerance-ESS being 0, that many of the layers of the pure GLA model may fail to learn expressive states, which provides an indication as to why the model performs so poorly in other examples described herein. FIG. 35A demonstrates that hybrid networks with a single attention layer may perform quite well except for the network that has attention in the first layer. When attention is placed as the first layer, the hybrid model may suffer from state collapse. FIG. 35A also demonstrates that hybrid networks with two SA layers may perform quite well, except for the models with attention placed in the second and third layers.

FIG. 35C may demonstrate that maximum ESS across attention layers best correlates with accuracy. In some embodiments, the average SA layer ESS is a worse proxy for performance, indicating that having a single layer with high memory utilization in hybrid network is more important than having many layers with lower memory utilization. FIG. 35C also demonstrates that, regarding the GLA layers, despite both the maximum and average ESS varying across models, changes in ESS do not correspond to changes in accuracy. In some embodiments, because the attention layers are not responsible for driving the total ESS of the network up due to their unbounded state size, the role of non-attention layers in hybrid networks may not be captured entirely by the magnitude of their ESS.

FIG. 35B demonstrates that the pure GLA network may be unable to solve the task and may realize a tolerance-based ESS of 0 in all layers. FIG. 35B also demonstrates that the two SA-layer Jamba hybrid may partially learn the task, and the three SA-layer Jamba hybrid (in some embodiments) may not. The three SA-layer Jamba hybrid may, in some embodiments, not learn the task because the attention layers suffer from state collapse, which may reveal a deficiency in fixed-topology hybridization policies like Jamba, which do not take into account factors like network trainability which can significantly influence model performance.

In some embodiments, the hybridization policy is modified based on the tolerance-based ESS per layer, such that a hybridization policy may be modified if the tolerance-based ESS per layer does not exceed a predefined threshold. In some embodiments, the hybridization policy is also modified based on state collapse, such that a hybridization policy may be modified if the ESS analysis indicates the model suffers from state collapse.

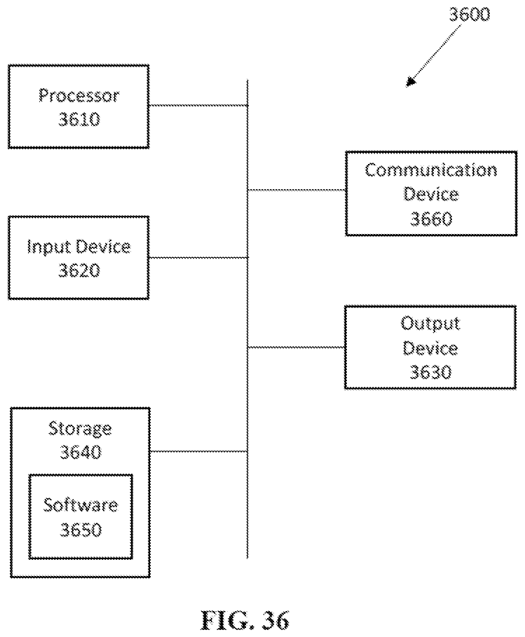

FIG. 36 illustrates an example of a computing system 3600 that may be used for any one of the computing systems and devices described herein, such as a control system described in reference to method 100 of FIG. 1. System 3600 can be a computer connected to a network. System 3600 can be a client computer, a server, a router, a hub, an access point, or any other computing device that can send and/or receive wireless signals or non-wireless signals. As shown in FIG. 36, system 3600 can be any suitable type of microprocessor-based system, such as a personal computer, workstation, server, or handheld computing device (portable electronic device) such as a phone or tablet. The system can include, for example, one or more of a processor 3610, input device 3620, output device 3630, storage 3640, and communication device 3660. Input device 3620 and output device 3630 can generally correspond to those described above and can either be connectable or integrated with the computer.

Input device 3620 can be any suitable device that provides input, such as a touch screen, keyboard or keypad, mouse, gesture recognition component of a virtual/augmented reality system, or voice recognition device. Output device 3630 can be or include any suitable device that provides output, such as a touch screen, haptics device, virtual/augmented reality display, or speaker.

Storage 3640 can be any suitable device that provides storage, such as an electrical, magnetic, or optical memory, including a RAM, cache, hard drive, removable storage disk, or other non-transitory computer-readable medium. Communication device 3660 can include any suitable device capable of transmitting and receiving signals over a network, such as a network interface chip or device. The components of the computer can be connected in any suitable manner, such as via a physical bus or wirelessly.

Software 3650, which can be stored in storage 3640 and executed by processor 3610, can include, for example, the programming that embodies the functionality of the present disclosure (e.g., as embodied in the devices as described above). For example, software 3650 can include one or more programs for performing one or more of the steps of method 100 of FIG. 1.

Software 3650 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 3640, that can contain or store programming for use by or in connection with an instruction execution system, apparatus, or device.

Software 3650 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport-readable medium can include, but is not limited to, an electronic, magnetic, optical, electromagnetic, or infrared wired or wireless propagation medium.

System 3600 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

System 3600 can implement any operating system suitable for operating on the network. Software 3650 can be written in any suitable programming language, such as C, C++, Java, or Python. In various aspects, application software embodying the functionality of the present disclosure can be deployed in different configurations, such as in a client/server arrangement or through a Web browser as a Web-based application or Web service, for example.

The foregoing description, for the purpose of explanation, has been described with reference to specific aspects. However, the illustrative discussions above are not intended to be exhaustive or to limit the invention to the precise forms disclosed. Many modifications and variations are possible in view of the above teachings. The aspects were chosen and described in order to best explain the principles of the techniques and their practical applications. Others skilled in the art are thereby enabled to best utilize the techniques and various aspects with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosures of the patents and publications referred to in this application are hereby incorporated herein by reference.

1. A method for configuring a machine-learning sequence model based on memory utilization of the model, the method performed by a system comprising one or more processors, the method comprising:
receiving data representing one or more characteristics for the model from the group consisting of: an architecture for the model, an initialization stage of the model, a featurizer for the model, a training process of the model, and a configuration of the model following the training stage;
computing a measure of effective state size of the model based on the received data, wherein the measure of effective state size characterizes memory utilization of the model;
based on the computed measure of the effective state size of the model, selecting a modification to the model from the group consisting of: a modification to the initialization stage of the model, a modification to the featurizer for the model, a modification to a loss function of the training stage of the model, a modification to a model order of the model, a modification to a hybridization of the model, and a modification to an architecture of the model;
applying the selected modification to the model; and
training the model based on the applied modification.

2. The method of claim 1, wherein computing the measure of effective state size comprises applying a tolerance value to threshold singular values of one or more operator submatrices of the sequence model to generate a tolerance effective state size metric.

3. The method of claim 1, wherein computing the measure of effective state size comprises exponentiating a normalized spectral entropy of one or more operator submatrices of the sequence model.

4. The method of claim 1, wherein computing the measure of effective state size comprises:
computing specific respective ESS values for each sequence index on a per-channel, per-layer basis; and
averaging the specific respective ESS values across layer, channel, sequence, and batch size dimensions to generate the measure of effective state size.

5. The method of claim 1, wherein computing the measure of effective state size comprises:
computing specific respective ESS values for each sequence index on a per-channel, per-layer basis;
summing the specific respective ESS values across channels to generate channel-sum ESS values; and
averaging the channel-sum ESS values across layer, sequence, and batch size dimensions to generate the measure of effective state size.

6. The method of claim 1, wherein computing the measure of effective state size comprises:
computing a plurality of respective ESS values for the model across channels and input samples; and
evaluating a minimum of the plurality of ESS values at the mid-point of the sequence.

7. The method of claim 1, wherein the training stage of the model comprises training the model on one or more tasks from the group consisting of: multi-query associative recall (MQAR), selective copying, and compression.

8. The method of claim 1, wherein the sequence model comprises one or more model types from the group consisting of: gated linear attention (GLA), weighted linear attention (WLA), linear attention (LA), and softmax attention (SA), S6, or GLA-S6.

9. The method of claim 1, wherein:
computing the measure of effective state size of the model comprises computing the measure at a first stage during the training process; and
the method further comprises computing a second measure of effective state size of the model at a second stage during the training process.

10. The method of claim 9, comprising:
based on the measure of the effective state size of the model at the first stage during the training process and based on the second measure of effective state size of the model at a second stage during the training process, detecting that a failure mode of the training process has occurred;
wherein selecting the modification to the model is performed in accordance with detecting that the failure mode has occurred.

11. The method of claim 10, wherein the failure mode comprises a mode of the group consisting of: state saturation and state collapse.

12. The method of claim 11, wherein:
the failure mode is a state saturation mode in which the model has insufficient memory to learn a task, and
detecting the state saturation mode comprises detecting, based on the measure of effective state size of the model at the first stage during the training process and based on the second measure of effective state size of the model at a second stage during the training process, that a measure of state utilization approaches withing a threshold distance of 1 as the training process progresses, wherein state utilization is computed as a ratio of the effective state size to theoretical realizable state size of the model.

13. The method of claim 10, wherein selecting a modification to the model comprises selecting the modification to increase the theoretical realizable state size of the model.

14. The method of claim 11, wherein:
the failure mode is a state collapse mode in which memory utilization fails to sufficiently increase during the training process, and
detecting the state collapse mode comprises detecting, based on the measure of effective state size of the model at the first stage during the training process and based on the second measure of effective state size of the model at a second stage during the training process, that an increase in the second measure of effective state size as compared to the first measure of effective state size fails to meet one or more improvement criteria.

15. The method of claim 10, wherein selecting a modification to the model comprises selecting the modification to increase the effective state size of the model without changing a theoretical realizable state size of the model.

16. The method of claim 1, wherein:
the data representing the one or more characteristics for the model represents the model before the training process of the model is performed; and
the selected modification to the model comprises the modification to the featurizer for the model.

17. The method of claim 1, wherein:
the data representing the one or more characteristics for the model represents the model before the training process of the model is performed; and
the selected modification to the model comprises the modification to the initialization stage of the model.

18. The method of claim 17, wherein the modification to the initialization stage of the model comprises an increase in a normalization factor of the initialization stage.

19. The method of claim 1, wherein:
the data representing the one or more characteristics for the model represents the model after at least part of the training process of the model is performed; and
the selected modification to the model comprises regularization of one or more layers of the model.

20. The method of claim 19, wherein the regularization of the one or more layers of the model comprises regularization of a second of two sequence mixing layers without regularization of a first of the two sequence mixing layers.

21. The method of claim 1, wherein:
the data representing the one or more characteristics for the model represents the model after the training process of the model is performed; and
the selected modification to the model comprises the modification to a model order of the model.

22. The method of claim 1, wherein:
the data representing the one or more characteristics for the model represents the model after the training process of the model is performed; and
the selected modification to the model comprises the modification to the hybridization of the model.

23. The method of claim 22, wherein computing the measure of effective state size of the model based on the received data comprises computing one or more per-layer measures of effective state size of the model.

24. The method of claim 1, wherein the model comprises a model type of the group consisting of: a linear system and an input-varying linear operator.

25. A system comprising:
at least one computer processor; and
a memory storing computer instructions, wherein the instructions are configured to be executed by the at least one computer processor, to cause the system to perform operations comprising:
receiving data representing one or more characteristics for a model from the group consisting of: an architecture for the model, an initialization stage of the model, a featurizer for the model, a training process of the model, and a configuration of the model following the training stage;
computing a measure of effective state size of the model based on the received data, wherein the measure of effective state size characterizes memory utilization of the model;
based on the computed measure of the effective state size of the model, selecting a modification to the model from the group consisting of: a modification to the initialization stage of the model, a modification to the featurizer for the model, a modification to a loss function of the training stage of the model, a modification to a model order of the model, a modification to a hybridization of the model, and a modification to an architecture of the model;
applying the selected modification to the model; and
training the model based on the applied modification.

26. The system of claim 25, wherein computing the measure of effective state size comprises:
computing specific respective ESS values for each sequence index on a per-channel, per-layer basis; and
averaging the specific respective ESS values across layer, channel, sequence, and batch size dimensions to generate the measure of effective state size.

27. The system of claim 25, wherein computing the measure of effective state size comprises:
computing specific respective ESS values for each sequence index on a per-channel, per-layer basis;
summing the specific respective ESS values across channels to generate channel-sum ESS values; and
averaging the channel-sum ESS values across layer, sequence, and batch size dimensions to generate the measure of effective state size.

28. The system of claim 25, wherein computing the measure of effective state size comprises:
computing a plurality of respective ESS values for the model across channels and input samples; and
evaluating a minimum of the plurality of ESS values at the mid-point of the sequence.

29. The system of claim 25, wherein the training stage of the model comprises training the model on one or more tasks from the group consisting of: multi-query associative recall (MQAR), selective copying, and compression.

30. The system of claim 25, wherein the model comprises a model type of the group consisting of: a linear system and an input-varying linear operator.

31. A non-transitory computer-readable storage medium storing computer instructions that, when executed by at least one computer processor of a computing system, cause the computing system to perform operations comprising:
receiving data representing one or more characteristics for a model from the group consisting of: an architecture for the model, an initialization stage of the model, a featurizer for the model, a training process of the model, and a configuration of the model following the training stage;
computing a measure of effective state size of the model based on the received data, wherein the measure of effective state size characterizes memory utilization of the model;
based on the computed measure of the effective state size of the model, selecting a modification to the model from the group consisting of: a modification to the initialization stage of the model, a modification to the featurizer for the model, a modification to a loss function of the training stage of the model, a modification to a model order of the model, a modification to a hybridization of the model, and a modification to an architecture of the model;
applying the selected modification to the model; and
training the model based on the applied modification.

32. A method for quantitatively assessing a machine-learning sequence model based on memory utilization of the model, the method performed by a system comprising one or more processors, the method comprising:
receiving data representing one or more characteristics for the model from the group consisting of: an architecture for the model, an initialization stage of the model, a featurizer for the model, a training process of the model, and a configuration of the model following the training stage; and
computing a measure of effective state size of the model based on the received data, wherein the measure of effective state size characterizes memory utilization of the model.

33. The method of claim 32, comprising:
based on the computed measure of the effective state size of the model:
selecting the model for application to a task; and
deploying the model for performance of the task.

34. The method of claim 32, wherein computing the measure of effective state size comprises:
computing specific respective ESS values for each sequence index on a per-channel, per-layer basis; and
averaging the specific respective ESS values across layer, channel, sequence, and batch size dimensions to generate the measure of effective state size.

35. The method of claim 32, wherein computing the measure of effective state size comprises:
computing specific respective ESS values for each sequence index on a per-channel, per-layer basis;
summing the specific respective ESS values across channels to generate channel-sum ESS values; and
averaging the channel-sum ESS values across layer, sequence, and batch size dimensions to generate the measure of effective state size.

36. The method of claim 32, wherein computing the measure of effective state size comprises:
computing a plurality of respective ESS values for the model across channels and input samples; and
evaluating a minimum of the plurality of ESS values at the mid-point of the sequence.

37. The method of claim 32, wherein the model comprises a model type of the group consisting of: a linear system and an input-varying linear operator.

38. A system comprising:
at least one computer processor; and
a memory storing computer instructions, wherein the instructions are configured to be executed by the at least one computer processor, to cause the system to perform operations comprising:
receiving data representing one or more characteristics for a model from the group consisting of: an architecture for the model, an initialization stage of the model, a featurizer for the model, a training process of the model, and a configuration of the model following the training stage; and
computing a measure of effective state size of the model based on the received data, wherein the measure of effective state size characterizes memory utilization of the model.

39. The system of claim 38, comprising:
based on the computed measure of the effective state size of the model:
selecting the model for application to a task; and
deploying the model for performance of the task.

40. The system of claim 38, wherein computing the measure of effective state size comprises:
computing specific respective ESS values for each sequence index on a per-channel, per-layer basis; and
averaging the specific respective ESS values across layer, channel, sequence, and batch size dimensions to generate the measure of effective state size.

41. The system of claim 38, wherein computing the measure of effective state size comprises:
computing specific respective ESS values for each sequence index on a per-channel, per-layer basis;
summing the specific respective ESS values across channels to generate channel-sum ESS values; and
averaging the channel-sum ESS values across layer, sequence, and batch size dimensions to generate the measure of effective state size.

42. The system of claim 38, wherein computing the measure of effective state size comprises:
computing a plurality of respective ESS values for the model across channels and input samples; and
evaluating a minimum of the plurality of ESS values at the mid-point of the sequence.

43. The system of claim 38, wherein the model comprises a model type of the group consisting of: a linear system and an input-varying linear operator.

44. A non-transitory computer-readable storage medium storing computer instructions that, when executed by at least one computer processor of a computing system, cause the computing system to perform operations comprising:
receiving data representing one or more characteristics for a model from the group consisting of: an architecture for the model, an initialization stage of the model, a featurizer for the model, a training process of the model, and a configuration of the model following the training stage; and
computing a measure of effective state size of the model based on the received data, wherein the measure of effective state size characterizes memory utilization of the model.

45. The non-transitory computer-readable storage medium of claim 44, comprising:
based on the computed measure of the effective state size of the model:
selecting the model for application to a task; and
deploying the model for performance of the task.
